(19) United States
(12) Patent Application Publication
(10) Pub. No.: US 2019/0186373 A1
(43) Pub. Date: Jun. 20, 2019

(54) Power-generation Gas Turbine with Fuel Injection Using a Conductor of At Least One of Multiple Resonators

(71) Applicant: Plasma Igniter, LLC, Bruceton Mills, WV (US)

(72) Inventors: Andrew D. Lowery, Morgantown, WV (US); James E. Smith, Bruceton Mills, WV (US)

(73) Assignee: Plasma Igniter, LLC, Bruceton Mills, WV (US)

(21) Appl. No.: 15/848,041

(22) Filed: Dec. 20, 2017

(51) Int. Cl. F02C 7/266; H05H 1/48; F02C 7/22

(52) U.S. Cl. CPC F02C 7/266; H05H 1/48; H05H 2001/485; H05H 2001/483; F02C 7/222

(57) ABSTRACT

An example system can include a combustion chamber of a power-generation gas turbine, one or more radio-frequency power sources, a plurality of resonators, and a fuel conduit. The plurality of resonators can be electromagnetically coupled to the one or more radio-frequency power sources and each have a respective resonant wavelength. Further, each resonator can include (i) a respective first conductor, (ii) a respective second conductor, and (iii) a respective dielectric between the first conductor and the second conductor, and can be configured to provide at least one of a plasma corona or electromagnetic waves. The fuel conduit can be configured to couple to a fuel source and have a fuel outlet for expelling fuel into a combustion zone of the combustion chamber. A portion of the fuel conduit is disposed within the first conductor of a given resonator of the plurality of resonators.

### CROSS-REFERENCE TO RELATED APPLICATIONS

The present application hereby incorporates by reference U.S. Pat. Nos. 5,361,737; 7,721,697; 8,783,220; 8,887,683; 9,551,315; 9,624,898; and 9,638,157. The present application also hereby incorporates by reference U.S. Patent Application Pub. Nos. 2009/0194051; 2011/0146607; 2011/0175691; 2014/0283780; 2014/0283781; 2014/0327357; 2015/0287574; 2017/0082083; 2017/0085060; 2017/0175697; and 2017/0175698. In addition, the present application hereby incorporates by reference International Patent Application Pub. Nos. WO 2011/112786; WO 2011/127298; WO 2015/157294; and WO 2015/176073. Further, the present application hereby incorporates by reference the following U.S. patent applications, each filed on the same date as the present application: “Plasma-Distributing Structure in a Resonator System” (identified by attorney docket number 17-1501); “Magnetic Direction of a Plasma Corona Provided Proximate to a Resonator” (identified by attorney docket number 17-1502); “Fuel Injection Using a Dielectric of a Resonator” (identified by attorney docket number 17-1505); “Jet Engine Including Resonator-based Diagnostics” (identified by attorney docket number 17-1506); “Power-generation Turbine Including Resonator-based Diagnostics” (identified by attorney docket number 17-1507); “Electromagnetic Wave Modification of Fuel in a Jet Engine” (identified by attorney docket number 17-1508); “Electromagnetic Wave Modification of Fuel in a Power-generation Turbine” (identified by attorney docket number 17-1509); “Jet Engine with Plasma-assisted Combustion” (identified by attorney docket number 17-1510); “Jet Engine with Fuel Injection Using a Conductor of a Resonator” (identified by attorney docket number 17-1511); “Jet Engine with Fuel Injection Using a Dielectric of a Resonator” (identified by attorney docket number 17-1512); “Jet Engine with Fuel Injection Using a Conductor of At Least One of Multiple Resonators” (identified by attorney docket number 17-1513); “Jet Engine with Fuel Injection Using a Dielectric of At Least One of Multiple Resonators” (identified by attorney docket number 17-1514); “Plasma-Distributing Structure in a Jet Engine” (identified by attorney docket number 17-1515); “Power-generation Gas Turbine with Plasma-assisted Combustion” (identified by attorney docket number 17-1516); “Power-generation Gas Turbine with Fuel Injection Using a Conductor of a Resonator” (identified by attorney docket number 17-1517); “Power-generation Gas Turbine with Fuel Injection Using a Dielectric of a Resonator” (identified by attorney docket number 17-1518); “Power-generation Gas Turbine with Plasma-assisted Combustion Using Multiple Resonators” (identified by attorney docket number 17-1519); “Power-generation Gas Turbine with Fuel Injection Using a Dielectric of At Least One of Multiple Resonators” (identified by attorney docket number 17-1521); “Plasma-Distributing Structure in a Power Generation Turbine” (identified by attorney docket number 17-1522); “Jet Engine with Plasma-assisted Combustion and Directed Flame Path” (identified by attorney docket number 17-1523); “Jet Engine with Plasma-assisted Combustion Using Multiple Resonators and a Directed Flame Path” (identified by attorney docket number 17-1524); “Plasma-Distributing Structure and Directed Flame Path in a Jet Engine” (identified by attorney docket number 17-1525); “Power-generation Gas Turbine with Plasma-assisted Combustion and Directed Flame Path” (identified by attorney docket number 17-1526); “Power-generation Gas Turbine with Plasma-assisted Combustion Using Multiple Resonators and a Directed Flame Path” (identified by attorney docket number 17-1527); “Plasma-Distributing Structure and Directed Flame Path in a Power Generation Turbine” (identified by attorney docket number 17-1528); “Jet engine with plasma-assisted afterburner” (identified by attorney docket number 17-1529); “Jet engine with plasma-assisted afterburner having Resonator with Fuel Conduit” (identified by attorney docket number 17-1530); “Jet engine with plasma-assisted afterburner having Resonator with Fuel Conduit in Dielectric” (identified by attorney docket number 17-1531); “Jet engine with plasma-assisted afterburner having Ring of Resonators” (identified by attorney docket number 17-1532); “Jet engine with plasma-assisted afterburner having Ring of Resonators and Resonator with Fuel Conduit” (identified by attorney docket number 17-1533); “Jet engine with plasma-assisted afterburner having Ring of Resonators and Resonator with Fuel Conduit in Dielectric” (identified by attorney docket number 17-1534); and “Plasma-Distributing Structure in an Afterburner of a Jet Engine” (identified by attorney docket number 17-1535).

### BACKGROUND

Resonators are devices and/or systems that can produce a large response for a given input when excited at a resonance frequency. Resonators are used in various applications, including acoustics, optics, photonics, electromagnetics, chemistry, particle physics, etc. For example, electromagnetic resonators can be used as antennas or as energy transmission devices. Further, resonators can concentrate a large amount of energy in a relatively small location (for example, as in the electromagnetic waves radiated by a laser).

Power-generation turbines can produce energy. That energy can be used to power a variety of structures, such as homes, offices, cars, or trains, for example. One way in which a power-generation turbine can produce energy is by combusting hydrocarbon fuel to generate heat.

### SUMMARY

In a first implementation, a system is provided. The system includes a combustion chamber of a power-generation gas turbine. In addition, the system includes one or more radio-frequency power sources and a plurality of resonators. The plurality of resonators is electromagnetically coupled to the one or more radio-frequency power sources. Each resonator of the plurality of resonators has a respective resonant wavelength and includes (i) a respective first conductor, (ii) a respective second conductor, and (iii) a respective dielectric between the first conduct and the second conductor. Each resonator of the plurality of resonators is configured such that, when the resonator is excited by a corresponding radio-frequency power source of the one or more radio-frequency power sources with a respective signal having a wavelength proximate to an odd-integer multiple of one-quarter of the resonant wavelength, the resonator provides at least one of a plasma corona or electromagnetic waves. The system also includes a fuel conduit configured to couple to a fuel source and having a fuel outlet for expelling fuel into a combustion zone of the combustion chamber. At least a first portion of the fuel conduit is disposed within the first conductor of a given resonator of the plurality of resonators.

In a second implementation, a method is provided. The method includes providing at least one plasma corona in a combustion chamber of a power-generation gas turbine by (a) exciting at least one resonator of a plurality of resonators with a respective signal having a wavelength proximate to an odd-integer multiple of one-quarter of a resonant wavelength of the resonator, each resonator of the plurality of the resonators including (i) a respective first conductor, (ii) a respective second conductor, and (iii) a respective dielectric between the first conductor and the second conductor; and (b) providing, using one or more direct-current power sources, a respective bias signal between the first conductor and the second conductor of the at least one resonator. The method also includes moving fuel from a fuel source into the combustion chamber of the power-generation gas turbine by way of a fuel conduit such that the at least one plasma corona causes combustion of the fuel. A portion of the fuel conduit is disposed within the first conductor of a given resonator of the plurality of resonators.

In a third implementation, a method is provided. The method includes providing electromagnetic waves by exciting each resonator of a plurality of resonators. Each resonator includes (i) a respective first conductor, (ii) a respective second conductor, and (iii) a respective dielectric between the first conductor and the second conductor. The method also includes moving fuel from a fuel source into a combustion chamber of a power-generation gas turbine by way of a plurality of fuel conduits. Each fuel conduit of the plurality of fuel conduits corresponds to a respective resonator of the plurality of resonators, with a portion of the fuel conduit being disposed within the first conductor of the resonator such that the fuel moving through the fuel conduit is exposed to the electromagnetic waves, thereby pre-treating fuel within the fuel conduit so as to provide pre-treated fuel.

Other implementations will become apparent to those of ordinary skill in the art by reading the following detailed description, with reference where appropriate to the accompanying drawings.

### BRIEF DESCRIPTION OF THE FIGURES

FIG. 1A illustrates a cross-sectional view of an internal combustion engine.

FIG. 1B illustrates an isometric view of an example quarter-wave coaxial cavity resonator (QWCCR) structure, according to example implementations.

FIG. 1C illustrates a cutaway side view of a QWCCR structure, according to example implementations.

FIG. 1D illustrates a cross-sectional view of a QWCCR structure, according to example implementations.

FIG. 1E is a cross-sectional illustration of an electromagnetic mode in a QWCCR structure, according to example implementations.

FIG. 1F is a cross-sectional illustration of an electromagnetic mode in a QWCCR structure, according to example implementations.

FIG. 1G is a plot of a quarter-wave resonance condition of a QWCCR structure, according to example implementations.

FIG. 2 illustrates a system that includes a coaxial resonator, according to example implementations.

FIG. 3A illustrates a system that includes a coaxial resonator, according to example implementations.

FIG. 3B illustrates a system that includes a coaxial resonator, according to example implementations.

FIG. 4A illustrates a system that includes a coaxial resonator, according to example implementations.

FIG. 4B illustrates a controller, according to example implementations.

FIG. 5 illustrates a cutaway side view of a QWCCR structure connected to a fuel pump and a fuel tank, according to example implementations.

FIG. 6 illustrates a cross-sectional view of an example coaxial resonator connected to a direct-current (DC) power source through an additional resonator assembly acting as a radio-frequency (RF) attenuator, according to example implementations.

FIG. 7 illustrates a cross-sectional view of an example coaxial resonator connected to a DC power source through an additional resonator assembly acting as an RF attenuator, according to example implementations.

FIG. 8 illustrates core components of a power-generation turbine.

FIG. 9 illustrates a partial cross-sectional view of a combustor of a power-generation turbine.

FIG. 10 illustrates a resonator structure having a fuel conduit connected to a fuel pump and a fuel tank, according to example implementations.

FIG. 11 illustrates a resonator structure having a fuel conduit connected to a fuel pump and a fuel tank, according to example implementations.

FIG. 12A is an elevation view of a conductor and fuel conduit of a resonator, according to example implementations.

FIG. 12B is a cross-sectional view of the conductor and fuel conduit shown in FIG. 12A.

FIG. 12C is an elevation view of a conductor and fuel conduit of a resonator, according to example implementations.

FIG. 12D is a cross-sectional view of the conductor and fuel conduit shown in FIG. 12C.

FIG. 13A is an elevational view a resonator structure having a fuel conduit, according to example implementations.

FIG. 13B is a cross-sectional view of the resonator shown in FIG. 13A.

FIG. 14 illustrates a cross-sectional view of a resonator having a fuel conduit within a conductor, according to example implementations.

FIG. 15A is an elevation view of a conductor, according to example implementations.

FIG. 15B is a cross-sectional view of the conductor shown in FIG. 15A.

FIG. 15C is an elevation view of a conductor, according to example implementations.

FIG. 15D is a cross-sectional view of the conductor shown in FIG. 15C.

FIG. 16 illustrates a resonator structure having a fuel conduit connected to a fuel pump and a fuel tank, according to example implementations.

FIG. 17A illustrates a perspective view of a combustor, according to example implementations.

FIG. 17B illustrates cross-sectional views of a combustor, according to example implementations.

FIG. 17C illustrates cross-sectional views of a combustor, according to example implementations.

FIG. 18A illustrates an end-view of a portion of a combustor, according to example implementations.

FIG. 18B illustrates a cross-sectional view of the portion of FIG. 18A, according to example implementations.

FIG. 19 is a cutaway side view of a strut and a resonator, according to example implementations.

FIG. 20 is a flow chart depicting operations of a representative method, according to example implementations.

FIG. 21 is a flow chart depicting operations of a representative method, according to example implementations.

### DETAILED DESCRIPTION

Example methods, devices, and systems are presently disclosed. It should be understood that the word “example” is used in the present disclosure to mean “serving as an instance or illustration.” Any implementation or feature presently disclosed as being an “example” is not necessarily to be construed as preferred or advantageous over other implementations or features. Other implementations can be utilized, and other changes can be made, without departing from the scope of the subject matter presented in the present disclosure.

Thus, the example implementations presently disclosed are not meant to be limiting. Components presently disclosed and illustrated in the figures can be arranged, substituted, combined, separated, and designed in a wide variety of different configurations, all of which are contemplated in the present disclosure.

Further, unless context suggests otherwise, the features illustrated in each of the figures can be used in combination with one another. Thus, the figures should be generally viewed as components of one or more overall implementations, with the understanding that not all illustrated features are necessary for each implementation.

In the context of this disclosure, various terms can refer to locations where, as a result of a particular configuration, and under certain conditions of operation, a voltage component can be measured as close to non-existent. For example, “voltage short” can refer to any location where a voltage component can be close to non-existent under certain conditions. Similar terms can equally refer to this location of close-to-zero voltage (for example, “virtual short circuit,” “virtual short location,” or “voltage null”). In examples, “virtual short” can be used to indicate locations where the close-to-zero voltage is a result of a standing wave crossing zero. “Voltage null” can be used to refer to locations of close-to-zero voltage for a reason other than as result of a standing wave crossing zero (for example, voltage attenuation or cancellation). Moreover, in the context of this disclosure, each of these terms that can refer to locations of close-to-zero voltage are meant to be non-limiting.

In an effort to provide technical context for the present disclosure, the information in this section can broadly describe various components of the implementations presently disclosed. However, such information is provided solely for the benefit of the reader and, as such, does not expressly limit the claimed subject matter. Further, components shown in the figures are shown for illustrative purposes only. As such, the illustrations are not to be construed as limiting. As is understood, components can be added, removed, or rearranged without departing from the scope of this disclosure.

### I. Overview

A resonator can be excited so as to establish a plasma corona and/or electromagnetic radiation. An example of such a resonator can include a first conductor and a second conductor, which could be separated by a dielectric insulator such as a ceramic material. In some implementations, the resonator can also be configured to provide fuel into a combustion environment or other type of environment in which fuel may be desired.

In an example implementation, the resonator can provide fuel through the first conductor. For instance, the first conductor can include one or more fuel conduits, through which fuel can pass. These conduits can terminate at one or more fuel outlets out of which the fuel can be expelled into the environment and/or into another portion of the resonator. The first conductor can be an inner, center conductor, and at least a portion of the first conductor can be disposed within a cavity defined by the second conductor. Alternatively, the first conductor can be an outer conductor that defines a cavity, and at least a portion of the second conductor can be disposed within the cavity defined by the first conductor.

Using a resonator configured in this manner in a power-generation gas turbine can be advantageous in a variety of ways. For example, the resonator can be used as a substitute or supplement for a separate fuel injector component, possibly even eliminating a need for such a component. As another example, passing the fuel through the first conductor can expose the fuel to resonator-generated electromagnetic waves, which can result in a reformation of the fuel before the resonator provides the fuel into a combustion chamber of the power-generation gas turbine and/or ignites the fuel. And in addition, outlets of the fuel conduit can be oriented towards the location where the resonator will excite a plasma corona, thereby providing the fuel proximate to the ignition source (particularly, toward/through the plasma corona), which can improve the resulting combustion.

Furthermore, in some implementations, a resonator configured in this manner can be used together with additional resonators within a combustion chamber of a power-generation gas turbine. Optionally, one or more of the additional resonators can also be configured such that fuel passes through a first conductor respectively of each of one or more of the additional resonators and is exposed to electromagnetic waves. Advantageously, when multiple resonators are configured such that fuel passes through a first conductor of each of the resonators, a greater amount of fuel can be reformed before entering the combustion chamber of the power-generation gas turbine as opposed to an amount of fuel that can be reformed when only a single resonator includes a fuel conduit. Additionally or alternatively, one or more of the additional resonators can be controlled so as to provide a plasma corona. When multiple resonators are controlled so as to provide multiple plasma coronas within a combustion chamber of a power-generation gas turbine, fuel introduced into the combustion chamber may combust at multiple ignition points, thereby increasing the probability of fuel being combusted before exiting the combustion chamber. Increasing the probability of fuel being combusted may improve various operating characteristics of the power-generation gas turbine, including fuel efficiency and emissions, for example.

### II. Example Combustion

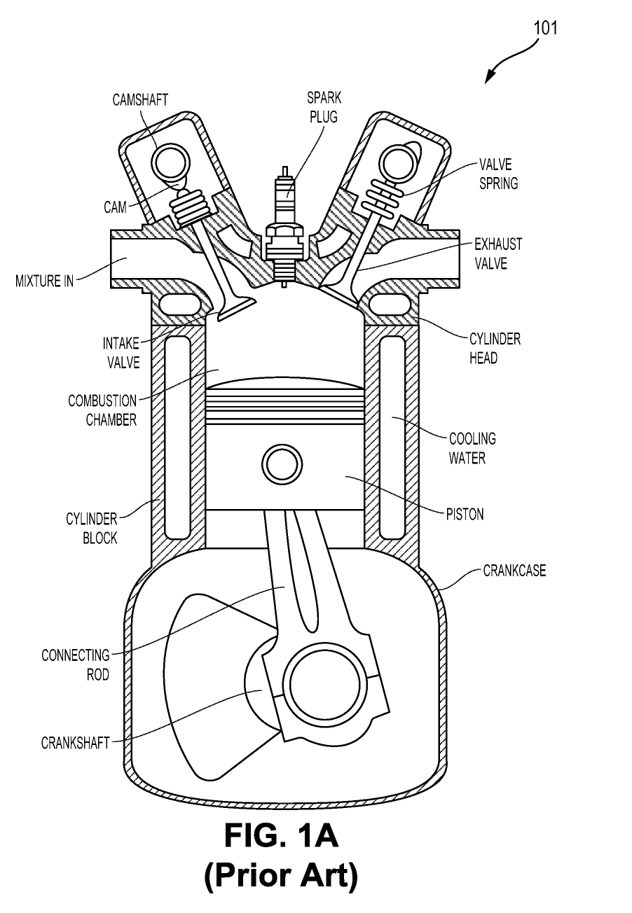

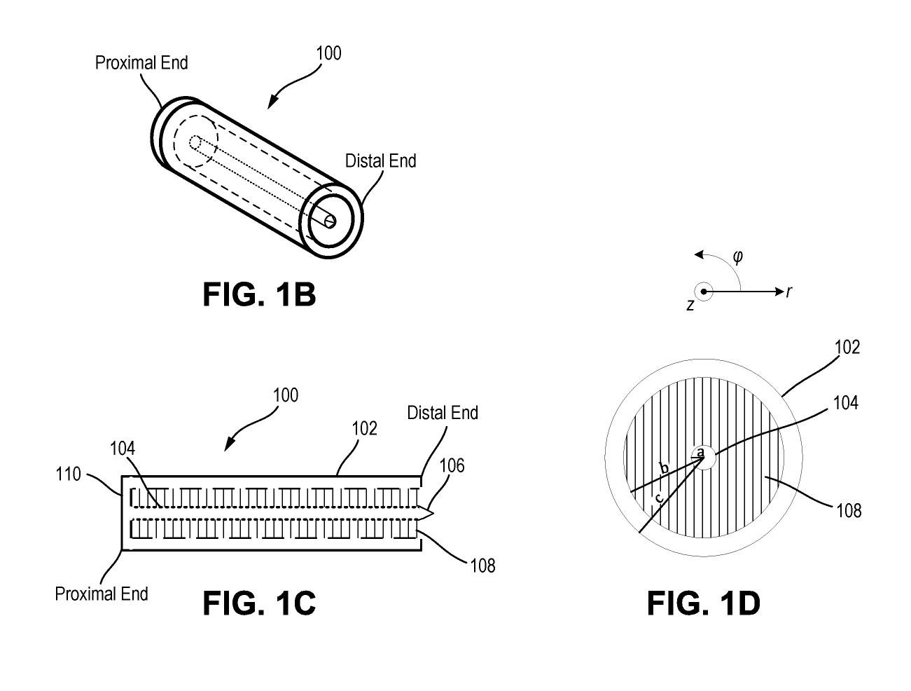

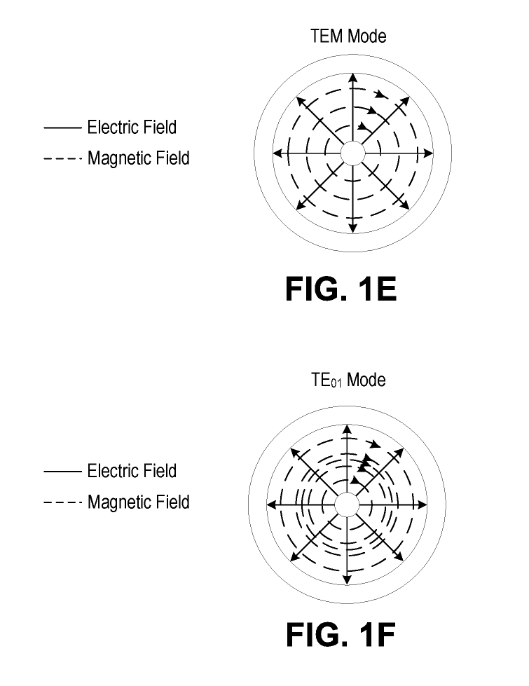

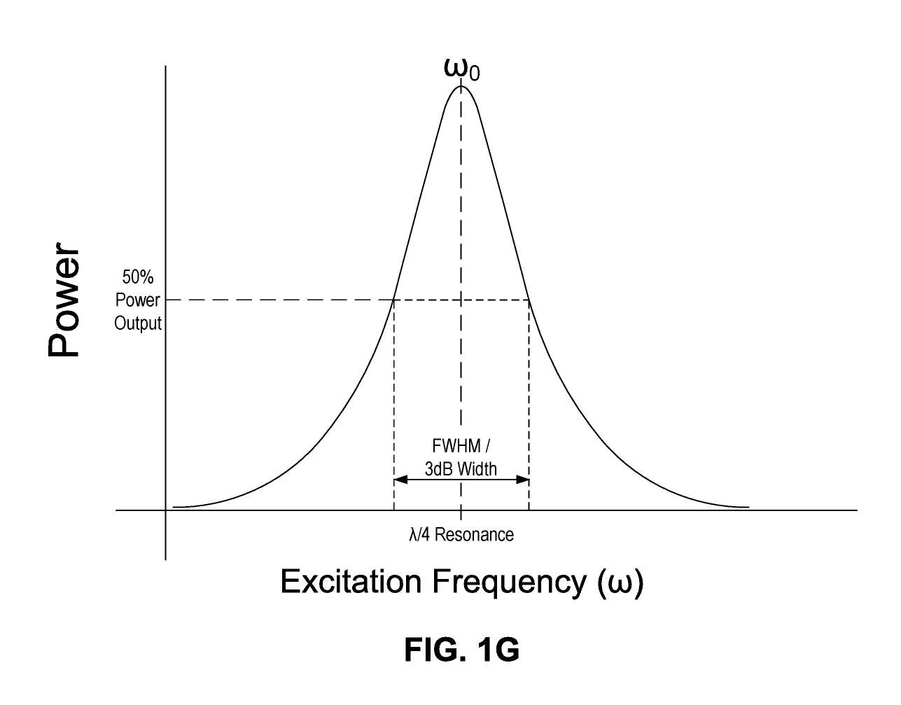

Igniters can be used to ignite a mixture of air and fuel (for example, within a combustion chamber of an internal combustion engine 101, such as that illustrated in cross-section in FIG. 1A). For example, igniters can be configured as gap spark igniters, similar to an automotive spark plug. However, gap spark igniters might not be desirable in some applications and/or under some conditions. For example, a gap spark igniter might not be capable of igniting and initiating combustion of fuel mixtures that have fuel-to-air ratios below a certain threshold. Further, lean mixtures of fuel and air might have significant environmental and economic benefits by making combustion (for example, within a combustor or an afterburner) more efficient, and thus, using a gap spark igniter might preclude achieving such benefits. In addition, higher thermal efficiencies can be achieved by operating at higher power densities and pressures. However, using more energetic or powerful gap spark igniters reduces overall ignition efficiency because the higher energy levels can be detrimental to the gap spark igniter's lifetime. Higher energy levels might also contribute to the formation of undesirable pollutants and can reduce overall engine efficiency.

While gap spark igniters are described above, other types of igniters can generally include glow plugs (for example, in diesel-fueled internal combustion engines), open flame sources (for example, cigarette lighters, friction spark devices, etc.), and other heat sources.

A variety of fuels (for example, hydrocarbon fuels) can be combusted to yield energy within an internal combustion engine, within a power-generation turbine, within a jet engine, or within various other applications. For example, kerosene (also known as paraffin or lamp oil), gasoline (also known as petrol), fractional distillates of petroleum fuel oil (for example, diesel fuel), crude oil, Fischer-Tropsch synthesized paraffinic kerosene, natural gas, and coal are all hydrocarbon fuels that, when combusted, liberate energy stored within chemical bonds of the fuel. Jet fuel, specifically, can be classified by its “jet propellant” (JP) number. The “jet propellant” (JP) number can correspond to a classification system utilized by the United States military. For example, JP-1 can be a pure kerosene fuel, JP-4 can be a 50% kerosene and 50% gasoline blend, JP-9 can be another kerosene-based fuel, JP-9 can be a gas turbine fuel (for example, including tetrahydrodimethylcyclopentadiene) specifically used in missile applications, and JP-10 can be a fuel similar to JP-9 that includes endo-tetrahydrodicyclopentadiene, exo-tetrahydrodicyclopentadiene, and adamantane. Other forms of jet fuel include zip fuel (for example, high-energy fuel that contains boron), SYNTROLEUM® FT-fuel, other kerosene-type fuels (for example, Jet A fuel and Jet A-1 fuel), and naphtha-type fuels (for example, Jet B fuel). It is understood that other fuels can be combusted as well. Further, the fuel type used can depend upon the application. For example, jet engines, internal combustion engines, and power-generation turbines may each burn different types of fuels.

When fuel (for example, hydrocarbon fuel) interacts with electromagnetic radiation, the fuel can change chemical composition. For example, when hydrocarbon fuel interacts with (for example, is irradiated by) microwaves, some of the hydrogen atoms can be ionized and/or one or more hydrogen atoms can be liberated from a hydrocarbon chain. The processes of liberating hydrogen within fuel, ionizing hydrogen within fuel, or otherwise changing the chemical composition of fuel are collectively referred to in the present disclosure as “reforming” the fuel. Reforming the fuel can include exciting the hydrocarbon fuel at one or more of its natural resonant frequencies (for example, acoustic and/or electromagnetic resonant frequencies) to break one or more of the carbon-hydrogen (or other) bonds within the hydrocarbon chain. When hydrogen within a hydrocarbon fuel becomes ionized and/or is liberated from the hydrocarbon chain, the resulting hydrocarbon fuel can require less energy to burn. Thus, a leaner fuel/air mixture that includes reformed fuel can achieve the same output power (for example, within a combustion chamber of a jet engine or a power-generation turbine) as compared to a more rich fuel/air mixture that includes non-reformed fuel, since the reformed fuel can combust more quickly and thoroughly. Analogously, when comparing equal fuel-to-air ratios, less input energy can be required to combust a mixture that includes reformed fuel when compared to a mixture that includes non-reformed fuel.

In addition to reforming fuels, electromagnetic radiation can alter an energy state of fuel and/or of a fuel mixture. In an example implementation, altering the energy state of fuel can include exciting electrons within the valence band of the hydrocarbon chain to higher energy levels. In such scenarios, raising the energy state can also include reorienting polar molecules (for example, water and/or polar hydrocarbon chains) within a fuel/air mixture due to electromagnetic fields applying a torque on polar molecules. Reorienting polar molecules can result in molecular motion, thereby increasing an effective temperature and/or kinetic energy of the molecule, which raises the energy state of fuel. By raising the energy state of fuel, the activation energy for combustion of the fuel can be reduced. When the activation energy for combustion is reduced, the energy supplied by the ignition source can also be decreased, thereby conserving energy during ignition.

Presently disclosed are ignition systems with resonators (for example, QWCCR structures) that use both RF power and DC power. The presently disclosed RF ignition systems provide an alternative to other types of igniters. For example, the QWCCR structure can be used as an igniter (for example, in place of an automotive gap spark plug) in the internal combustion engine 101. Such RF ignition systems can excite plasma (for example, within a corona). If an igniter is configured as one of the RF ignition systems presently disclosed, then more efficient, leaner, cleaner combustion can be achieved. Such increased combustion efficiency can be achieved at decreased air pressures and temperatures when compared with a gap spark igniter (for example, if the RF ignition system is used in a jet engine). Further, such increased combustion efficiency can be achieved at higher air pressures and temperatures when compared with a gap spark igniter. It is understood throughout this disclosure that where reference is made to “RF” or to microwaves, in alternate implementations, other wavelengths of electromagnetic waves outside of the RF range can be used alternatively or in addition to RF electromagnetic waves.

As described above, RF ignition systems can excite plasma. Plasma is one of the four fundamental states of matter (in addition to solid, liquid, and gas). Further, plasmas are mixtures of positively charged gas ions and negatively charged electrons. Because plasmas are mixtures of charged particles, plasmas have associated intrinsic electric fields. In addition, when the charged particles in the mixture move, plasmas also produce magnetic fields (for example, according to Ampere's law). Given the electromagnetic nature of plasmas, plasmas interact with, and can be manipulated by, external electric and magnetic fields. For example, placing a ferromagnetic material (for example, iron, cobalt, nickel, neodymium, samarium-cobalt, etc.) near a plasma can cause the plasma to be attracted to or repelled from the ferromagnetic material (for example, causing the plasma to move).

Plasmas can be formed in a variety of ways. One way of forming a plasma can include heating gases to a sufficiently high temperature (for example, depending on ambient pressure). Additionally or alternatively, forming a plasma can include exposing gases to a sufficiently strong electromagnetic field. Lightning is an environmental phenomenon involving plasma. One application of plasma can include neon signs. Further, because plasma is responsive to applied electromagnetic fields, plasma can be directed according to specific patterns. Hence, plasmas can also be used in technologies such as plasma televisions or plasma etching.

Plasmas can be characterized according to their temperature and electron density. For example, one type of plasma can be a “microwave-generated plasma” (for example, ranging from 5 eV to 15 eV in energy). Such a plasma can be generated by a QWCCR structure, for example.

### III. Example Resonator

An example implementation of a QWCCR structure 100 is illustrated in FIGS. 1B-1D. As illustrated, the QWCCR structure 100 can include an outer conductor 102, an inner conductor 104 with an associated electrode 106, a base conductor 110, and a dielectric 108. Also as illustrated, the QWCCR structure 100 can be shaped as concentric circular cylinders. The inner conductor 104 can have radius ‘a’, the outer conductor 102 can have inner radius ‘b’, and the outer conductor 102 can have outer radius ‘c’, as illustrated in cross-section in FIG. 1D. In alternate implementations, the QWCCR structure 100 can have other shapes (for example, concentric ellipsoidal cylinders or concentric, enclosed, elongated volumes with square or rectangular cross-sections). The inner conductor 104, the outer conductor 102 (or just the inner surface of the outer conductor 102), the electrode 106, and the base conductor 110 can be made of various conductive materials (for example, steel, gold, silver, platinum, nickel, or alloys thereof). Further, in some implementations, the inner conductor 104, the outer conductor 102, and the base conductor 110 can be made of the same conductive materials, while in other implementations, the inner conductor 104, the outer conductor 102, and the base conductor 110 can be made of different conductive materials. Additionally, in some implementations, the inner conductor 104, the outer conductor 102, and/or the base conductor 110 can include a dielectric material coated in a conductor (for example, a metal-plated ceramic). In such implementations, the conductive coating can be thicker than a skin-depth of the conductor at a given excitation frequency of the QWCCR structure 100 such that electricity is conducted throughout the conductive coating.

As illustrated, an electrode 106 can be disposed at a distal end of the inner conductor 104. The electrode 106 can be made of a conductive material as described above (for example, the same conductive material as the inner conductor 104). For example, the electrode 106 can be machined with the inner conductor 104 as a single piece. In some implementations, as illustrated, the base conductor 110, the outer conductor 102, the inner conductor 104, and the electrode can be shorted together. For example, the base conductor 110 can short the outer conductor 102 to the inner conductor 104, in some implementations. When shorted together, these components can be directly electrically coupled to one another such that each of these components is at the same electric potential.

Further, in implementations where the base conductor 110, the outer conductor 102, and the inner conductor 104 (including the electrode 106) are shorted together, the base conductor 110, the outer conductor 102, and the inner conductor 104 (including the electrode 106) can be machined as a single piece. In addition, the electrode 106 can include a concentrator (for example, a tip, a point, or an edge), which can concentrate and enhance the electric field at one or more locations. Such an enhanced electric field can create conditions that promote the excitation of a plasma corona near the concentrator (for example, through a breakdown of a dielectric, such as air, that surrounds the concentrator). The concentrator can be a patterned or shaped portion of the electrode 106, for example. The electrode 106, including the concentrator, can be electromagnetically coupled to the inner conductor 104. In the present disclosure and claims, the electrode 106 and/or the concentrator can be described as being “configured to electromagnetically couple to” the inner conductor 104. This language is to be interpreted broadly as meaning that the electrode 106 and/or the concentrator: are presently electromagnetically coupled to the inner conductor 104, are always electromagnetically coupled to the inner conductor 104, can be selectively electromagnetically coupled to the inner conductor 104 (for example, using a switch), are only electromagnetically coupled to the inner conductor 104 when a power source is connected to the inner conductor 104, and/or are able to be electromagnetically coupled to the inner conductor 104 if one or more components are repositioned relative to one another. For example, the electrode 106 can be “configured to electromagnetically couple to” the inner conductor 104 if the electrode 106 is machined as a single piece with the inner conductor 104, if the electrode 106 is connected to the inner conductor 104 using a wire or other conducting mechanism, or if the electrode 106 is disposed sufficiently close to the inner conductor 104 such that the electrode 106 electromagnetically couples to one or more evanescent waves excited by the inner conductor 104 when the inner conductor 104 is connected to a power source.

As illustrated in FIG. 1C, the electrode 106 and/or a concentrator of the electrode 106 can extend beyond the distal end of the outer conductor 102 and/or the distal end of the dielectric 108. In alternate implementations, the electrode 106 and/or a concentrator of the electrode 106 can be flush with the distal end of the outer conductor 102 and/or the distal end of the dielectric 108. In alternate implementations, the electrode 106 and/or a concentrator of the electrode 106 can be shorter than the outer conductor 102, such that no portion of the electrode 106 and/or concentrator is flush with the distal end of the outer conductor 102 and no portion extends beyond the distal end of the outer conductor 102. The QWCCR structure 100 can be excited at resonance, in some implementations. The resonance can generate a standing voltage quarter-wave within the QWCCR structure 100. If the concentrator, the distal end of the outer conductor 102, and the distal end of the dielectric 108 are each flush with one another, the electromagnetic field can quickly collapse outside of the QWCCR structure 100, thereby concentrating the majority of the electromagnetic energy at the concentrator. In still other implementations, the distal end of the outer conductor 102 and/or the distal end of the dielectric 108 can extend beyond the electrode 106 and/or a concentrator of the electrode 106. The electrode 106 can effectively modify the physical length of the inner conductor 104, which can modify the resonance conditions of the QWCCR structure 100 (for example, can modify the electrical length of the QWCCR structure 100). Various resonance conditions can thus be achieved across a variety of QWCCR structures 100 by varying the geometry of the electrode 106 and/or a concentrator of the electrode 106.

Further, as illustrated in FIG. 1C, the base conductor 110 can be electrically coupled to the outer conductor 102 and the inner conductor 104. In alternate implementations, the inner conductor 104 can be electrically insulated from the outer conductor 102 (rather than shorted together through the base conductor 110).

Plasmas (for example, plasma coronas generated by the QWCCR structure 100) can be used to ignite mixtures of air and fuel (for example, hydrocarbon fuel for use in a combustion process). Plasma-assisted ignition (for example, using a QWCCR structure 100) is fundamentally different from ignition using a gap spark plug. For example, efficient electron-impact excitation, dissociation of molecules, and ionization of atoms, which might not occur in ignition using gap spark plugs, can occur in plasma-assisted ignition. Further, in plasmas, an external electric field can accelerate the electrons and/or ions. Thus, using electric fields, energy within the plasma (for example, thermal energy) can be directed to specific locations (for example, within a combustion chamber).

There are a variety of mechanisms by which plasma can impart the energy necessary to ignite mixtures of air and fuel. For example, electrons can impart energy to molecules during collisions. However, this singular energy exchange might be relatively minor (for example, because an electron's mass is orders of magnitude less than a molecule's mass). So long as the rate at which electrons are imparting energy to the molecules is higher than the rate at which molecules are undergoing relaxation, a population distribution of the molecules (for example, a population distribution that differs from an initial Boltzmann distribution of the molecules) can arise. The molecules having higher energy, along with the dissociation and ionization processes, can emit ultraviolet (UV) radiation (for example, when undergoing relaxation) that affects mixtures of fuel and air. Further, gas heating and an increase in system reactivity can increase the likelihood of ignition and flame propagation. In addition, when the average electron energy within a plasma (for example, within a combustion chamber) exceeds 10 eV, gas ionization can be the predominant mechanism by which plasma is formed (over electron-impact excitation and dissociation of molecules).

Plasma-assisted ignition can have a variety of benefits over ignition using a gap spark plug. For example, in plasma-assisted ignition, a plasma corona that is generated can be physically larger (for example, in length, width, radius, and/or overall volumetric extent) than a typical spark from a gap spark plug. This can allow a more lean fuel mixture (also known as lower fuel-to-air ratio) to be burned once combustion occurs as compared with alternative ignition, for example. Also, because a larger energy can be energized in plasma-assisted ignition, stoichiometric ratio fuels can be combusted more fully, thereby creating fewer regulated pollutants (for example, creating less NOₓ to be expelled as exhaust) and/or leaving less unspent fuel.

Dielectric breakdown of air or another dielectric material near the electrode 106 of the QWCCR structure 100 can be a mechanism by which a plasma corona is excited near the concentrator of the QWCCR structure 100. Factors that impact the breakdown of a dielectric, such as dielectric breakdown of air, include free-electron population, electron diffusion, electron drift, electron attachment, and electron recombination. Free electrons in the free-electron population can collide with neutral particles or ions during ionization events. Such collisions can create additional free electrons, thereby increasing the likelihood of dielectric breakdown. Oppositely, electron diffusion and attachment can each be mechanisms by which free electrons recombine and are lost, thereby reducing the likelihood of dielectric breakdown.

As presently described, a plasma corona can be provided “proximate to” a distal end of the QWCCR structure 100, the electrode 106, and/or a concentrator of the QWCCR structure 100. In other words, the plasma corona could be described as being provided “nearby” or “at” a distal end of the QWCCR structure 100, the electrode 106, and/or a concentrator of the QWCCR structure 100. Further, this terminology is not to be viewed as limiting. For example, while the plasma corona is provided “proximate to” the QWCCR structure 100, this does not limit the plasma corona from extending away from the QWCCR structure 100 and/or from being moved to other locations that are farther from the QWCCR structure 100 after being provided “proximate to” the QWCCR structure 100.

When used to describe a relationship between a plasma corona and a distal end of the QWCCR structure 100, a relationship between a plasma corona and the electrode 106, a relationship between a plasma corona and a concentrator of the electrode 106, or similar relationships, the term “proximate” can describe the physical separation between the plasma corona and the other component. In various implementations, the physical separation can include different ranges. For example, a plasma corona provided “proximate to” the concentrator can be separated from the concentrator (in other words, can “stand off from” the concentrator) by less than 1.0 nanometer, by 1.0 nanometer to 10.0 nanometers, by 10.0 nanometers to 100.0 nanometers, by 100.0 nanometers to 1.0 micrometer, by 1.0 micrometer to 10.0 micrometers, by 10.0 micrometers to 100.0 micrometers, or by 100.0 micrometers to 1.0 millimeter. Additionally or alternatively, a plasma corona provided “proximate to” the concentrator can be separated from the concentrator by 0.01 times a width of the plasma corona to 0.1 times a width of the plasma corona, by 0.1 times a width of the plasma corona to 1.0 times the width of the plasma corona, or by 1.0 times a width of the plasma corona to 10.0 times a width of the plasma corona. Even further, a plasma corona provided “proximate to” the concentrator can be separated from the concentrator by 0.01 times a radius of the concentrator to 0.1 times a radius of the concentrator, by 0.1 times a radius of the concentrator to 1.0 times a radius of the concentrator, or by 1.0 times a radius of the concentrator to 10.0 times a radius of the concentrator.

It is understood that in various implementations, the plasma corona can emit light entirely within the visible spectrum, partially within the visible spectrum and partially outside the visible spectrum, or completely outside the visible spectrum. In other words, even if the plasma corona is “invisible” to the human eye and/or to optics that only sense light within the visible spectrum, it is not necessarily the case that the plasma corona is not being provided.

### IV. Mathematical Description of Example Resonator

In order for dielectric breakdown to occur, an electric field within the dielectric must be greater than or equal to an electric field breakdown threshold. An electric field generated by an alternating current (AC) source can be described by a root-mean-square (rms) value for electric field (Eᵣₘₛ). The rms value for electric field (Eᵣₘₛ) can be calculated according the following equation:

$${E}_{rms} = \sqrt{\frac{1}{{T}_{2} - {T}_{1}} {\int }_{{T}_{1}}^{{T}_{2}} {E}^{2} dt}$$

where T₂−T₁ represents the period over which the electric field is oscillating (for example, corresponding to the period of the AC source generating the electric field). As described mathematically above, the rms value for electric field (Eᵣₘₛ) represents the quadratic mean of the electric field. Using the rms value for electric field, an effective electric field (E_{eff}) can be calculated that is approximately frequency independent (for example, by removing phase lag effects from the oscillating electric field):

$${E}_{eff}^{2} = {E}_{rms}^{2} \frac{{v}_{c}^{2}}{{ω}^{2} + {v}_{c}^{2}}$$

where ω represents the angular frequency of the electric field (for example,

$$ω = \frac{2 π}{{T}_{2} - {T}_{1}} )$$

and v_{c} represents the effective momentum collision frequency of the electrons and neutral particles. The angular frequency (ω) of the electric field can correspond to the frequency of an excitation source used to excite the electric field (for example, the QWCCR structure 100). Using this effective electric field (E_{eff}), DC breakdown voltages for various gases (and potentially other dielectrics) can be related to AC breakdown values for uniform electric fields. For air, v_{c}≈5·10⁹×p, where p represents the pressure (in torr). At atmospheric pressure (for example, around 760 torr) or above and excitation frequencies of below 1 THz, the effective momentum collision frequency of the electrons and neutral particles (v_{c}) will dominate the denominator of the fractional coefficient of Eᵣₘₛ². Therefore, an approximation of the rms breakdown field (E_{b}) can be used. The rms breakdown field (E_{b}), in V/cm, of a uniform microwave field in the collision regime can be given by:

$${E}_{b} = 30 \cdot 297 ( \frac{p}{T} )$$

where T is the temperature in Kelvin.

An analytical description of the electromagnetics of the QWCCR structure 100 follows.

If fringing electromagnetic fields are assumed to be small, the lowest quarter-wave resonance in a coaxial cavity is a transverse electromagnetic mode (TEM mode) (as opposed to a transverse electric mode (TE mode) or a transverse magnetic mode (TM mode)). The TEM mode is the dominant mode in a coaxial cavity and has no cutoff frequency (ωₑ). In the TEM mode (as illustrated in FIG. 1E), because neither the electric field nor the magnetic field have any components in the z-direction (coordinate system illustrated in FIG. 1D), the electric and magnetic fields can be written, respectively, as:

$$H = {H}_{ϕ} {\hat{a}}_{ϕ} = \frac{{I}_{0}}{2 π r} cos ( β z ) {\hat{a}}_{ϕ}$$

$$E = {E}_{r} {\hat{a}}_{r} = \frac{{V}_{0}}{2 π r} sin ( β z ) {\hat{a}}_{r}$$

where H is a phasor representing the magnetic field vector, E is a phasor representing the electric field vector, â_{φ} represents a unit vector in the φ direction (labeled in FIG. 1D), âᵣ represents a unit vector in the r direction (labeled in FIG. 1D), β represents the wave number (canonically defined as

$$β = \frac{2 π}{λ} ,$$

where λ is the wavelength), I₀ represents the maximum current in the cavity, V₀ represents the maximum voltage in the cavity, and z represents a distance along the QWCCR structure 100 in the z direction (labeled in FIG. 1D).

In various implementations, various electromagnetic modes of the QWCCR structure 100 can be excited in order to achieve various electromagnetic properties. In some implementations, for instance, a single electromagnetic mode can be excited, whereas in alternate implementations, a plurality of electromagnetic modes can be excited. For example, in some implementations, the TE₀₁ mode (as illustrated in FIG. 1F) can be excited.

Quality factor (Q) can be defined as:

$$Q = \frac{ω \cdot U}{{P}_{L}} \to U = \frac{{P}_{L} \cdot Q}{ω}$$

where ω is the angular frequency, U is the time-average energy, and P_{L} is the time-average power loss. Quality factor (Q) can be used to measure goodness of a resonator cavity. Other formulations of goodness measurement can also be used (for example, based on full-width, half-max (FWHM) or a 3 decibel (dB) bandwidth of cavity resonance). In some implementations, the quality factor (Q) can be maximized when the ratio of the inner radius of the outer conductor ‘b’ to the radius of the inner conductor ‘a’ is approximately equal to 4. However, it will be understood that many other ways to adjust and/or maximize quality factor (Q) are possible and contemplated in the present disclosure.

At resonance, the stored energy of the QWCCR structure 100 oscillates between electrical energy (Uₑ) (within the electric field) and magnetic energy (Uₘ) (within the magnetic field). Time-average stored energy in the QWCCR structure 100 can be calculated using the following:

$$U = {U}_{m} + {U}_{e} = \frac{1}{4} {\int }_{vol} μ {\vert H \vert}^{2} + ɛ {\vert E \vert}^{2}$$

where μ is magnetic permeability and E is dielectric permittivity. By inserting the values for electric field and magnetic field from above, and integrating over the entire volume of the QWCCR structure 100, the following expression can be obtained:

$$U = \frac{ln ( \frac{b}{a} ) \cdot λ}{64 π} ( μ \cdot {I}_{0}^{2} + ɛ \cdot {V}_{0}^{2} )$$

where b represents the inner radius of the outer conductor 102 of the QWCCR structure 100 (as illustrated in FIG. 1D), a represents the radius of the inner conductor 104 of the QWCCR structure 100 (as illustrated in FIG. 1D), and λ represents the wavelength of the source (for example, AC source) used to excite the QWCCR structure 100. Because the magnetic energy at maximum is the same as the electric energy at maximum, μ·I₀² can be replaced with ε·V₀², thus resulting in:

$$U = \frac{ln ( \frac{b}{a} ) \cdot λ}{32 π} ( ɛ \cdot {V}_{0}^{2} )$$

Now, by equating the two above expressions for U, the following relationship can be expressed:

$$\frac{{P}_{L} \cdot Q}{ω} = \frac{ln ( \frac{b}{a} ) \cdot λ}{32 π} ( ɛ \cdot {V}_{0}^{2} ) \to {V}_{0} = \sqrt{\frac{32 π \cdot Q \cdot {P}_{L}}{ω \cdot ɛ \cdot ln ( \frac{b}{a} ) \cdot λ}}$$

Further, in recognizing that

$$ω = 2 π f = \frac{2 π c}{λ} ,$$

where c is the speed of light;

$$c = \sqrt{\frac{1}{μ \cdot ɛ}} ; and η = \sqrt{\frac{μ}{ɛ}} ,$$

where η is the impedance of the dielectric between the inner conductor 104 and the outer conductor 102 of the QWCCR structure 100, the following relationship for the peak potential (V₀) can be identified:

$${V}_{0} = 4 \sqrt{\frac{η \cdot Q \cdot {P}_{L}}{ln ( \frac{b}{a} )}}$$

Given that electric field decays as the distance from the peak potential (V₀) increases, the largest value of electric field corresponding to the peak potential (V₀) occurs exactly at the surface of the inner conductor (for example, at radius a, as illustrated in FIG. 1D). Using the above equation for phasor electric field (E), the peak value of electric field (Eₐ) can be expressed as:

$${E}_{a} = \frac{{V}_{0}}{2 π a} = \frac{2}{π a} \sqrt{\frac{η \cdot Q \cdot {P}_{L}}{ln ( \frac{b}{a} )}}$$

If the above peak value of electric field (Eₐ) meets or exceeds the above-described rms breakdown field (E_{b}), a dielectric breakdown can occur. For example, a dielectric breakdown of the air surrounding the tip of the QWCCR structure 100 can result in a plasma corona being excited. As indicated in the above equation for peak electric field (Eₐ), the smaller the radius a of the inner conductor 104, the smaller the inner radius b of outer conductor 102, the higher the quality factor (Q) of the QWCCR structure 100, and the larger the time-average power loss (P_{L}), the more likely it is that breakdown can occur (for example, because the peak value of electric field (Eₐ) is larger). A larger excitation power can correspond to a larger time-average power loss (P_{L}) in the QWCCR structure 100, for example.

The power loss (P_{L}) can include ohmic losses (P_{σ}) on conductive surfaces (for example, the surface of the outer conductor 102, the surface of the inner conductor 104, and/or the surface of the base conductor 110, as illustrated in FIG. 1C), dielectric losses (P_{σ}_{ₑ}) in the dielectric 108, and radiation losses (P_{rad}) from a radiating end of the QWCCR structure 100 (for example, the distal end of the QWCCR structure 100). Each of the conductors can have a corresponding surface resistance (R_{S}). The surface resistance (R_{S}) can be the same for one or more of the conductors if the corresponding conductors are made of the same conductive materials. The corresponding surface resistance for each conductor can be expressed as

$${R}_{S} = \sqrt{\frac{ω \cdot {μ}_{c}}{2 \cdot {σ}_{c}}} ,$$

where μ_{c} is the magnetic permeability of the respective conductor and σ_{c} is the conductivity of the respective conductor. The power lost by each conductor can be calculated according to the following:

$${P}_{σ} = \frac{1}{2} {\int }_{A} {R}_{S} {\vert {H}_{//} \vert}^{2}$$

where H_{//} is the magnetic field parallel to the surface of the conductor. Thus, the total power loss in all conductors can be represented by:

$${P}_{σ} = {P}_{inner} + {P}_{outer} + {P}_{base} = \frac{{R}_{S} \cdot {I}_{0}^{2}}{4 π} [ \frac{λ}{8 \cdot a} + \frac{λ}{8 \cdot b} + ln ( \frac{b}{a} ) ]$$

Further, if the dielectric 108 is an isotropic, low-loss dielectric, the dielectric 108 can be characterized by its dielectric constant (E) and its loss tangent (tan(δₑ)), where the loss tangent (tan(δₑ)) represents conductivity and alternating molecular dipole losses. Using dielectric constant (E) and loss tangent (tan(δₑ)), an effective dielectric conductivity (σₑ) can be approximately defined as:

σₑ≈ω·ε·tan(δₑ)

Based on the above, the power dissipated in the dielectric can be calculated according to the following:

$${P}_{{σ}_{e}} = \frac{1}{2} {\int }_{vol} {σ}_{e} {\vert E \vert}^{2} = \frac{{σ}_{e} \cdot η \cdot {I}_{0}^{2}}{4 π} ( \frac{ln ( \frac{b}{a} ) \cdot λ}{8} )$$

In order to combine all quality factors of the QWCCR structure 100 into a total internal quality factor (Qᵢₙₜ), the following relationship can be used:

$${Q}_{int} = \frac{1}{( {Q}_{inner}^{- 1} + {Q}_{outer}^{- 1} + {Q}_{base}^{- 1} + {Q}_{{σ}_{e}}^{- 1} )}$$

where Qᵢₙₙₑᵣ⁻¹, Qₒᵤₜₑᵣ⁻¹, Q_{base}⁻¹, and Q_{σ}_{ₑ}⁻¹ are the quality factors of the inner conductor 104, the outer conductor 102, the base conductor 110, and the dielectric 108, respectively. Using the above expression for quality factor (Q) in terms of time-average power loss (P_{L}), angular frequency (ω), and time-average energy (U), the following expression for internal quality factor (Qᵢₙₜ) can be determined:

$${Q}_{int} = {( \frac{{R}_{S}}{2 \cdot π \cdot η} [ \frac{( \frac{b}{a} + 1 )}{\frac{b}{a} \cdot ln ( \frac{b}{a} )} + 8 ] + tan ( {δ}_{e} ) ]}^{- 1}$$

Based on the definitions of the individual quality factors above, the individual contribution of the outer conductor quality factor (Qₒᵤₜₑᵣ) to the internal quality factor (Qᵢₙₜ) can be greater than the individual contribution of the inner conductor quality factor (Qᵢₙₙₑᵣ). Thus, to increase the internal quality factor (Qᵢₙₜ), a material with higher conductivity can be used for the inner conductor 104 than is used for the outer conductor 102. Further, the base conductor 110 quality factor (Q_{base}) and the dielectric 108 quality factor (Q_{σ}_{ₑ}) can be unaffected by the geometry of the QWCCR structure 100 (both in terms of

$$\frac{b}{a}$$

and in terms of

$$\frac{b}{λ} ) .$$

The QWCCR structure 100 can also radiate electromagnetic waves (for example, from a distal, non-closed end opposite the base conductor 110). For example, if the QWCCR structure 100 is being excited by an RF power source (for example, a signal generator oscillating at radio frequencies), the QWCCR structure 100 can radiate microwaves from a distal end (for example, from an aperture of the distal end) of the QWCCR structure 100. Such radiation can lead to power losses, which can be approximated using admittance. Assuming that the transverse dimensions of the QWCCR structure 100 are significantly smaller than the wavelength (λ) being used to excite the QWCCR structure 100 (in other words, a<<λ and b<<A), the real part (Gᵣ) and imaginary part (Bᵣ) of admittance can be represented by:

$${G}_{r} \approx \frac{4 \cdot {π}^{5} \cdot {[ {( \frac{( \frac{b}{λ} )}{( \frac{b}{a} )} )}^{2} - {( \frac{b}{λ} )}^{2} ]}^{2}}{3 \cdot η \cdot {ln}^{2} ( \frac{b}{a} )}$$

$${B}_{r} \approx \frac{16 \cdot π \cdot ( \frac{( \frac{b}{λ} )}{( \frac{b}{a} )} - ( \frac{b}{λ} ) )}{η \cdot {ln}^{2} ( \frac{b}{a} )} \cdot [ E ( \frac{2 \sqrt{\frac{b}{a}}}{1 + \frac{b}{a}} ) - 1 ]$$

where E(x) is the complete elliptical integral of the second kind. Namely:

$$E ( x ) = {\int }_{0}^{\frac{π}{2}} \sqrt{1 - {x}^{2} \cdot {sin}^{2} ( θ )} \cdot d θ$$

Further, the line integral of the electric field from the inner conductor 104 to the outer conductor 102 can be used to determine the potential difference (V_{ab}) across the shunt admittance corresponding to the electromagnetic waves radiated.

$${V}_{ab} {\vert}_{β z = \frac{π}{4}} = {\int }_{a \to b} {E}_{r} = \frac{{V}_{0} ln ( \frac{b}{a} )}{2 π}$$

Using the potential difference (V_{ab}) across the shunt admittance corresponding to the electromagnetic waves radiated, the power going to radiation (P_{rad}) can be represented by:

$${P}_{rad} = \frac{1}{2} {G}_{r} {V}_{ab}^{2} = \frac{{V}_{0} {{{π}^{3} ( \frac{b}{λ} )}^{4} [ {( \frac{b}{a} )}^{2} - 1 ]}^{2}}{6 {η ( \frac{b}{a} )}^{4}}$$

In addition, using the potential difference (V_{ab}) across the shunt admittance corresponding to the electromagnetic waves radiated, the energy stored during radiation (U_{rad}) can be represented by:

$${U}_{rad} = \frac{1}{4} ( \frac{{B}_{r}}{ω} ) {V}_{ab}^{2} = \frac{ɛ {V}_{0}^{2} λ ( \frac{b}{λ} ) [ {( \frac{b}{a} )}^{- 1} + 1 ]}{2 {π}^{2}} [ E ( \frac{2 \sqrt{\frac{b}{a}}}{1 + \frac{b}{a}} ) - 1 ]$$

Based on the above, the overall quality factor of the QWCCR structure 100 (Q_{QWCCR}) can be described by the following:

$${Q}_{QWCCR} = \frac{ω ( U + {U}_{rad} )}{{P}_{inner} + {P}_{outer} + {P}_{base} + {P}_{{σ}_{e}} + {P}_{rad}}$$

If the energy stored during radiation (U_{rad}) is small compared with the energy stored in the interior of the QWCCR structure 100 (U), the radiation power (P_{rad}) can be treated similarly to the other losses. Further, the energy stored during radiation (U_{rad}) can be neglected in the above equation:

$$Q \approx \frac{ω ( U )}{{P}_{inner} + {P}_{outer} + {P}_{base} + {P}_{{σ}_{e}} + {P}_{rad}}$$

Still further, the quality factor of the radiation component (Q_{rad}) can be described using the above relationship for quality factors:

$${Q}_{rad} = \frac{ω U}{{P}_{rad}} = \frac{3 {( \frac{b}{λ} )}^{4} ln ( \frac{b}{a} )}{8 {{{π}^{3} ( \frac{b}{λ} )}^{4} [ {( \frac{b}{a} )}^{2} - 1 ]}^{2}}$$

Even further, using the above-referenced quality factors, the total quality factor of the QWCCR structure 100 (Q_{QWCCR}) can be approximated by:

$${Q}_{QWCCR} \approx {( \frac{8 {{{π}^{3} ( \frac{b}{λ} )}^{4} [ {( \frac{b}{a} )}^{2} - 1 ]}^{2}}{3 {( \frac{b}{a} )}^{4} ln ( \frac{b}{a} )} + \frac{{R}_{S}}{2 π η} [ \frac{( ( \frac{b}{a} ) + 1 )}{( \frac{b}{λ} ) ln ( \frac{b}{a} )} + 8 ] tan ( {δ}_{e} ) )}^{- 1}$$

Based on the above relationships, it can be shown that one method of minimizing losses due to radiation of electromagnetic waves by the QWCCR structure 100 is to minimize the inner radius b of the outer conductor 102 with respect to the excitation wavelength (A). Another way of minimizing losses due to radiation of electromagnetic waves is to select an inner radius b of the outer conductor 102 that is close in dimension to the radius a of the inner conductor 104.

Various physical quantities and dimensions of the QWCCR structure 100 can be adjusted to modify performance of the QWCCR structure 100. For example, physical quantities and dimensions can be modified to maximize and/or optimize the total quality factor of the QWCCR structure 100 (Q_{QWCCR}). In some implementations, different dielectrics can be inserted into the QWCCR structure 100. In one implementation, the dielectric 108 can include a composite of multiple dielectric materials. For example, a half of the dielectric 108 near a proximal end of the QWCCR structure 100 can include alumina ceramic while a half of the dielectric 108 near a distal end of the QWCCR structure 100 can include air. The resonant frequency can be based on the dimensions and the fabrication materials of the QWCCR structure 100. Hence, modification of the dielectric 108 can modify a resonant frequency of the QWCCR structure 100. In some implementations, the resonant frequency can be 2.45 GHz based on the dimensions of the QWCCR structure 100. In other implementations, the resonant frequency of the QWCCR structure 100 could be within an inclusive range between 1 GHz to 100 GHz. In still other implementations, the resonant frequency of the QWCCR structure 100 could be within an inclusive range of 100 MHz to 1 GHz or an inclusive range of 100 GHz to 300 GHz. However, other resonant frequencies are contemplated within the context of the present disclosure.

An RF power source exciting the QWCCR structure 100 can generate a standing electromagnetic wave within the QWCCR structure 100. In some implementations, the resonant frequency of the QWCCR structure 100 can be designed to match the frequency of an RF power source that is exciting the QWCCR structure 100 (for example, to maximize power transferred to the QWCCR structure 100). For example, if a desired excitation frequency corresponds to a wavelength of λ₀, dimensions of the QWCCR structure 100 can be modified such that the electrical length of the QWCCR structure 100 is an odd-integer multiple of quarter wavelengths (for example, ¼λ₀, ¾λ₀, 5/4λ₀, 7/4λ₀, 9/4λ₀, 11/4λ₀, 13/4λ₀, etc.). The electrical length is a measure of the length of a resonator in terms of the wavelength of an electromagnetic wave used to excite the resonator. The QWCCR structure 100 can be designed for a given resonant frequency based on the dimensions of the QWCCR structure 100 (for example, adjusting dimensions of the inner conductor 104, the outer conductor 102, or the dielectric 108) or the materials of the QWCCR structure 100 (for example, adjusting materials of the inner conductor 104, the outer conductor 102, or the dielectric 108).

In other implementations, the resonant frequency of the QWCCR structure 100 can be designed or adjusted such that its resonant frequency does not match the frequency of an RF power source that is exciting the QWCCR structure 100 (for example, to reduce power transferred to the QWCCR structure 100). Analogously, the frequency of an RF power source can be de-tuned relative to the resonant frequency of a QWCCR structure 100 that is being excited by the RF power source. Additionally or alternatively, the physical quantities and dimensions of the QWCCR structure 100 can be modified to enhance the amount of energy radiated (for example, from the distal end) in the form of electromagnetic waves (for example, microwaves) from the QWCCR structure 100. As an example, one or more elements of the QWCCR structure 100 could be movable or otherwise adjustable so as to modify the resonant properties of the QWCCR structure 100. Enhancing the amount of energy radiated might be done at the expense of maximizing the electric field at a concentrator of the electrode 106 at the distal end of the inner conductor 104. For example, some implementations can include slots or openings in the outer conductor 102 to increase the amount of radiated energy despite possibly reducing a quality factor of the QWCCR structure 100.

In still other implementations, the physical quantities and dimensions of the QWCCR structure 100 can be designed in such a way so as to enhance the intensity of an electric field at a concentrator of the electrode 106 of the QWCCR structure 100. Enhancing the electric field at a concentrator of the electrode 106 of the QWCCR structure 100 can result in an increase in plasma corona excitation (for example, an increase in dielectric breakdown near the concentrator), when the QWCCR structure 100 is excited with sufficiently high RF power/current. To increase electric field at a concentrator of the electrode 106 of the QWCCR structure 100, a radius of the concentrator can be minimized (for example, configured as a very sharp structure, such as a tip). Additionally or alternatively, to increase the electric field at a tip of the QWCCR structure 100 (for example, thereby increasing the intensity and/or size of an excited plasma corona), the intrinsic impedance (η) of the dielectric 108 can be increased, the power used to excite the QWCCR structure 100 can be increased, and the total quality factor of the QWCCR structure 100 (Q_{QWCCR}) can be increased (for example, by increasing the volume energy storage (U) of the cavity or by minimizing the surface and radiation losses).

Further, the shunt capacitance (C) of a circular coaxial cavity (for example, in farads/meter, and neglecting fringing fields) can be expressed as follows:

$$C = \frac{2 π {ɛ}_{0} {ɛ}_{r}}{ln ( \frac{b}{a} )}$$

where ε₀ represents the permittivity of free space, εᵣ represents the relative dielectric constant of the dielectric 108 between the inner conductor 104 and the outer conductor 102, b is the inner radius of the outer conductor 102, and a is the radius of the inner conductor 104 (as illustrated in FIG. 1D).

Similarly, the shunt inductance (L) of a circular coaxial cavity (for example, in henrys/meter) can be expressed as follows:

$$L = \frac{{µ}_{0} {µ}_{r}}{2 π} ln ( \frac{b}{a} )$$

where μ₀ represents the permeability of free space, μᵣ represents the relative permeability of the dielectric 108 between the inner conductor 104 and the outer conductor 102, b is the inner radius of the outer conductor 102, and a is the radius of the inner conductor 104 (as illustrated in FIG. 1D).

Based on the above, the complex impedance (Z) of a circular coaxial cavity (for example, in ohms, Ω) can be expressed as follows:

$$Z = \sqrt{\frac{R + j ω L}{G + j ω C}}$$

where G represents the conductance per unit length of the dielectric between the inner conductor and the outer conductor, R represents the resistance per unit length of the QWCCR structure 100, j represents the imaginary unit (for example, \sqrt{−1}), ω represents the frequency at which the QWCCR structure 100 is being excited, L represents the shunt inductance of the QWCCR structure 100, and C represents the shunt capacitance of the QWCCR structure 100.

At very high frequencies (for example, GHz frequencies) the complex impedance (Z) can be approximated by:

$${Z}_{0} = \sqrt{\frac{L}{C}}$$

where Z₀ represents the characteristic impedance of the QWCCR structure 100 (in other words, the complex impedance (Z) of the QWCCR structure 100 at high frequencies).

As described above, the shunt inductance (L) and the shunt capacitance (C) of the QWCCR structure 100 depend on the relative permeability (μᵣ) and the relative dielectric constant (εᵣ), respectively, of the dielectric 108 between the inner conductor 104 and the outer conductor 102. Thus, any modification to either the relative permeability GO or the relative dielectric constant (εᵣ) of the dielectric 108 between the inner conductor 104 and the outer conductor 102 can result in a modification of the characteristic impedance (Z₀) of the QWCCR structure 100. Such modifications to impedance can be measured using an impedance measurement device (for example, an oscilloscope, a spectrum analyzer, and/or an AC volt meter).

The above characteristic impedance (Z₀) represents an impedance calculated by neglecting fringing fields. In some applications and implementations, the fringing fields can be non-negligible (for example, the fringing fields can significantly impact the impedance of the QWCCR structure 100). Further, in such implementations, the composition of the materials surrounding the QWCCR structure 100 can affect the characteristic impedance (Z₀) of the QWCCR structure 100. Measurements of such changes to characteristic impedance (Z₀) can provide information regarding the environment (for example, a combustion chamber) surrounding the QWCCR structure 100 (for example, the temperature, pressure, or atomic composition of the environment). A change in the characteristic impedance (Z₀) can coincide with a change in the cutoff frequency, resonant frequency, short-circuit condition, open-circuit condition, lumped-circuit model, mode distribution, etc. of the QWCCR structure 100.

FIG. 1G illustrates a quarter-wave resonance condition of the QWCCR structure 100. The y-axis of the plot corresponds to a power of electromagnetic waves radiated from a distal end of the QWCCR structure 100 and the x-axis corresponds to an excitation frequency (ω) (for example, from a radio-frequency power source that is electromagnetically coupled to the QWCCR structure 100) used to excite the QWCCR structure 100. As illustrated, the shape of the curve can be a Lorentzian.

As illustrated in FIG. 1G the curve has a maximum power at a quarter-wave (λ/4) resonance. This resonance can correspond to excitation frequency (ω) that has an associated excitation wavelength that is four times the length of the QWCCR structure 100. In other words, at the resonant frequency (ω₀) the QWCCR structure 100 is being excited by a standing wave, where one-quarter of the length of the standing wave is equal to the length of the QWCCR structure 100. Although not illustrated, it is understood that the QWCCR structure 100 could experience additional resonances (for example, at odd-integer multiples of the resonant wavelength: ¾λ₀, 5/4λ₀, 7/4λ₀, 9/4λ₀, 11/4λ₀, 13/4λ₀, etc.). Each of the additional resonances could look similar to the resonance illustrated in FIG. 1G (for example, could have a Lorentzian shape).

As illustrated, the power of the electromagnetic waves radiated from the distal end of the QWCCR structure 100 decreases exponentially the further the excitation frequency (ω) is from the resonant frequency (ω₀). However, the power of the electromagnetic waves is not necessarily zero as soon as you move away from resonance. Hence, it is understood that even when excited near the quarter-wave resonance condition (in other words, proximate to the quarter-wave resonance condition), rather than exactly at the resonance condition, the QWCCR structure 100 can still radiate electromagnetic waves with non-zero power and/or provide a plasma corona, depending on arrangement.

When the QWCCR structure 100 is being excited such that it provides a plasma corona proximate to the distal end (for example, at the electrode 106), a plot with a shape similar to that of FIG. 1G could be provided. In such a scenario, a plot of voltage at the electrode 106 versus excitation frequency (ω) could include a Gaussian shape, rather than a Lorentzian shape. In other words, the voltage at the electrode 106 may reach a peak when excited by a resonant frequency. The voltage at the electrode 106 may fall off exponentially according to a Gaussian shape as the excitation frequency moves away from the resonant frequency. It will be understood that the Gaussian and Lorentzian shapes presently described may be based on one or more characteristics of the QWCCR structure 100, such as its shape, quality factor, bias conditions, or other factors.

It is understood that when the term “proximate” is used to describe a relationship between a wavelength of a signal (for example, a signal used to excite the QWCCR structure 100) and a resonant wavelength of a resonator (for example, the QWCCR structure 100), the term “proximate” can describe a difference in length. For example, if the wavelength of the signal is “proximate to an odd-integer multiple of one-quarter of the resonant wavelength,” the wavelength of the signal can be equal to, within 0.001% of, within 0.01% of, within 0.1% of, within 1.0% of, within 5.0% of, within 10.0% of, within 15.0% of, within 20.0% of, and/or within 25.0% of one-quarter of the resonant wavelength. Additionally or alternatively, if the wavelength of the signal is “proximate to an odd-integer multiple of one-quarter of the resonant wavelength,” the wavelength of the signal can be within 0.1 nm, within 1.0 nm, within 10.0 nm, within 0.1 micrometers, within 1.0 micrometers, within 10.0 micrometers, within 0.1 millimeters, within 1.0 millimeters, and/or within 1.0 centimeters of one-quarter of the resonant wavelength, depending on context (for example, depending on the resonant wavelength). Still further, if the wavelength of the signal is “proximate to an odd-integer multiple of one-quarter of the resonant wavelength,” the wavelength of the signal can be a multiple of one-quarter of the resonant wavelength that is an odd number plus or minus 0.5, an odd number plus or minus 0.1, an odd number plus or minus 0.01, an odd number plus or minus 0.001, and/or an odd number plus or minus 0.0001.

The quality factor of the QWCCR structure 100 (Q_{QWCCR}), described above, can be used to describe the width and/or the sharpness of the resonance (in other words, how quickly the power drops off as you excite the QWCCR structure 100 further and further from the resonance condition). For example, a square root of the quality factor can correspond to the voltage modification experienced at the electrode 106 of the QWCCR structure 100 when the QWCRR structure 100 is excited at the quarter-wave resonant condition. Additionally, the quality factor may be equal to the resonant frequency (ω₀) divided by full width at half maximum (FWHM). The FWHM is equal to the width of the curve in terms of frequency between the two points on the curve where the power is equal to 50% of the maximum power, as illustrated). The 50% power maximum point can also be referred to as the −3 decibel (dB) point, because it is the point at which the maximum voltage at the distal end of the QWCCR structure 100 decreases by 3 dB (or 29.29% for voltage) and the maximum power radiated by the QWCCR structure 100 decreases by 3 dB (or 50% for power). In various implementations, the FWHM of the QWCCR structure 100 could have various values. For example, the FWHM could be between 5 MHz and 10 MHz, between 10 MHz and 20 MHz, between 20 MHz and 40 MHz, between 40 MHz and 60 MHz, between 60 MHz and 80 MHz, or between 80 MHz and 100 MHz. Other FWHM values are also possible.

Further, the quality factor of the QWCCR structure 100 (Q_{QWCCR}) can also take various values in various implementations. For example, the quality factor could be between 25 and 50, between 50 and 75, between 75 and 100, between 100 and 125, between 125 and 150, between 150 and 175, between 175 and 200, between 200 and 300, between 300 and 400, between 400 and 500, between 500 and 600, between 600 and 700, between 700 and 800, between 800 and 900, between 900 and 1000, or between 1000 and 1100. Other quality factor values are also possible.

It is understood that, in alternate implementations, alternate structures (for example, alternate quarter-wave structures) can be used to emit electromagnetic radiation and/or excite plasma coronas (for example, other structures that concentrate electric field at specific locations using points or tips with sufficiently small radii). For example, other quarter-wave resonant structures, such as a coaxial-cavity resonator (sometimes referred to as a “coaxial resonator”), a dielectric resonator, a crystal resonator, a ceramic resonator, a surface-acoustic-wave resonator, a yttrium-iron-garnet resonator, a rectangular-waveguide cavity resonator, a parallel-plate resonator, a gap-coupled microstrip resonator, etc. can be used to excite a plasma corona.

Further, it is understood that wherever in this disclosure the terms “resonator,” “QWCCR,” “QWCCR structure,” and “coaxial resonator,” are used, any of the structures enumerated in the preceding paragraph could be used, assuming appropriate modifications are made to a corresponding system. In addition, the terms “resonator,” “QWCCR,” “QWCCR structure,” and “coaxial resonator” are not to be construed as inclusive or all-encompassing, but rather as examples of a particular structure that could be included in a particular implementation. Still further, when a “QWCCR structure” is described, the QWCCR structure can correspond to a coaxial resonator, a coaxial resonator with an additional base conductor, a coaxial resonator excited by a signal with a wavelength that corresponds to an odd-integer multiple of one-quarter (¼) of a length of the coaxial resonator, and other structures, in various implementations.

Additionally, whenever any “QWCCR,” “QWCCR structure,” “coaxial resonator,” “resonator,” or any of the specific resonators in this disclosure or in the claims are described as being “configured such that, when the resonator is excited by the radio-frequency power source with a signal having a wavelength proximate to an odd-integer multiple of one-quarter (¼) of the resonant wavelength, the resonator provides at least one of a plasma corona or electromagnetic waves,” some or all of the following are contemplated, depending on context. First, the corresponding resonator could be configured to provide a plasma corona when excited by the radio-frequency power source with a signal having a wavelength proximate to an odd-integer multiple of one-quarter (¼) of a resonant wavelength of the resonator. Second, the corresponding resonator could be configured to provide electromagnetic waves when excited by the radio-frequency power source with a signal having a wavelength proximate to an odd-integer multiple of one-quarter (¼) of a resonant wavelength of the resonator. Third, the corresponding resonator could be configured to provide, when excited by the radio-frequency power source with a signal having a wavelength proximate to an odd-integer multiple of one-quarter (¼) of a resonant wavelength of the resonator, both a plasma corona and electromagnetic waves.

### V. Example Resonator Systems

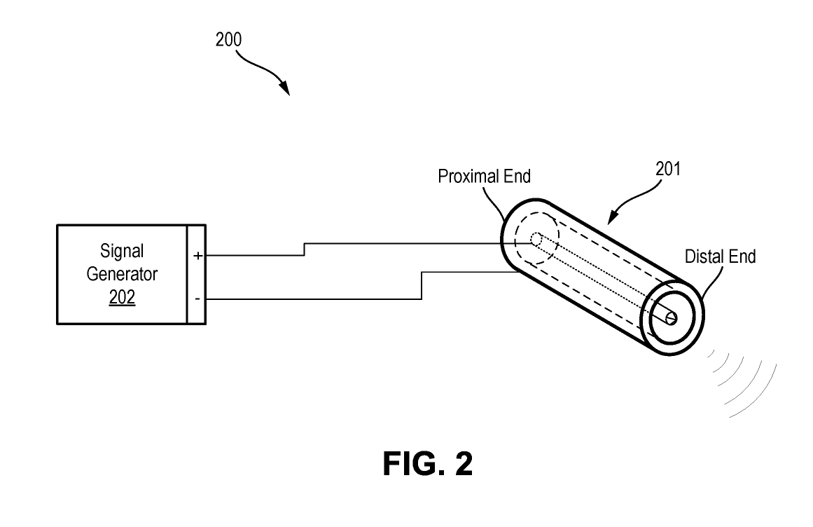

In some implementations, the coaxial resonator 201 can be used as an antenna (for example, instead of or in addition to generating a plasma corona). As an antenna, the coaxial resonator 201 can radiate electromagnetic waves. The electromagnetic waves can consequently influence charged particles. As illustrated in the system 200 of FIG. 2, such electromagnetic waves can be radiated when the coaxial resonator 201 is excited by a signal generator 202. For example, the signal generator 202 can be coupled to the coaxial resonator 201 in order to excite the coaxial resonator 201 (for example, to excite a plasma corona and to produce electromagnetic waves). Such a coupling can include inductive coupling (for example, using an induction feed loop), parallel capacitive coupling (for example, using a parallel plate capacitor), or non-parallel capacitive coupling (for example, using an electric field applied opposite a non-zero voltage conductor end). Further, the electrical distance between the signal generator 202 and the coaxial resonator 201 can be optimized (for example, minimized or adjusted based on wavelength of an RF signal) in order to minimize the amount of energy lost to heating and/or to maximize a quality factor. Further, in some implementations, the coaxial resonator 201 can radiate acoustic waves when excited (for example, at resonance). The acoustic waves produced can induce motion in nearby particles, for example.

The signal generator 202 can be a device that produces periodic waveforms (for example, using an oscillator circuit). In various implementations, the signal generator 202 can produce a sinusoidal waveform, a square waveform, a triangular waveform, a pulsed waveform, or a sawtooth waveform. Further, the signal generator 202 can produce waveforms with various frequencies (for example, frequencies between 1 Hz and 1 THz). The electromagnetic waves radiated from the coaxial resonator 201 can be based on the waveform produced by the signal generator 202. For example, if the waveforms produced by the signal generator 202 are sinusoidal waves having frequencies between 300 MHz and 300 GHz (for example, between 1 GHz and 100 GHz), the electromagnetic waves radiated by coaxial resonator 201 can be microwaves. In various implementations, the signal generator 202 can, itself, be powered by an AC power source or a DC power source.

Depending on the signal used by the signal generator 202 to excite the coaxial resonator 201, the coaxial resonator 201 can additionally excite one or more plasma coronas. For example, if a large enough voltage is used to excite the coaxial resonator 201, a plasma corona can be excited at the distal end of the electrode 106 (for example, at a concentrator of the electrode 106). In some implementations, a voltage step-up device can be electrically coupled between the signal generator 202 and the coaxial resonator 201. In such scenarios, the voltage step-up device can be operable to increase an amplitude of the AC voltage used to excite the coaxial resonator 201.

In some implementations, the signal generator 202 can include one or more of the following: an internal power supply; an oscillator (for example, an RF oscillator, a surface acoustic wave resonator, or a yttrium-iron-garnet resonator); and an amplifier. The oscillator can generate a time-varying current and/or voltage (for example, using an oscillator circuit). The internal power supply can provide power to the oscillator. In some implementations, the internal power supply can include, for example, a DC battery (for example, a marine battery, an automotive battery, an aircraft battery, etc.), an alternator, a generator, a solar cell, and/or a fuel cell. In other implementations, the internal power supply can include a rectified AC power supply (for example, an electrical connection to a wall socket passed through a rectifier). The amplifier can magnify the power that is output by the oscillator (for example, to provide sufficient power to the coaxial resonator 201 to excite plasma coronas). For example, the amplifier can multiply the current and/or the voltage output by the oscillator. Additionally, in some implementations, the signal generator 202 can include a dedicated controller that executes instructions to control the signal generator 202.

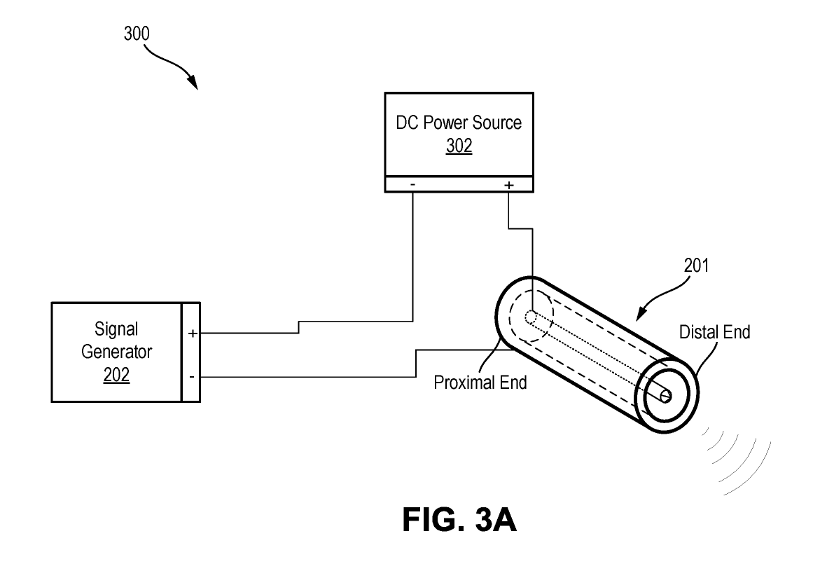

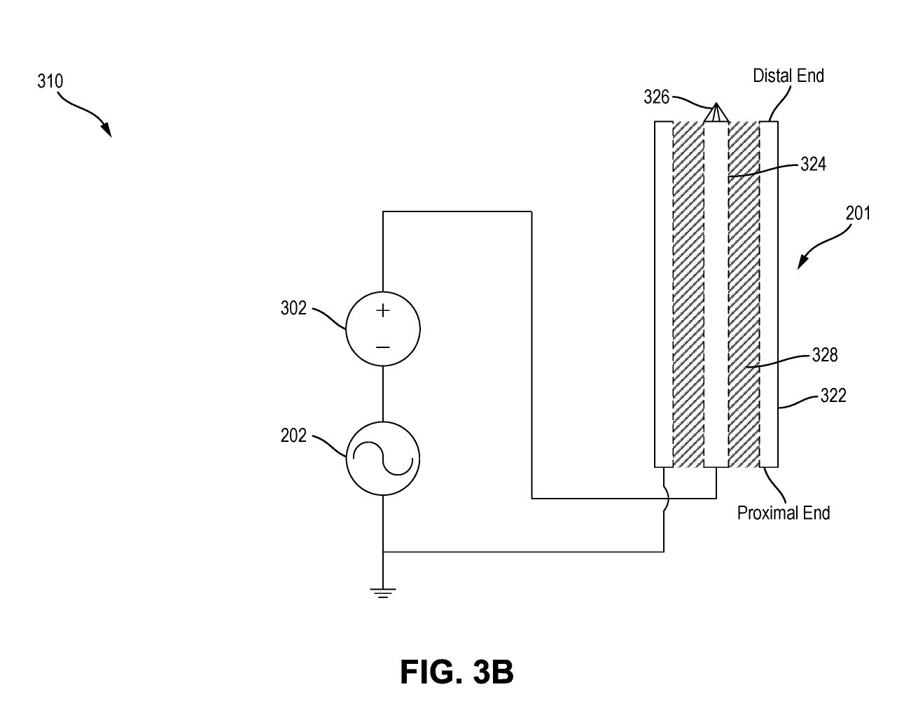

Additionally or alternatively, as illustrated in the system 300 of FIG. 3A, the coaxial resonator 201 can be electrically coupled (for example, using a wired connection or wirelessly) to a DC power source 302. Further, in some implementations, an RF cancellation resonator (not shown) can prevent RF power (for example, from the signal generator 202) from reaching, and potentially interfering with, the DC power source 302. The RF cancellation resonator can include resistive elements, lumped-element inductors, and/or a frequency cancellation circuit.

In some implementations, the DC power source 302 can include a dedicated controller that executes instructions to control the DC power source 302. The DC power source 302 can provide a bias signal (for example, corresponding to a DC bias condition) for the coaxial resonator 201. For example, a DC voltage difference between the inner conductor 104 and the outer conductor 102 of the coaxial resonator 201 in FIG. 3A can be established by the DC power source 302 by increasing the DC voltage of the inner conductor 104 and/or decreasing the DC voltage of the outer conductor 102 (given the orientation of the positive terminal and negative terminal of the DC power source 302). In other implementations, a DC voltage difference between the inner conductor 104 and the outer conductor 102 can be established by the DC power source 302 by decreasing the DC voltage of the inner conductor 104 and/or increasing the DC voltage of the outer conductor 102 (if the orientation of the positive terminal and negative terminal of the DC power source 302 in FIG. 3A were reversed). The bias signal (for example, the voltage of the bias signal and/or the current of the bias signal) output by the DC power source 302 can be adjustable.

By providing the coaxial resonator 201 with a bias signal, an increased voltage can be presented at a concentrator of the electrode 106, thereby yielding an increased electric field at the concentrator of the electrode 106. The total electric field at the concentrator can thus be a sum of the electric field from the bias signal of the DC power source 302 and the electric field from the signal generator 202 exciting the coaxial resonator 201 at a resonance condition (for example, exciting the coaxial resonator 201 at a quarter-wave resonance condition so the electric field of the signal from the signal generator 202 reaches a maximum at the distal end of the coaxial resonator 201). Because of this increased total electric field, an excitation of a plasma corona near the concentrator can be more probable.

As an alternative, rather than using a bias signal, the signal generator 202 can simply excite the coaxial resonator 201 using a higher voltage. However, this might use considerably more power than providing a bias signal and augmenting that bias signal with an AC voltage oscillation.

In some implementations, the DC power source 302 can be switchable (for example, can generate the bias signal when switched on and not generate the bias signal when switched off). As such, the DC power source 302 can be switched on when a plasma corona output is desired from coaxial resonator 201 and can be switched off when a plasma corona output is not desired from coaxial resonator 201. For example, the DC power source 302 can be switched on during an ignition sequence (for example, a sequence where fuel is being ignited within a combustion chamber to begin combustion), but switched off during a reforming sequence (for example, a sequence in which electromagnetic radiation is being used to chemically modify fuel). Further, in some implementations, the electric field at the concentrator of the electrode 106 used to initiate the plasma corona can be larger than the electric field at the concentrator used to sustain the plasma corona. Hence, in some implementations, the DC power source 302 can be switched on in order to excite the plasma corona, but switched off while the plasma corona is maintained by the signal from the signal generator 202.

In alternate implementations, the system 200 of FIG. 2 and/or the system 300 of FIG. 3A can include a plurality of coaxial resonators 201. If the system 200 of FIG. 2 includes a plurality of coaxial resonators 201, the plurality of coaxial resonators 201 can each be electrically coupled to the same signal generator (for example, such that each of the plurality of coaxial resonators 201 is excited by the same signal), can each be electrically coupled to a respective signal generator (for example, such that each of the plurality of coaxial resonators 201 is independently excited, thereby allowing for unique excitation frequency, power, etc. for each of the plurality of coaxial resonators 201), or one set of the plurality of coaxial resonators 201 can be connected to a common signal generator and another set of the plurality of coaxial resonators 201 can be connected to one or more other signal generators, which could be similar or different from signal generator 202. In implementations of the system 300 that include a plurality of coaxial resonators 201, each of the coaxial resonators 201 can be attached to a respective DC power source (for example, multiple instances of DC power source 302) and a common signal generator (for example, such that a bias signal can be independently switchable and/or adjustable for each coaxial resonator 201, while maintaining a common excitation waveform across all coaxial resonators 201 in the system 300), different signal generators and a common DC power source (for example, such that a bias signal can be jointly switchable across all coaxial resonators 201 in the system 300, while maintaining an independent excitation waveform for each coaxial resonator 201), or different DC power sources and different signal generators (for example, such that the bias signal is independently switchable for each coaxial resonator 201, while maintaining an independent excitation waveform for each coaxial resonator 201).

FIG. 3B illustrates a circuit diagram of the system 300 of FIG. 3A, which includes the signal generator 202, the DC power source 302, and the coaxial resonator 201 (illustrated in vertical cross-section). As illustrated, similar to the QWCCR structure 100, the coaxial resonator 201 includes an outer conductor 322, an inner conductor 324 (including an electrode 326), and a dielectric 328. In addition, when the DC power source 302 is switched off, the circuit illustrated in FIG. 3B may not be an open-circuit. Instead, the signal generator 202 can simply be shorted to the inner conductor 324 when the DC power source 302 is switched off. As illustrated, the outer conductor 322 can be electrically coupled to ground. Further, the signal generator 202 and the DC power source 302 can be connected in series, with their negative terminals connected to ground. The positive terminals of the signal generator 202 and the DC power source 302 can be electrically coupled to the inner conductor 324. Consequently, the electrode 326 can also be electrically coupled to the positive terminals through an electrical coupling between the inner conductor 324 and the electrode 326.

In alternate implementations, the negative terminals of the signal generator 202 and the DC power source 302 can instead be connected to the inner conductor 324 and the positive terminals can be connected to the outer conductor 322. In this way, the signal generator 202 and the DC power source 302 can instead apply a negative voltage (relative to ground) to the electrode 326 and/or inner conductor 324, rather than a positive voltage (relative to ground). Further, in some implementations, the negative terminals of the DC power source 302 and the signal generator 202 and/or the inner conductor 324 might not be grounded.

As stated above, the DC power source 302 can be switchable. In this way a positive bias signal or a negative bias signal can be selectively applied to the inner conductor 324 and/or the electrode 326 relative to the outer conductor 322. When the DC power source 302 is switched on, a bias condition can be present, and when the DC power source 302 is switched off, a bias condition might not be present. A bias signal provided by the DC power source 302 can increase the electric potential, and thus the electric field, at the electrode 326 (for example, at a concentrator of the electrode 106, such as a tip, edge, or blade). By increasing the electric field at the electrode 326, dielectric breakdown and potentially plasma excitation can be more prevalent. Thus, by switching on the DC power source 302, the amount of plasma excited at a plasma corona can be enhanced.

In some implementations, the voltage of the DC power source 302 can range from +1 kV to +100 kV. Alternatively, the voltage of the DC power source 302 can range from −1 kV to −100 kV. Even further, the voltage of the DC power source 302 can be adjustable in some implementations. Furthermore, the voltage of the DC power source 302 can be pulsed, ramped, etc. For example, the voltage can be adjusted by a controller connected to the DC power source 302. In such implementations, the voltage of the DC power source 302 can be adjusted by the controller according to sensor data (for example, sensor data corresponding to temperature, pressure, fuel composition, etc.).

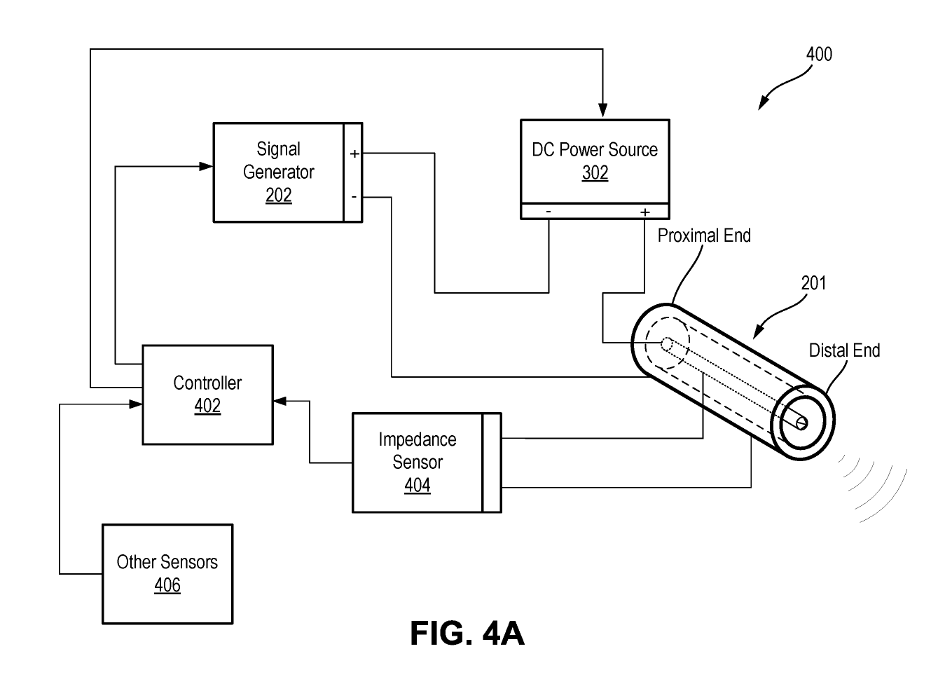

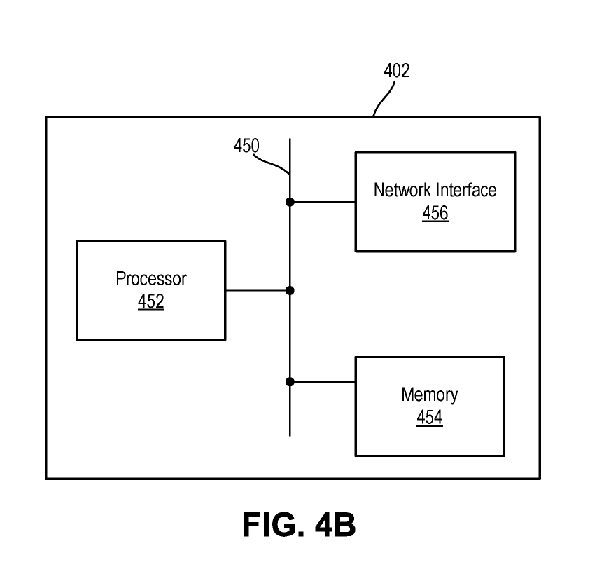

As illustrated in FIG. 4A, an example system 400 can include a controller 402. In various implementations, the controller 402 can include a variety of components. For example, the controller 402 can include a desktop computing device, a laptop computing device, a server computing device (for example, a cloud server), a mobile computing device, a microcontroller (for example, embedded within a control system of a power-generation turbine, an automobile, or an aircraft), and/or a microprocessor. As illustrated, the controller 402 can be communicatively coupled to the signal generator 202, the DC power source 302, an impedance sensor 404, and one or more other sensors 406. Through the communicative couplings, the controller 402 can receive signals/data from various components of the system 400 and control/provide data to various components of the system 400. For example, the controller 402 can switch the DC power source 302 in order to provide a time-modulated bias signal to the coaxial resonator 201 (for example, during an ignition sequence within a combustion chamber adjacent to, coupled to, or surrounding the coaxial resonator 201).

Further, a “communicative coupling,” as presently disclosed, is understood to cover a broad variety of connections between components, based on context. “Communicative couplings” can include direct and/or indirect couplings between components in various implementations. In some implementations, for example, a “communicative coupling” can include an electrical coupling between two (or more) components (for example, a physical connection between the two (or more) components that allows for electrical interaction, such as a direct wired connection used to read a sensor value from a sensor). Additionally or alternatively, a “communicative coupling” can include an electromagnetic coupling between two (or more) components (for example, a connection between the two (or more) components that allows for electromagnetic interaction, such as a wireless interaction based on optical coupling, inductive coupling, capacitive coupling, or coupling though evanescent electric and/or magnetic fields). In addition, a “communicative coupling” can include a connection (for example, over the public internet) in which one or more of the coupled components can transmit signals/data to and/or receive signals/data from one or more of the other coupled components. In various implementations, the “communicative coupling” can be unidirectional (in other words, one component sends signals and another component receives the signals) or bidirectional (in other words, both components send and receive signals). Other directionality combinations are also possible for communicative couplings involving more than two components. One example of a communicative coupling could be the controller 402 communicatively coupled to the coaxial resonator 201, where the controller 402 reads a voltage and/or current value from the resonator directly. Another example of a communicative coupling could be the controller 402 communicating with a remote server over the public Internet to access a look-up table. Additional communicative couplings are also contemplated in the present disclosure.

In some implementations, the controller 402 can control one or more settings of the signal generator 202 (for example, waveform shape, output frequency, output power amplitude, output current amplitude, or output voltage amplitude) or the DC power source 302 (for example, switching on or off or adjusting the level of the bias signal). For example, the controller 402 can control the bias signal of the DC power source 302 (for example, a voltage of the bias signal) based on a calculated voltage used to excite a plasma corona (for example, based on conditions within a combustion chamber). The calculated voltage can account for the voltage amplitude being output by the signal generator 202, in some implementations. The calculated voltage can ensure, for example, that the bias signal has a small effect on any standing electromagnetic wave formed within the coaxial resonator 201 based on an output of the signal generator 202.

The controller 402 can be located nearby the signal generator 202, the DC power source 302, the impedance sensor 404, and/or the one or more other sensors 406. For example, the controller 402 may be connected by a wire connection to the signal generator 202, the DC power source 302, the impedance sensor 404, and/or the one or more other sensors 406. Alternatively, the controller 402 can be remotely located relative to the signal generator 202, the DC power source 302, the impedance sensor 404, and/or the one or more other sensors 406. For example, the controller 402 can communicate with the signal generator 202, the DC power source 302, the impedance sensor 404, and/or the one or more other sensors 406 over BLUETOOTH®, over BLUETOOTH LOW ENERGY (BLE)®, over the public Internet, over WIFI® (IEEE 802.11 standards), over a wireless wide area network (WWAN), etc.

In some implementations, the controller 402 can be communicatively coupled to fewer components within the system 400 (for example, only communicatively coupled to the DC power source 302). Further, in implementations that include fewer components than illustrated in the system 400 (for example, in implementations, having only the coaxial resonator 201, the signal generator 202, and the controller 402), the controller 402 can interact with fewer components of the system 400. For instance, the controller can interact only with the signal generator 202.

The impedance sensor 404 can be connected to the coaxial resonator 201 (for example, one lead to the inner conductor 324 of the coaxial resonator 201 and one lead to the outer conductor 322 of the coaxial resonator 201) to measure an impedance of the coaxial resonator 201. In some implementations, the impedance sensor 404 can include an oscilloscope, a spectrum analyzer, and/or an AC volt meter. The impedance measured by the impedance sensor 404 can be transmitted to the controller 402 (for example, as a digital signal or an analog signal). In some implementations, the impedance sensor 404 can be integrated with the controller 402 or connected to the controller 402 through a printed circuit board (PCB) or other mechanism. The impedance data can be used by the controller 402 to perform calculations and to adjust control of the signal generator 202 and/or the DC power source 302.

Similarly, the other sensors 406 can also transmit data to the controller 402. Analogous to the impedance sensor 404, in some implementations, the other sensors 406 can be integrated with the controller 402 or connected to the controller 402 through a PCB or other mechanism. The other sensors 406 can include a variety of sensors, such as one or more of: a fuel gauge, a tachometer (for example, to measure revolutions per minute (RPM)), an altimeter, a barometer, a thermometer, a sensor that measures fuel composition, a gas chromatograph, a sensor measuring fuel-to-air ratio in a given fuel/air mixture, an anemometer, a torque sensor, a vibrometer, an accelerometer, or a load cell.

In some implementations, the controller 402 can be powered by the DC power source 302. In other implementations, the controller 402 can be independently powered by a separate DC power source or an AC power source (for example, rectified within the controller 402).

As an example, a possible implementation of the controller 402 is illustrated in FIG. 4B. As illustrated, the controller 402 can include a processor 452, a memory 454, and a network interface 456. The processor 452, the memory 454, and the network interface 456 can be communicatively coupled over a system bus 450. The system bus 450, in some implementations, can be defined within a PCB.

The processor 452 can include one or more central processing units (CPUs), such as one or more general purpose processors and/or one or more dedicated processors (for example, application-specific integrated circuits (ASICs), digital signal processors (DSPs), or network processors). The processor 452 can be configured to execute instructions (for example, instructions stored within the memory 454) to perform various actions. Rather than a processor 452, some implementations can include hardware logic (for example, one or more resistor-inductor-capacitor (RLC) circuits, flip-flops, latches, etc.) that performs actions (for example, based on the inputs from the impedance sensor 404 or the other sensors 406).

The memory 454 can store instructions that are executable by the processor 452 to carry out the various methods, processes, or operations presently disclosed. Alternatively, the method, processes, or operations can be defined by hardware, firmware, or any combination of hardware, firmware, or software. Further, the memory 454 can store data related to the signal generator 202 (for example, control signals), the DC power source 302 (for example, switching signals), the impedance sensor 404 (for example, look-up tables related to changes in impedance and/or a characteristic impedance of the coaxial resonator 201 based on certain environmental factors), and/or the other sensors 406 (for example, a look-up table of typical wind speeds based on elevation).

The memory 454 can include non-volatile memory. For example, the memory 454 can include a read-only memory (ROM), electrically erasable programmable read-only memory (EEPROM), a hard drive (for example, hard disk), and/or a solid-state drive (SSD). Additionally or alternatively, the memory 454 can include volatile memory. For example, the memory 454 can include a random-access memory (RAM), flash memory, dynamic random-access memory (DRAM), and/or static random-access memory (SRAM). In some implementations, the memory 454 can be partially or wholly integrated with the processor 452.

The network interface 456 can enable the controller 402 to communicate with the other components of the system 400 and/or with outside computing device(s). The network interface 456 can include one or more ports (for example, serial ports) and/or an independent network interface controller (for example, an Ethernet controller). In some implementations, the network interface 456 can be communicatively coupled to the impedance sensor 404 or one or more of the other sensors 406. Additionally or alternatively, the network interface 456 can be communicatively coupled to the signal generator 202, the DC power source 302, or an outside computing device (for example, a user device). Communicative couplings between the network interface 456 and other components can be wireless (for example, over WIFI®, BLUETOOTH®, BLUETOOTH LOW ENERGY (BLE)®, or a WWAN) or wireline (for example, over token ring, t-carrier connection, Ethernet, a trace in a PCB, or a wire connection).

In some implementations, the controller 402 can also include a user-input device (not shown). For example, the user-input device can include a keyboard, a mouse, a touch screen, etc. Further, in some implementations, the controller 402 can include a display or other user-feedback device (for example, one or more status lights, a speaker, a printer, etc.) (not shown). That status of the controller 402 can alternatively be provided to a user device through the network interface 456. For example, a user device such as a personal computer or a mobile computing device can communicate with the controller 402 through the network interface 456 to retrieve the values of one or more of the other sensors 406 (for example, to be displayed on a display of the user device).

### VI. Resonators with Fuel Injection

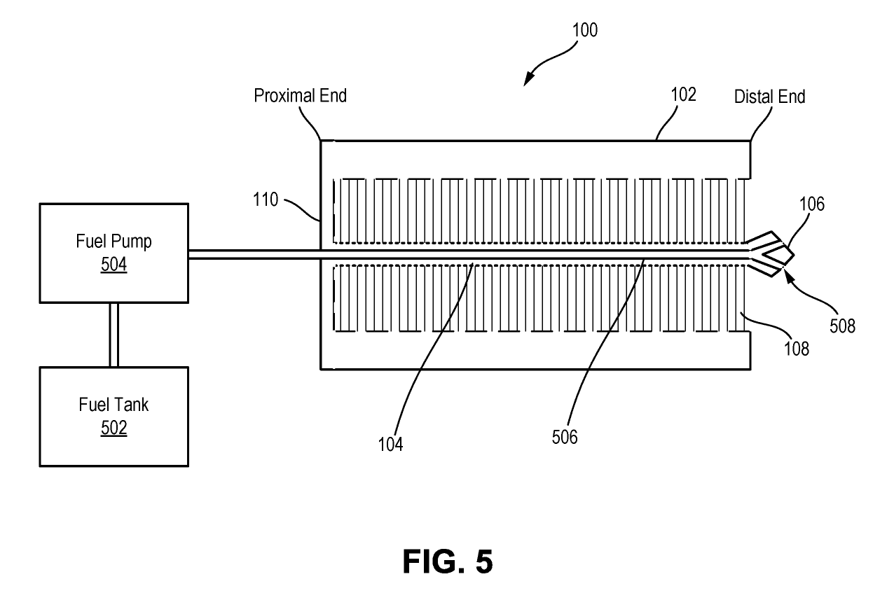

As illustrated in FIG. 5, in some implementations, the QWCCR structure 100 (or the coaxial resonator 201) can be attached to a fuel tank 502. The fuel tank 502 can provide a fuel source for a combustion chamber or other environment, for example. The fuel tank 502 can contain or be connected to a fuel pump 504 through a fuel-supply line (for example, a hose or a pipe). The fuel pump 504 can transfer fuel from the fuel tank 502 into the fuel-supply line and propel the fuel through a fuel conduit 506 defined by or disposed within the inner conductor 104 of the QWCCR structure 100. For example, the fuel pump 504 can include a mechanical pump (for example, gear pump, rotary vane pump, diaphragm pump, screw pump, peristaltic pump) or an electrical pump. In some implementations, the fuel tank 502 can include various sensors (for example, a pressure sensor, a temperature sensor, or a fuel-level sensor). Such sensors can be electrically connected to the controller 402 in order to provide data regarding the status of the fuel tank 502 to the controller 402, for example. Additionally or alternatively, the fuel pump 504 can be connected to the controller 402. Through such a connection, the controller 402 could control the fuel pump 504 (for example, to switch the fuel pump on and off, set a fuel injection rate, etc.).

In some implementations, the fuel conduit 506 can inject fuel (for example, into a combustion chamber) at one or more outlets 508 defined within the electrode 106 (for example, within a concentrator of the electrode 106). By conveying fuel through the fuel conduit 506 and out one or more outlets 508, fuel can be introduced proximate to a source of ignition energy (for example, proximate to a plasma corona generated near a concentrator of the electrode 106), which can allow for efficient combustion and ignition. In alternate implementations, one or more outlets can be defined with other locations of the fuel conduit 506 (for example, so as not to interfere with the electric field at the concentrator of the electrode 106).

In some implementations, the fuel conduit 506 can act, at least in part, as a Faraday cage (for example, by encapsulating the fuel within a conductor that makes up the fuel conduit 506) to prevent electromagnetic radiation in the QWCCR structure 100 from interacting with the fuel while the fuel is transiting the fuel conduit 506. In other structures, the fuel conduit 506 can allow electromagnetic radiation to interact with (for example, reform) the fuel within the fuel conduit 506.

In some implementations, the QWCCR structure 100 can include multiple fuel conduits 506 (for example, multiple fuel conduits running from the proximal end of the QWCCR structure 100 to the distal end of the QWCCR structure 100). Additionally or alternatively, one or more fuel conduits 506 can be positioned within the dielectric 108 or within the outer conductor 102. As described above, the outlet(s) 508 of the fuel conduit(s) 506 can be oriented in such as a way as to expel fuel toward concentrators (for example, tips, edges, or points) of one or more electrodes 106 (for example, toward regions where plasma coronas are likely to be excited).

### VII. Additional Resonator Implementations

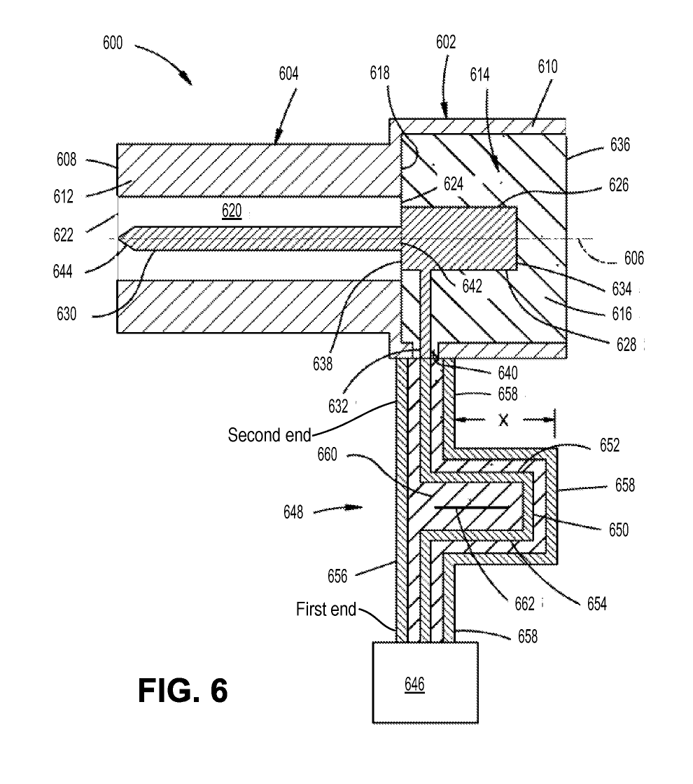

FIG. 6 illustrates a cross-sectional view of an example alternative coaxial resonator 600 connected to a DC power source through an additional resonator assembly acting as an RF attenuator, in accordance with example implementations. The coaxial resonator 600 is an assembly of two quarter-wave coaxial cavity resonators that are coupled together. More specifically, the coaxial resonator 600 includes a first resonator 602 and a second resonator 604 electrically coupled in a series arrangement along a longitudinal axis 606. In some implementations, the coaxial resonator 600 includes a DC bias condition established at a node of the voltage standing wave (for example, between quarter-wave segments). In such implementations, there may be no impedance mismatch. Because there is no impedance mismatch, the diameters of the inner conductor and the outer conductor of the first resonator 602 can be different than the diameters of the inner conductor and the outer conductor of the second resonator 604, respectively, without impacting the quality factor (Q). In such a way, the DC bias condition might not affect or interact with the AC signal coming from a signal generator.

The first resonator 602 and the second resonator 604 are defined by a common outer conductor wall structure 608. The outer conductor wall structure 608 includes a first cylindrical wall 610 and a second cylindrical wall 612 centered on the longitudinal axis 606. The first cylindrical wall 610 is constructed of a conducting material and surrounds a first cylindrical cavity 614 centered on the longitudinal axis 606. The first cylindrical cavity 614 is filled with a dielectric 616 having a relative dielectric constant approximately equal to four (εᵣ≈4), for example.

In the example implementation of FIG. 6, the first resonator 602 and the second resonator 604 adjoin one another in a connection plane 618 that is perpendicular to the longitudinal axis 606. In other examples, the connection plane 618 might not be perpendicular to the longitudinal axis 606, and can instead be designed with a different configuration that maintains constant impedance between the first resonator 602 and the second resonator 604.

The second cylindrical wall 612 is constructed of a conducting material and surrounds a second cylindrical cavity 620 that is also centered on the longitudinal axis 606. The second cylindrical cavity 620 is coaxial with the first cylindrical cavity 614, but can have a greater physical length. The second cylindrical wall 612 provides the second cylindrical cavity 620 with a distal end 622 spaced along the longitudinal axis 606 from a proximal end 624 of the second cylindrical cavity 620.

A center conductor structure 626 is supported within the conductor wall structure 608 of the coaxial resonator 600 by the dielectric 616. The center conductor structure 626 includes a first center conductor 628, a second center conductor 630, and a radial conductor 632.

The first center conductor 628 reaches within the first cylindrical cavity 614 along the longitudinal axis 606. In the example implementation shown in FIG. 6, the first center conductor 628 has a proximal end 634 adjacent a proximal end 636 of the first cylindrical cavity 614, and has a distal end 638 adjacent the distal end 624 of the first cylindrical cavity 614. The radial conductor 632 projects radially from a location adjacent the distal end 638 of the first center conductor 628, across the first cylindrical cavity 614, and outward through an aperture 640.

The second center conductor 630 has a proximal end 642 at the distal end 638 of the first center conductor 628. The second center conductor 630 projects along the longitudinal axis 606 to a distal end 644 configured as an electrode tip located at or in close proximity to the distal end 622 of the second cylindrical cavity 620.

To reduce any mismatch in impedances between the first resonator 602 and the second resonator 604, the relative radial thicknesses between both the cylindrical walls 610, 612 and the respective center conductors 628, 630 are defined in relation to the relative dielectric constant of the dielectric 616 and the dielectric constant of the air or gas that fills the second cylindrical cavity 620. In the example implementation of FIG. 6, the physical length of the second center conductor 630 along the longitudinal axis 606 is approximately twice the physical length of the first center conductor 628 along the longitudinal axis 606. However, based at least in part on the dielectric 616 having a relative dielectric constant approximately equal to four, the electrical lengths of the two center conductors 628 and 630 are approximately equal.

In example implementations, any gaps between any of the center conductors 628, 630 and any outer conductor could be filled with a dielectric and/or the gap (for example, the second cylindrical cavity 620) could be large enough to reduce arcing (in other words, large enough such that the electric field is not of sufficient intensity to result in a dielectric breakdown of air or the intervening dielectric). As further shown in FIG. 6, the dielectric 616 fills the first cylindrical cavity 614 around the first center conductor 628 and the radial conductor 632.

In the illustrated example, a DC power source 646 is connected to the center conductor structure 626 through the radial conductor 632 connected adjacent to a virtual short-circuit point of the DC power source 646.

An RF control component, specifically, an RF frequency cancellation resonator assembly 648 is disposed between the radial conductor 632 and the DC power source 646 to restrict RF power from reaching the DC power source 646. The RF frequency cancellation resonator assembly 648 is an additional resonator assembly having a center conductor 650. The center conductor 650 has a first portion 652 and a second portion 654, each of which has the same electrical length “X” illustrated in FIG. 6 (and the same electrical length as the first center conductor 628 and the second center conductor 630).

In an example implementation, the electrical length “X” depicted in FIG. 6 can be sized such that the center conductor 650 is an odd-integer multiple of half wavelengths (for example, ½λ₀, 3/2λ₀, 5/2λ₀, 7/2λ₀, 9/2λ₀, 11/2λ₀, 13/2λ₀, etc.) out of phase (in other words, 180° out of phase) with the outer conducting wall 656 and the outer conducting wall 658, simultaneously, where λ₀ is the resonant wavelength, and where the resonant wavelength λ₀ is inversely related to the frequency of the RF power. In alternative implementations, a similar “folded” structure to the electrical length “X” could be located within the cylindrical cavity 614 to achieve a similar phase shift between the inner conductor and the outer conductor.

The RF frequency cancellation resonator assembly 648 also has a short outer conducting wall 656 and a long outer conducting wall 658. The short outer conducting wall 656 has first and second ends on opposite ends of the RF frequency cancellation resonator assembly 648. The long outer conducting wall 658 also has first and second ends on opposite ends of the RF frequency cancellation resonator assembly 648. The first and second ends of the short outer conducting wall 656 are each on the opposite side of the RF frequency cancellation resonator assembly 648 from the corresponding first and second ends of the long outer conducting wall 658.

In an example implementation, the difference in electrical length between the short outer conducting wall 656 and the long outer conducting wall 658 is substantially equal to the combined electrical length of the first portion 652 and the second portion 654. In this example, the combined electrical length of the first portion 652 and the second portion 654 is substantially equal to twice the electrical length of the first center conductor 628.

In an example implementation, the short outer conducting wall 656 and the long outer conducting wall 658 surround a cavity 660 filled with a dielectric. In operation, with this example implementation, electric current running along the outer conductor of the RF frequency cancellation resonator assembly 648 primarily follows the shortest path and run along the short outer conducting wall 656. Accordingly, electric current on the outer conductor of the RF frequency cancellation resonator assembly 648 travels two fewer quarter-wavelengths than current running along the center conductor 650 of the RF frequency cancellation resonator assembly 648.

In examples, the RF frequency cancellation resonator assembly 648 can also have an internal conducting ground plane 662 disposed within the cavity 660 and between the first portion 652 and the second portion 654 of the center conductor 650. Based on the geometry of the cancellation resonator assembly 648, this configuration provides a frequency cancellation circuit connected between the DC power source 646 and the radial conductor 632.

Further, in examples, the RF frequency cancellation resonator assembly 648 is configured to shift a voltage supply of RF energy 180 degrees out of phase relative to the ground plane 662 of the coaxial resonator 600 due to the difference in electrical length between the short outer conducting wall 656 and the center conductor 650 of the RF frequency cancellation resonator assembly 648.

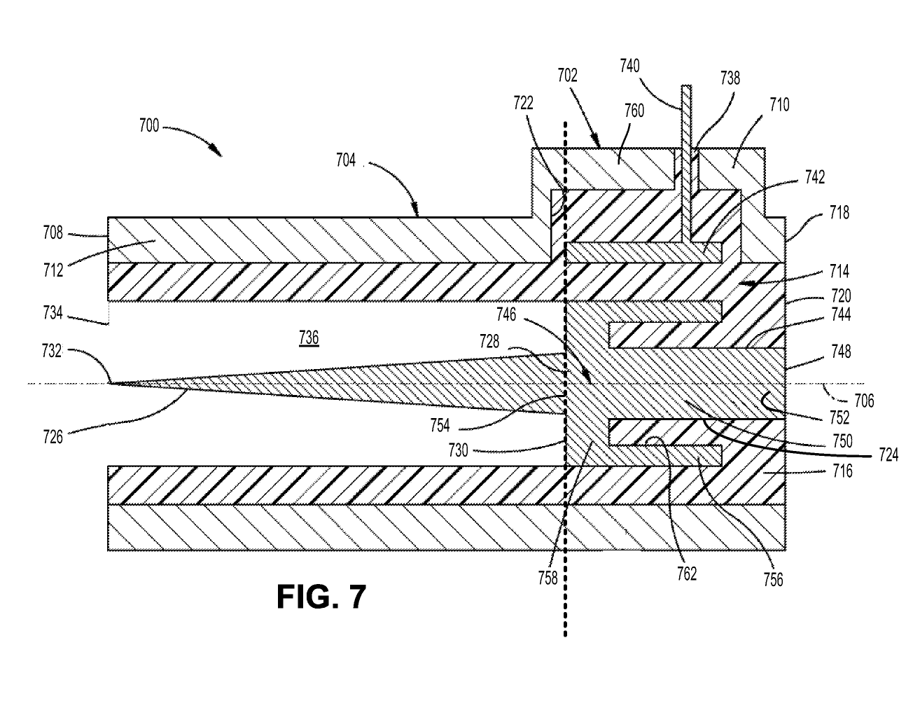

FIG. 7 illustrates a cross-sectional view of another example alternative coaxial resonator 700 connected to a DC power source through an additional resonator assembly acting as an RF attenuator, in accordance with an example implementation. The coaxial resonator 700 includes a first resonator portion 702 and a second resonator portion 704 electrically coupled in a series arrangement along a longitudinal axis 706.

As depicted in FIG. 7, the first resonator portion 702 and the second resonator portion 704 are defined by a common outer conductor wall structure 708. The wall structure 708 includes a first cylindrical wall portion 710 and a second cylindrical wall portion 712 centered on the longitudinal axis 706. The first cylindrical wall portion 710 is constructed of a conducting material and surrounds a first cylindrical cavity 714 centered on the longitudinal axis 706. In this example implementation, the first cylindrical cavity 714 is filled with a dielectric 716.

An annular edge 718 of the first cylindrical wall portion 710 defines a proximal end 720 of the first cylindrical cavity 714. A proximal end of the second cylindrical wall portion 712 adjoins a distal end 722 of the first cylindrical cavity 714.

The coaxial resonator 700 further includes a first center conductor portion 724 and a second center conductor portion 726 (the center conductor portions 724, 726 represented by the densest cross-hatching in FIG. 7). For illustration, the first center conductor portion 724 and the second center conductor portion 726 are separated by the vertical dashed line in FIG. 7. In some implementations, both the first center conductor portion 724 and the second center conductor portion 726 can correspond to an odd-integer multiple of quarter wavelengths based on the frequency of an RF power source used to excite the coaxial resonator 700. The second center conductor portion 726 has a proximal end 728 adjoining a distal end 730 of the first center conductor portion 724. The second center conductor portion 726 projects along the longitudinal axis 706 to a distal end configured as a concentrator 732 (for example, a tip) of an electrode located at or in close proximity to a distal end 734 of a second cylindrical cavity 736.

The coaxial resonator 700 has an aperture 738 that reaches radially outward through the first cylindrical wall portion 710. A radial conductor 740 extends out through the aperture 738 from the longitudinal axis 706 to be connected to an RF power source (for example, the signal generator 202) by an RF power input line. The end of the radial conductor 740 that is closer to the longitudinal axis 706 connects to a parallel plate capacitor 742 that is in a coupling arrangement to a center conductor structure 744. The parallel plate capacitor 742 is also in a coupling arrangement to an inline folded RF attenuator 746. The spacing between the parallel plate capacitor 742 and the center conductor structure 744 can depend on the materials used for fabrication (for example, the materials used to fabricate the parallel plate capacitor 742, the center conductor structure 744, and/or the dielectric 716).

In an example, the DC power source 646 described above is connected to the center conductor structure 744 at a proximal end 748 of the center conductor structure 744 with a DC power input line. The inline folded RF attenuator 746 is disposed between the second resonator portion 704 and the DC power source 646 to restrict RF power from reaching the DC power source 646.

The inline folded RF attenuator 746 includes an interior center conductor portion 750 having a proximal end 752 and a distal end 754. The inline folded RF attenuator 746 also includes an exterior center conductor portion 756 and a transition center conductor portion 758 that connects or couples the interior center conductor portion 750 and the exterior center conductor portion 756.

The exterior center conductor portion 756 has a proximal end largely in the same plane as the proximal end 752, and a distal end largely in the same plane as the distal end 754. For example, in the cross-sectional illustration of FIG. 7, the plane of the proximal end 752 and the plane of the proximal end of the exterior center conductor portion 756 can be the plane of the cross-section that is illustrated. In this example implementation, the transition center conductor portion 758 is located proximal to the distal end 754. The exterior center conductor portion 756 surrounds the interior center conductor portion 750.

In this example, the exterior center conductor portion 756 resembles a cylindrical portion of conducting material surrounding the rest of the interior center conductor portion 750. The longitudinal lengths of the interior center conductor portion 750 and the exterior center conductor portion 756 are substantially equal to the longitudinal length of the parallel plate capacitor 742 with which they are in a coupling arrangement. The electrical length between the proximal end 752 to the distal end 754, for both the interior center conductor portion 750 and the exterior center conductor portion 756, is substantially equal to one quarter-wavelength. The second center conductor portion 726 and the second cylindrical wall portion 712 are both configured to have an electrical length of one quarter-wavelength.

The wall structure 708 includes a short outer conducting portion 760 which has a proximal end largely in the same plane as the proximal end 752, and a distal end largely in the same plane as the distal end 754. An outer conducting path runs from the distal end of the wall structure 708 (that is substantially coplanar with the distal end 734 of the second cylindrical cavity 736), along the short outer conducting portion 760, and stops at the proximal end 720 of the first cylindrical wall portion 710. In this example, the outer conducting path has an electrical length of two quarter-wavelengths.

An inner conducting path runs from the concentrator 732 to the proximal end 728 of the second center conductor portion 726, along the outside of the transition center conductor portion 758, then along the outside from the distal end to the proximal end of the exterior center conductor portion 756, then along an interior wall 762 of the exterior center conductor portion 756 from its proximal end to its distal end, then along the interior center conductor portion 750 from its distal end to its proximal end. In this example, the electrical length of this inner conducting path is four quarter-wavelengths, or two half wavelengths. The difference in electrical lengths between the inner conducting path and the outer conducting path is one half wavelength.

With this configuration, the inline folded RF attenuator 746 operates as a radio-frequency control component connected between the DC power source 646 and the voltage supply of RF energy. The inline folded RF attenuator 746 is configured to shift a voltage supply of RF energy 180 degrees out of phase relative to the ground plane of the coaxial resonator 700.

The particular arrangement depicted in FIG. 7 is not limiting with respect to the orientation of the inline folded RF attenuator 746. In other examples, the entire arrangement depicted in FIG. 7 can be “stretched,” with the inline folded RF attenuator 746 being disposed further away from the concentrator 732 and not directly coupled to the parallel plate capacitor 742. For example, the inline folded RF attenuator 746 could be separated by one quarter-wavelength from the portion of the center conductor that would remain in direct coupling arrangement with the parallel plate capacitor 742. The coaxial resonator 700 can achieve a maximize efficiency when (i) the inline folded RF attenuator 746 is an odd-integer multiple of quarter wavelengths from the concentrator 732; and (ii) the inline folded RF attenuator 746 is an odd-integer multiple of quarter wavelengths in electrical length.

In another example, the arrangement depicted in FIG. 7 could be more compressed, with the exterior center conductor portions 756 of the inline folded RF attenuator 746 extending longitudinally as far as the parallel plate capacitor 742 and also surrounding the portion of center conductor exposed for plasma creation. This can be implemented by arranging the center conductor structure 744 in the middle so that the exterior center conductor portions 756 extends in either direction longitudinally. Any particular geometry of this arrangement can involve adjusting the various parameters of dielectrics to ensure impedance matching and full 180 degree phase cancellation.

In one example, the arrangements described with respect to FIGS. 6 and 7 and the particular combination of components that provide the RF signal to the coaxial resonators are contained in a body dimensioned approximately the size of a gap spark igniter and adapted to mate with a combustor (for example, of an internal combustion engine). As an example for illustration, a microwave amplifier could be disposed at the resonator, and the resonator could be used as the frequency determining element in an oscillator amplifier arrangement. The amplifier/oscillator could be attached at the top or back of an igniter, and could have the high voltage supply also integrated in the module with diagnostics. This example permits the use of a single, low-voltage DC power supply for feeding the module along with a timing signal.

### VIII. Power-Generation Turbines

The above coaxial resonators could be usefully employed in the context of a power-generation turbine. For example, a coaxial cavity resonator similar to the coaxial resonator 201 illustrated in FIG. 2 could be used in a gas turbine. While reference is made to “QWCCR,” “QWCCR structure,” and “coaxial resonator” elsewhere in the description, it will be understood that other types of resonators are possible and contemplated.

An example power-generation turbine includes a compressor coupled to a turbine through a shaft, and the power-generation turbine also includes a combustion chamber or area, called a combustor. It is understood that, as presently described, the terms “power-generation turbine,” “power-generation gas turbine,” and “gas turbine” are used synonymously and/or interchangeably. In operation, atmospheric air flows through a compressor that brings the air to higher pressure. Energy is then added by spraying fuel into the air and igniting it so the combustion generates a high-temperature, high-pressure gas flow. The high-temperature, high-pressure gas enters a turbine, where it expands down to an exhaust pressure, producing a shaft work output at the shaft coupled to the turbine in the process.

The shaft work output is used to drive the compressor and other devices (for example, an electric generator) that can be coupled to the shaft. The energy that is not used for shaft work comes out in the exhaust gases that can include a high temperature and/or a high velocity. Gas turbines can be utilized to power aircraft, trains, ships, electrical generators, pumps, gas compressors, and tanks, among other machines.

An example gas turbine includes an upstream rotating compressor coupled to a downstream turbine, and a combustion chamber or area, called a combustor, in between the compressor and the turbine. In operation, atmospheric air flows through a compressor that brings the air to higher pressure. Energy is then added by spraying fuel into the air and igniting it so the combustion generates a high-temperature high pressure gas flow. The high-temperature high-pressure gas enters a turbine, where it expands down to the exhaust pressure, producing a shaft work output in the process. In a power-generation turbine, the shaft work is used to drive the compressor and an electric generator that can be coupled to the shaft.

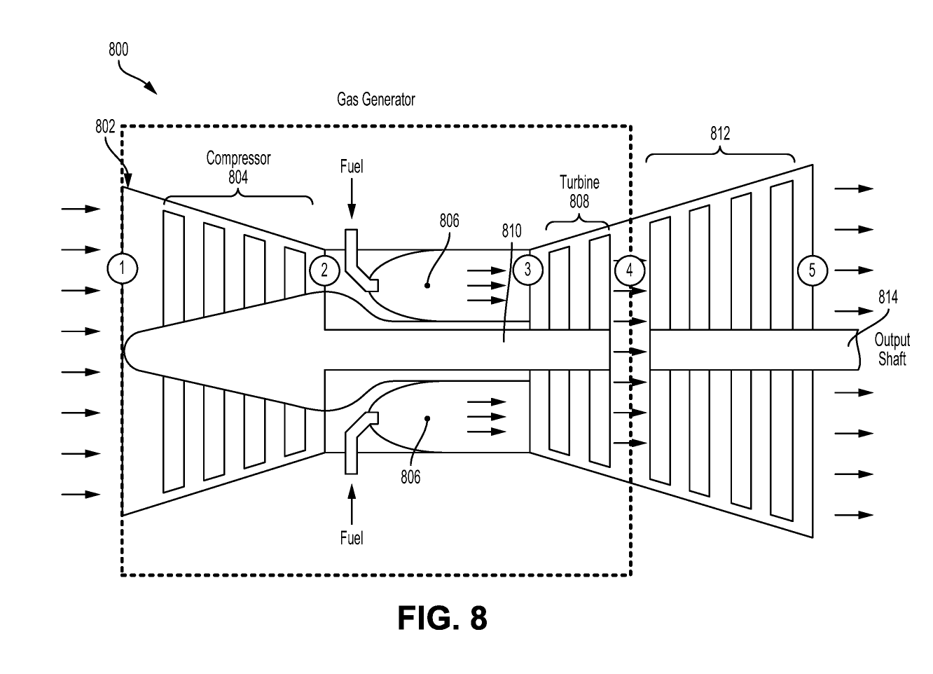

FIG. 8 illustrates core components of an example power-generation turbine 800. In this arrangement, large amounts of surrounding air (free stream) are continuously brought into an inlet or intake 802. At the rear of the intake 802, the air then enters a compressor 804 (axial, centrifugal, or both). The compressor 804 operates as many rows of airfoils, with each row producing an increase in pressure. At the exit of the compressor 804, the air is therefore at a much higher pressure than when it enters the intake 802.

Fuel is mixed with the compressed air exiting the compressor 804, and the fuel-compressed air mixture is burned in a combustor 806, generating a flow of hot, high pressure gas. The hot, high pressure air exiting the combustor 806 is then passed through a first turbine 808. The first turbine 808 extracts energy from a flow of gas by making blades of the first turbine 808 spin in the flow. The first turbine 808 can include several stages, and the energy extracted by the first turbine 808 is used to turn the compressor 804 by linking or coupling the compressor 804 and the first turbine 808 by a central shaft 810.

The above-mentioned components of the power-generation turbine 800 can be referred to collectively as the gas generator. The power-generation turbine 800 further includes a power section having a second turbine 812 and an output shaft 814. The output shaft 814 can be coupled to an electric generator. Particularly, the output shaft 814 can be connected to a rod or shaft of the electric generator that turns one or more magnets surrounded by coils of copper wire. The fast-revolving generator magnet creates a powerful magnetic field that lines up the electrons around the copper coils and causes them to move, providing an electrical current, and thereby generating electricity.

In examples, the gas generator and power section of the power-generation turbine 800 are mechanically-separate so they can each rotate at different speeds appropriate for the conditions. In other examples, the power-generation turbine 800 might not include two turbines 808, 812 but can have a single turbine driving both the compressor 804 and the output shaft 814. Further, although FIG. 8 illustrates the output shaft 814 exiting an end of the power-generation turbine 800 that is opposite the intake 802, in some examples, the output shaft 814 is disposed and rotatable within the central shaft 810 and exits the power-generation turbine 800 from the intake 802.

One way to boost efficiency of the power-generation turbine 800 is to install a recuperator or to use a heat-recovery steam generator (HRSG) to recover energy from the exhaust of the second turbine 812. If a recuperator is installed, the recuperator captures waste heat in the gases exiting the turbines 808, 812 to preheat the compressed air discharged by the compressor 804 before the compressed air enters the combustor 806. If a HRSG is used, the HRSG generates steam by capturing heat from the gases exiting the turbines 808, 812. High-pressure steam generated by the HSRG can be used to generate additional electric power with steam turbines in a “combined cycle” configuration.

The combustor 806, which can also be referred to as a burner, a combustion chamber, or a flame holder, comprises the area of the power-generation turbine 800 where combustion takes place. The combustor 806 of the power-generation turbine 800 is configured to contain and maintain stable combustion despite high air flow rates. As such, in examples, the combustor 806 is configured to mix the air and fuel, ignite the air-fuel mixture, and then mix in more air to complete the combustion process.

Combustors of power-generation turbines can be classified into several types. For example, a first type of combustor can be referred to as an annular combustor in which the combustor is configured as a continuous chamber that encircles the air in a plane perpendicular to the air flow. A second type of combustor can be referred to as can-annular, which is similar to the annular type but incorporates several can-shaped combustion chambers rather than a single continuous chamber. The can-shaped combustion chambers can be disposed in a radial array about a longitudinal axis of the power-generation turbine. The can-shaped combustion chambers could be disposed perpendicular to the longitudinal axis, parallel to the longitudinal axis, or at a particular angle relative to the longitudinal axis. A third type of combustor can be referred to as a can or silo combustor that can include one or more self-contained combustion chambers mounted externally to the power-generation turbine.

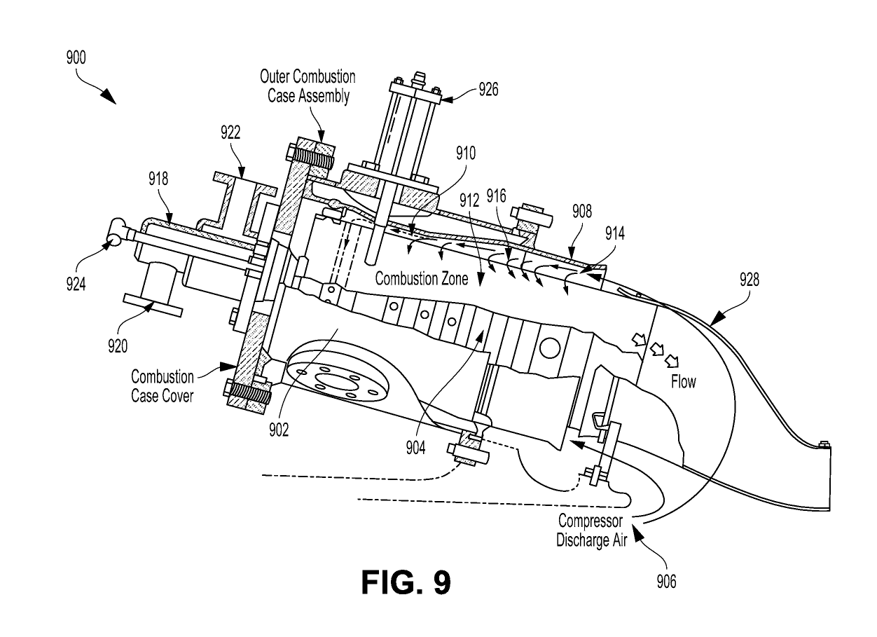

FIG. 9 illustrates a partial cross-sectional view of a combustor 900 of a power-generation turbine. In an example implementation, the combustor 900 could represent the combustor 806 of the power-generation turbine 800 described above.

The combustor 900 includes a case 902 that is configured as an outer shell of the combustor 900. The case 902 can be protected from thermal loads by the air flowing in it, and can operate as a pressure vessel configured to withstand the difference between the high pressures inside the combustor 900 and the lower pressure outside.

The combustor 900 further includes a liner 904 that could be slot-cooled and configured to contain the combustion process. The liner 904 is configured to withstand extended high temperature cycles, and therefore can be made from superalloys. Furthermore, the liner 904 is cooled with air flow. In some example implementations, in addition to air cooling, the combustor 900 can include thermal barrier coatings to further cool the liner 904.

FIG. 9 further illustrates air flow paths through the combustor 900. Compressed discharge air exiting the compressor 804 can flow through a compressor discharge air opening 906 disposed in the combustor 900. The air entering through the compressor discharge air opening 906 flows through a flow sleeve 908 and is the source of combustion air 910, which is highly compressed air. The combustion air 910 can be decelerated using a diffuser and is fed through main channels of the combustor 900. This air is mixed with fuel, and then combusted in a combustion zone 912.

A portion of the compressed discharge air, referred to as dilution air 914, is injected through dilution air holes in the liner 904 at the end of the combustion zone 912 to help cool the air before it reaches the first turbine 808. The dilution air 914 can be used to produce the uniform temperature profile desired in the combustor 900.

Further, a portion of the compressed discharge air, referred to as cooling air 916, is injected through cooling air holes in the liner 904 to generate a layer (film) of cool air to protect the liner 904 from the high combustion temperatures. The combustor 900 can be configured such that the cooling air 916 does not directly interact with the combustion air 910 and the combustion process.

The combustor 900 further includes a fuel injector 918 configured to introduce fuel to the combustion zone 912 for mixing the fuel with the combustion air 910. The fuel injector 918 can be configured as any of several types of fuel injectors, including without limitation: pressure-atomizing, air blast, vaporizing, and premix/prevaporizing injectors.

Pressure-atomizing fuel injectors utilize high fuel pressures (as much as 500 pounds per square inch (psi)) to atomize the fuel. When using this type of fuel injector, the fuel system is configured to be sufficiently robust to withstand such high pressures. The fuel tends to be heterogeneously atomized, resulting in incomplete or uneven combustion, which generates pollutants and smoke.

The air blast fuel injector can include a port 920 configured to receive atomizing air. The air blast injector “blasts” fuel with a stream of air received through the port 920, atomizing the fuel into homogeneous droplets, and can cause the combustor 900 to be smokeless. The air blast fuel injector can operate at lower fuel pressures than the pressure atomizing fuel injector.

The vaporizing fuel injector is similar to the air blast injector in that the combustion air 910 is mixed with the fuel as it is injected into the combustion zone 912. However, with the vaporizing fuel injector, the fuel-air mixture travels through a tube within the combustion zone 912. Heat from the combustion zone 912 is transferred to the fuel-air mixture, vaporizing some of the fuel to enhance the mixing before the mixture is combusted. This way, the fuel is combusted with low thermal radiation, which helps protect the liner 904. However, the vaporizer tube can have low durability because of the low fuel flow rate within it causing the tube to be less protected from the combustion heat.

The premixing/prevaporizing injector is configured to mix or vaporize the fuel before it reaches the combustion zone 912. In such a scenario, the fuel is uniformly mixed with the air, and emissions from the power-generation turbine 800 can be reduced. However, in some cases, fuel can auto-ignite or otherwise combust before the fuel-air mixture reaches the combustion zone 912, and the combustor 900 can thus be damaged. In some example implementations, a resonator could be configured with fuel passages disposed within the resonator, such that the resonator integrates operations of the fuel injector 918 with operations of an igniter described below. In these examples, the resonator could be configured to perform the atomization and vaporization of the fuel in addition to mixing and preparing the fuel for combustion. The fuel would then be passed through a formed plasma to ensure ignition. Further, the presence of the electromagnetic waves radiated by the resonator could be used to energize the air-fuel mixture and stimulate combustion.

In examples, the power-generation turbine 800 could be a dual-fuel turbine. A dual-fuel turbine can run primarily with one type of gas (for example, natural gas) as fuel but can also have a back-up fuel supply system if the gaseous fuel is not available. For instance, the dual-fuel turbine can be configured to also receive liquid fuel and water through a pipe system.

In an example, to accommodate different types of fuel, the fuel injector 918 could be configured as a dual-fuel nozzle assembly configured to receive two types of fuel. For instance, the fuel injector 918 can have a gas-fuel port 922 configured to be fluidly coupled to a source of gaseous fuel, and can also have a liquid-fuel port 924 configured to be fluidly coupled to a source of liquid fuel.

Example fuels that could be provided to the power-generation turbine 800 include, without limitation: Arabian Extra Light Crude Oil (AXL), Arabian Super Light (ASL), Biodiesel Condensate or Natural Gas Liquids (NGL), Dimethyl Ether (DME), Distillate Oil #2 (DO2), Ethane (C₂), Heavy Crude Oil, Heavy Fuel Oil (HFO), High H₂, Hydrogen Blends, Kerosene (Jet A or Jet A-1), Lean Methane, Light Crude Oil (LCO), Liquid Natural Gas (LNG), Liquefied Propane Gas (LPG), Medium Crude Oil, Methanol/Ethanol (Alcohol), Naphtha, Natural Gas (NG), Sour Gas (H₂S), Steel Mill Gases, and Syngas.

Each of these fuels can have a particular air-to-fuel mixture ratio (or desirable mixture ratio range) at which the fuel is burnt. Under some conditions, if the air-fuel mixture has an air-to-fuel ratio that is less than the particular air-to-fuel ratio, combustion might not occur. Further, each fuel can have different combustion characteristics. The resonators disclosed in the present disclosure may enable gas turbines to operate on a wide variety of gaseous and liquid fuels while burning fuels efficiently and without changes to the gas turbines.

The combustor 900 also includes an igniter 926. In examples, the igniter 926 can be configured as an electrical spark igniter, similar to an automotive spark plug. However, there are several disadvantages to such configuration. For instance, a spark plug might not be capable of igniting different types of fuel with different air-to-fuel ratios and combustion characteristics. Further, even if the spark plug is capable of igniting some mixtures, achieving high efficiencies for different types of fuel and air-to-fuel ratios can be difficult.

The igniter 926 can be disposed proximate to the combustion zone 912 where the fuel and air are already mixed. To avoid damage by the combustion itself, the igniter 926 can be located proximate to the combustion zone 912, but upstream from the combustion location. In example implementations, once combustion is initially started by the igniter 926, the combustion can be self-sustaining and the igniter 926 need no longer be used. However, in some examples, it can be desirable to have the igniter 926 configured to facilitate detection of changes in operational characteristics of the gas turbine or the combustion process that could lead to extinguishing combustion, and proactively prevent such extinguishment.

The combustor 900 can further include a transition assembly 928 that couples the combustor 900 to the first turbine 808 such that hot air resulting from the combustion zone 912 flows through the transition assembly 928 to the first turbine 808.

The combustor 900 illustrated in FIG. 9 represents one implementation, and other possible variations are possible. For example, rather than having a fuel injector including two ports for two different types of fuel, the combustor can include different, independent fuel injectors, each fuel injector configured to provide a respective type of fuel to the combustion zone 912. In other examples, the combustor 900 can have a port configured to receive water or steam injection to provide control of NOₓ gases in the combustion zone 912.

Additionally, in examples, the combustor 900 can have several combustion stages, including, for example, a pilot stage. The power-generation turbine 800 can be configured to provide fuel to each stage in the combustor 900 through a respective tube. Other example variations are possible.

The combustion taking place at the combustor 900 may affect many of the operating characteristics of the power-generation turbine 800. As examples, combustion may determine fuel efficiency, output power level, and levels of emissions of the power-generation turbine 800. It can thus be desirable to have an ignition system that prepares the fuel for efficient and thorough combustion regardless of the type of fuel, reduces emissions, and that facilitates starting and sustaining ignition regardless of air-to-fuel ratio and the type of fuel.

### IX. Example of Fuel Injection Through a Conductor of a Resonator

As discussed above, in a power-generation gas turbine, it may be desirable to expose fuel (or a fuel mixtures) to electromagnetic waves before ignition in order to reform the fuel and/or alter an energy state of the fuel. Doing so can help conserve energy during ignition and/or provide other advantages.

One manner of accomplishing this can be configuring a resonator to operate as a fuel injection source—particularly, by having fuel (or fuel mixture) flow through a conductor of the resonator, thereby exposing the fuel to electromagnetic waves as the fuel passes through the dielectric. Configuring a resonator in this manner can provide additional benefits as well, such as enabling use of the resonator both as an ignition source and as an alternative to a separate fuel injector device. Further, while fuel injection through the conductor may be desired to achieve leaner fuel/air mixtures, the configurations and methods for fuel injection described in the present disclosure can be applied in scenarios in which a richer fuel/air mixture is desired. In any event, the resonator may also excite a plasma corona to ignite the fuel/air mixture.

To facilitate fuel injection through a conductor of the resonator, the resonator can include a fuel conduit through which to inject fuel into a combustion chamber of the power-generation gas turbine. In some implementations, at least a portion of the fuel conduit can be disposed within the conductor. For example, the fuel conduit can include one or more channels through which the fuel can flow, and at least one of the one or more channels can be arranged within the conductor.

In line with the discussion above, each fuel conduit channel can have a particular shape, such as a linear shape, rifled shape, curved shape, etc. In some implementations, the conductor can be machined so as to define a channel within the conductor. Additionally or alternatively, at least a portion of the fuel conduit can include a tube, such as flexible tubing, and that tubing can be disposed within the conductor. For instance, a fuel conduit in the form of a polyamide plastic tubing can be disposed within the conductor.

Furthermore, the fuel conduit can include one or more fuel outlets configured to expel the fuel. The location and orientation of a given fuel outlet can be selected based on the direction where the fuel is desired. For example, a fuel outlet can be oriented in such as a way as to expel fuel toward a concentrator of the resonator's electrode. That way, when the resonator is exciting a plasma corona at the concentrator, the plasma corona can ignite the fuel that is being expelled from the fuel outlet towards the plasma corona.

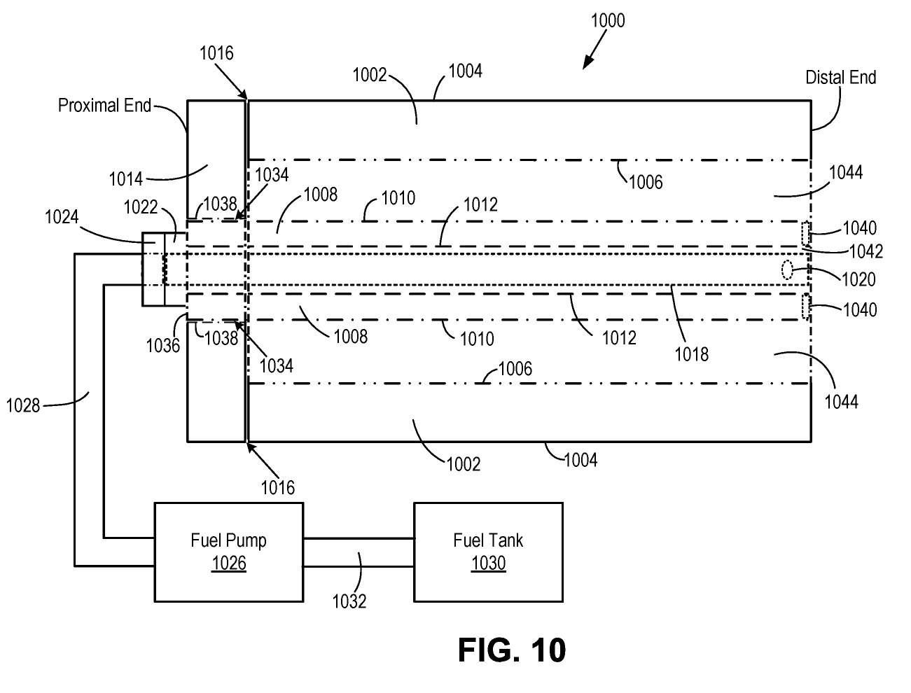

FIG. 10 illustrates a resonator 1000 including a fuel conduit 1018. FIG. 10 includes labels “distal end” and “proximal end” to distinguish different ends of the resonator 1000. The resonator 1000 is one of the many possible variations of a resonator that can be used in the power-generation gas turbine 800. This variation shows a resonator with a base 1014 at the proximal end of the resonator 1000. FIG. 10 also shows a fuel tank 1030, a fuel pump 1026, a fuel supply line 1032 that fluidly couples the fuel tank 1030 and the fuel pump 1026, and a fuel supply line 1028 that fluidly couples the fuel pump 1026 and the fuel conduit 1018. In an example implementation, the fuel pump 1026 can be disposed within the fuel tank 1030.

Components, such as a fuel supply line and/or a fuel conduit, that are fluidly coupled are components connected together such that a fluid, such as a fuel, can flow from one component to the other component. In some implementations, two components can be fluidly coupled such that the fluid can flow from a first component to a second component and from the second component to the first component. In other implementations, two components can be fluidly coupled such that the fluid can flow from the first component to the second component, but not from the second component to the first component. Those other implementations can, for example, include a one-way check valve that prevents the fluid within the second component to flow into the first component.

As shown in FIG. 10, the resonator 1000 includes an outer conductor 1002 having both an exterior surface 1004 and an interior surface 1006. The resonator 1000 also includes an inner conductor 1008 having both an exterior surface 1010 and an interior surface 1012. The interior surface 1006 and the exterior surface 1010 define a cavity 1044 that extends from a proximal end of the outer conductor 1002 to a distal end of the outer conductor 1002. The resonator 1000 can include a dielectric within the cavity 1044. Similar to the dielectric 108 shown in FIG. 1C, the dielectric can include air and/or one or more dielectric materials. The interior surface 1012 defines a cavity 1042 that can extend from a proximal end of the inner conductor 1008 to a distal end of the inner conductor 1008. In an example implementation, the interior surface 1012 defines at least a portion of the fuel conduit 1018. In that implementation, fuel flowing through the fuel conduit 1018 flows through the cavity 1042 and can contact the interior surface 1012. In another example implementation, the fuel conduit 1018 includes a structure distinct from the inner conductor 1008. In that implementation, at least a portion of the fuel conduit 1018 is disposed within the cavity 1042 and can contact the interior surface 1012.

The base 1014 can include a hole 1036 in which a portion of the inner conductor 1008 can be disposed. A wall 1038 of the base 1014 and that portion of the inner conductor 1008 can form a joint 1034. In an implementation, the joint 1034 can include one or more fasteners, an adhesive material, and/or a friction force. The friction force can result from pressing the inner conductor 1008 into the hole 1036 or by turning a threaded portion of the inner conductor 1008 into a threaded portion of the wall 1038. In an implementation, at least a portion of the hole 1036 is a through-hole so that a portion of the fuel conduit 1018 and/or a portion of fuel supply line 1028 can pass through or be disposed within the base 1014.

The base 1014 and the outer conductor 1002 can form a joint 1016. In an implementation, the joint 1016 can include one or more fasteners, an adhesive material, and/or a friction force. The friction force can result from pressing one of the base 1014 and the outer conductor 1002 into the other. In yet another implementation, one of the base 1014 and the conductor 1002 can include an entry hole and a slot and the other can include a flange that can be disposed in the entry hole and slid within the slot to securely join the base 1014 and the conductor 1002. In an example implementation, the joint 1016 can extend from the exterior surface 1004 to the interior surface 1006.

In an example implementation, the base 1014 can be made of an insulated material such that the base 1014 does not electrically short the outer conductor 1002 to the inner conductor 1008. In another example implementation, the base 1014 can be made of a conductive material that electrically shorts the outer conductor 1002 to the inner conductor 1008. In that implementation, the base 1014 can operate as a base conductor, similar to the implementations in which the base conductor 110 electrically shorts together the outer conductor 102 and the inner conductor 104 (all shown in FIG. 5).

In yet another example implementation, the base 1014 can be made of a conductive material and the joint 1016 and/or the joint 1034 can be insulated joints such that the base 1014 does not electrically short the outer conductor 1002 to the inner conductor 1008. In such implementation, the insulated joints can include one or more insulated fasteners, such as electrical standoff insulators, a dielectric material, or some other insulated material.

As mentioned above, at least a portion of the fuel conduit 1018 can include a structure distinct from the inner conductor 1008. In such an implementation, the fuel conduit 1018 can include a tube that is at least partly disposed with the inner conductor 1008. The portion of the tube within the inner conductor 1008 can be maintained in place by friction and/or an adhesive, for example. In an implementation, the tube of the fuel conduit 1018 can extend from the proximal end of the resonator 1000 to the distal end of the resonator 1000. In that or a different implementation, the tube of the fuel conduit 1018 can extend beyond the proximal end of the resonator 1000 and/or the distal end of the resonator 1000.

The tube of the fuel conduit 1018 can have an opening proximate to the proximal end of the resonator 1000 so that fuel from the fuel supply line 1028 can enter the tube. The tube of the fuel conduit 1018 can also include one or more fuel outlets. As an example, an end of the tube proximate the distal end of the resonator 1000 can have an opening configured as a fuel outlet. As another example, the tube of the fuel conduit 1018 can include one or more fuel outlets, such as a fuel outlet 1020 between a distal end and a proximal end of the tube.

The fuel conduit 1018 can be made of a material such that fuel contained within the fuel conduit can be treated by electromagnetic waves provided by the resonator 1000 when the resonator 1000 is excited by a signal from a radio-frequency power source. For the implementations in which at least a portion of the fuel conduit 1018 includes a tube, the tube can include a glass tube, a sapphire tube, a quartz tube, a rubber tube, a reinforced rubber tube, an aliphatic polyamide tube, or a metallic tube, for example.

In some implementations, the fuel conduit 1018 can act, at least in part, as a Faraday cage (for example, by encapsulating the fuel within a conductor that makes up the fuel conduit 1018) to prevent electromagnetic radiation in the resonator 1000 from interacting with the fuel while the fuel is transiting the fuel conduit 1018. In other implementations, the fuel conduit 1018 can allow electromagnetic radiation to interact with (for example, reform) the fuel within the fuel conduit 1018. Accordingly, a resonator with a fuel conduit can be configured to provide at least some of the electromagnetic waves provided by the resonator within the fuel conduit.

The resonator 1000 can include a connector 1022 to connect the fuel conduit 1018 to the fuel supply line 1028. Likewise, the fuel supply line 1028 can include a connector 1024 that is connectable to the connector 1022. FIG. 10 shows the connector 1022 outside of the base 1014. In another implementation, at least a portion of the connector 1022 can be disposed within the base 1014.

In some implementations, the fuel conduit 1018 can include the connector 1022, and the fuel supply line 1028 can include the connector 1024. As an example of those implementations, the fuel conduit 1018 and the fuel supply line 1028 can each comprise a steel tube, and the connector 1022 can include a flared portion of the steel tube of the fuel conduit 1018 and a threaded fastener, and the connector 1024 can include a flared portion of the other steel tube and a threaded fastener. The flared portion of a steel tube can include a double flare, a bubble flare, or an inverted flare, for example. The threaded fittings of two steel tubes can mate together to provide a leak-proof connection.

In some implementations, the connector 1022 can be separate from fuel conduit 1018. In those implementations, the connector 1022 can include a clamp (such as a hose clamp), for example. In some implementations, the connector 1022 can include a friction connection made by pressing one of the fuel conduit 1018 or the fuel supply line 1028 into the other, or by screwing a threaded portion of one of the fuel conduit 1018 or the fuel supply line 1028 into the other. One or both of the connectors 1022, 1024 can include a gasket, such as a rubber o-ring, to prevent fuel leakage at the connectors 1022, 1024.

Similar to other resonators discussed above, the resonator 1000 can connect to a radio-frequency power source that is configured to provide a signal to excite the resonator 1000. The resonator 1000 can further connect to a direct-current power source that is configured to provide a bias signal between the outer conductor 1002 and the inner conductor 1008. Furthermore, in some implementations, a distal end of the inner conductor 1008 can include an electrode 1040 having a concentrator. The resonator 1000 can provide a plasma corona at the concentrator of the electrode 1040 when the resonator 1000 is excited by a signal from the radio-frequency power source. The plasma corona can be provided within a combustion chamber of a power-generation gas turbine, such as within the combustion zone 912 shown in FIG. 9. Furthermore, one or more of the fuel outlet(s) can output the fuel proximate to the plasma corona (or another source of ignition energy), which can allow for efficient ignition and combustion.

In some implementations, the resonator 1000 can include multiple fuel conduits 1018 (for example, multiple fuel conduits running from the proximal end of the resonator 1000 to the distal end of the resonator 1000). One of the multiple fuel conduits can be disposed within the outer conductor 1002.

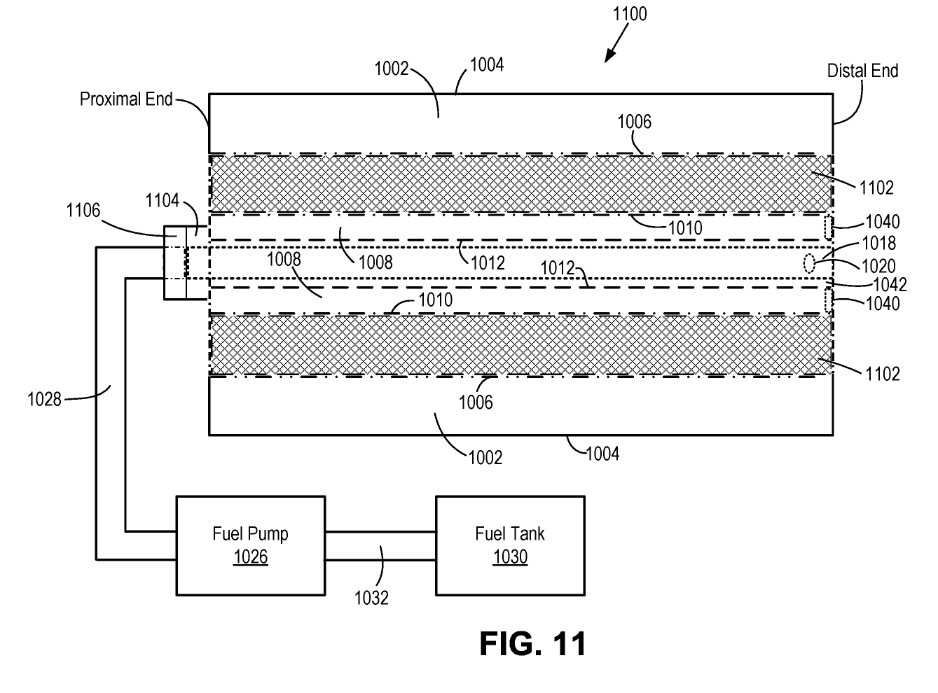

FIG. 11 illustrates a resonator 1100. The resonator 1100 is one of the many possible variations of a resonator that includes a fuel conduit and can be used in the power-generation gas turbine 800. This variation does not include the base 1014 shown in FIG. 10. FIG. 11 includes labels “distal end” and “proximal end” to distinguish different ends of the resonator 1100.

Similar to the resonator 1000 shown in FIG. 10, the resonator 1100 includes (i) the outer conductor 1002 having the exterior surface 1004, the interior surface 1006, and the cavity 1044, (ii) the inner conductor 1008 having the exterior surface 1010, the interior surface 1012, the electrode 1040, and the cavity 1042, and (iii) the fuel conduit 1018 including the fuel outlet 1020, all of which are discussed above. Like the fuel conduit 1018 for the resonator 1000, the fuel conduit 1018 for the resonator 1100 can include a different configuration of fuel outlet(s). FIG. 11 also shows the fuel tank 1030, the fuel pump 1026, the fuel supply line 1032, and the fuel supply line 1028, all of which are discussed above.

The interior surface 1012 can define the cavity 1042. The cavity 1042 and/or the interior surfaced 1012 can define at least a portion of the fuel conduit 1018. Alternatively, the interior surface 1012 can define a cavity in which at least a portion of the fuel conduit 1018 with a structure distinct from the inner conductor 1008 is disposed. Examples of that distinct structure of the fuel conduit 1018 and examples of the materials used to make the fuel conduit 1018 are discussed above.

The interior surface 1006 can define a cavity that extends from a proximal end of the outer conductor 1002 to a distal end of the outer conductor 1002. The resonator includes a dielectric 1102. The dielectric 1102 can include a dielectric material disposed between the internal surface of the outer conductor 1002 and the exterior surface 1010. Similar to the dielectric 108 shown in FIG. 1C, the dielectric 1102 can include air and/or one or more dielectric materials.

The resonator 1100 can include a connector 1104 to fluidly connect the fuel conduit 1018 to the fuel supply line 1028. Likewise, the fuel supply line 1028 can include a connector 1106 that is connectable to the connector 1104. FIG. 11 shows the connector 1104 outside of the cavity defined by the interior surface 1006. In another implementation, at least a portion of the connector 1122 can be disposed within the cavity defined by the interior surface 1006.

In some implementations, at least a portion of the connector 1104 can be a portion of the fuel conduit 1018, and at least a portion of the connector 1106 can be a portion of the fuel supply line 1028. As an example of those implementations, the fuel conduit 1018 and the fuel supply line 1028 can each comprise a steel tube, and the portion of the connector 1104 can be a flared portion of the steel tube of the fuel conduit 1018, and the portion of the connector 1106 can be a flared portion of the other steel tube.

In some implementations, the connector 1104 can be separate from fuel conduit 1018. In those implementations, the connector 1104 can include a clamp (such as a hose clamp), for example. In some implementations, the connector 1104 can include a friction connection made by pressing one of the fuel conduit 1018 or the fuel supply line 1028 into the other, or by screwing a threaded portion of one of the fuel conduit 1018 or the fuel supply line 1028 into the other. One or both of the connectors 1104, 1106 can include a gasket, such as a rubber o-ring, to prevent fuel leakage at the connectors 1104, 1106.

In some implementations, the resonator 1100 can include multiple fuel conduits 1018 (for example, multiple fuel conduits running from the proximal end of the resonator 1100 to the distal end of the resonator 1100). One of the multiple fuel conduits can be positioned within the dielectric 1102. Additionally or alternatively, one of the multiple fuel conduits can be positioned within the outer conductor 1002.

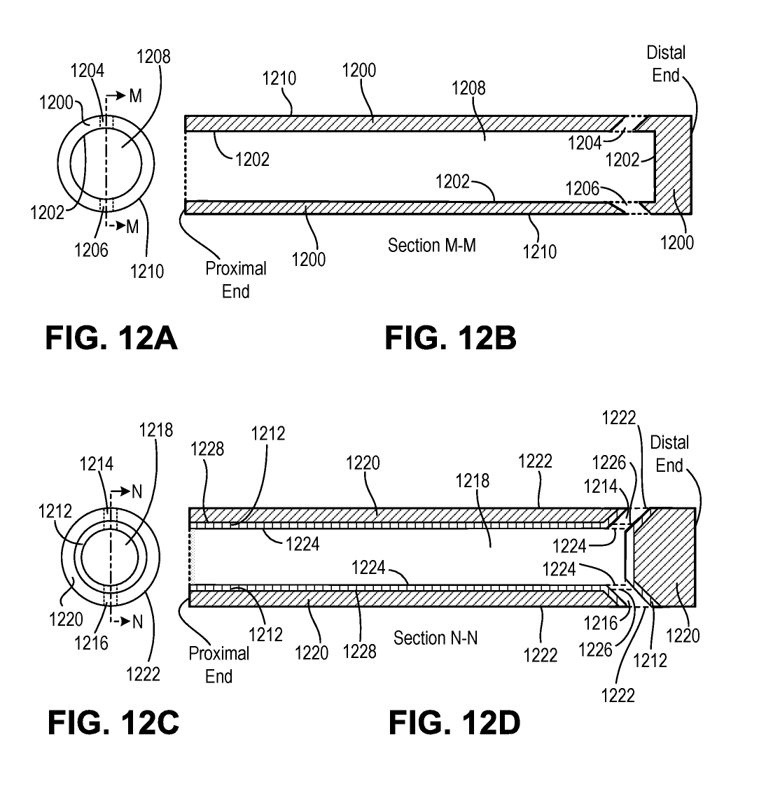

FIG. 12A is an elevation view of a conductor 1200 that can be used as an inner conductor of a resonator including a fuel conduit. The conductor 1200 is a variation of the inner conductor 1008 shown in FIG. 10 and FIG. 11. In this variation, multiple fuel outlets are shown. FIG. 12B is a cross-sectional view of the conductor 1200 shown in FIG. 12A, and includes labels “distal end” and “proximal end” to distinguish different ends of the conductor 1200. The proximal end of the conductor 1200 is shown in FIG. 12A.

The conductor 1200 includes an interior surface 1202, an exterior surface 1210, and a fuel conduit 1208. The interior surface 1202 defines the fuel conduit 1208. A fuel outlet 1204 extends from the interior surface 1202 to the exterior surface 1210. Likewise, a fuel outlet 1206 extends from the interior surface 1202 to the exterior surface 1210. As shown in FIG. 12B, the fuel outlets 1204, 1206 can pass through the conductor 1200 obliquely. In an alternative implementation, one or more fuel outlets can pass through the conductor 1200 squarely.

The fuel pump 1026, shown in FIG. 10 and FIG. 11, can pump fuel into the fuel conduit 1208 at the proximal end of the conductor 1200. That fuel can flow through the fuel conduit 1208 and out the fuel outlets 1204, 1206. In an example implementation, the fuel outlets 1204, 1206 can output the fuel into the cavity 1044 shown in FIG. 10. In another example implementation, the fuel outlets 1204, 1206 can output the fuel into the dielectric 1102 shown in FIG. 11. For that implementation, if the dielectric 1102 includes a dielectric material, the dielectric material can include one or more fuel conduits for further transportation of the fuel.

FIG. 12C is an elevation view of a conductor 1220 that can be used as an inner conductor of a resonator including a fuel conduit. The conductor 1220 is another variation of the inner conductor 1008 shown in FIG. 10 and FIG. 11. This variation shows (i) a fuel conduit structure 1212 distinct from the conductor 1220, and (ii) a fuel conduit 1218. This variation also shows multiple fuel outlets. FIG. 12D is a cross-sectional view of the conductor 1220 shown in FIG. 12C, and includes labels “distal end” and “proximal end” to distinguish different ends of the conductor 1220. The proximal end of the conductor 1220 is shown in FIG. 12C.

The conductor 1220 includes an exterior surface 1222, and the fuel conduit structure 1212 includes an interior surface 1224 that defines the fuel conduit 1218. A portion of the interior surface of the conductor 1220 and a portion of an exterior surface 1226 of the fuel conduit structure 1212 can form a joint 1228. In an implementation, the joint 1228 can include an adhesive material and/or a friction force. The friction force can result from pressing the fuel conduit structure 1212 into a cavity defined by the interior surface of the conductor 1220.

A fuel outlet 1214 extends from the interior surface 1224 to the exterior surface 1226 and/or to the exterior surface 1222. Likewise, a fuel outlet 1216 extends from the interior surface 1224 to the exterior surface 1226 and/or to the exterior surface 1222. As shown in FIG. 12D, the fuel outlets 1214, 1216 can pass through the conductor 1220 obliquely. In an alternative implementation, one or more fuel outlets can pass through the conductor 1220 squarely.

The fuel pump 1026 shown in FIG. 10 and FIG. 11 can pump fuel into the fuel conduit 1218 at the proximal end of the conductor 1220. That fuel can flow through the fuel conduit 1218 and out the fuel outlets 1214, 1216. In an example implementation, the fuel outlets 1214, 1216 can output the fuel into the cavity 1044 shown in FIG. 10. In another example implementation, the fuel outlets 1214, 1216 can output the fuel into the dielectric 1102 shown in FIG. 11. For that implementation, if the dielectric 1102 includes a dielectric material, the dielectric material can include one or more fuel conduits for further transportation of the fuel.

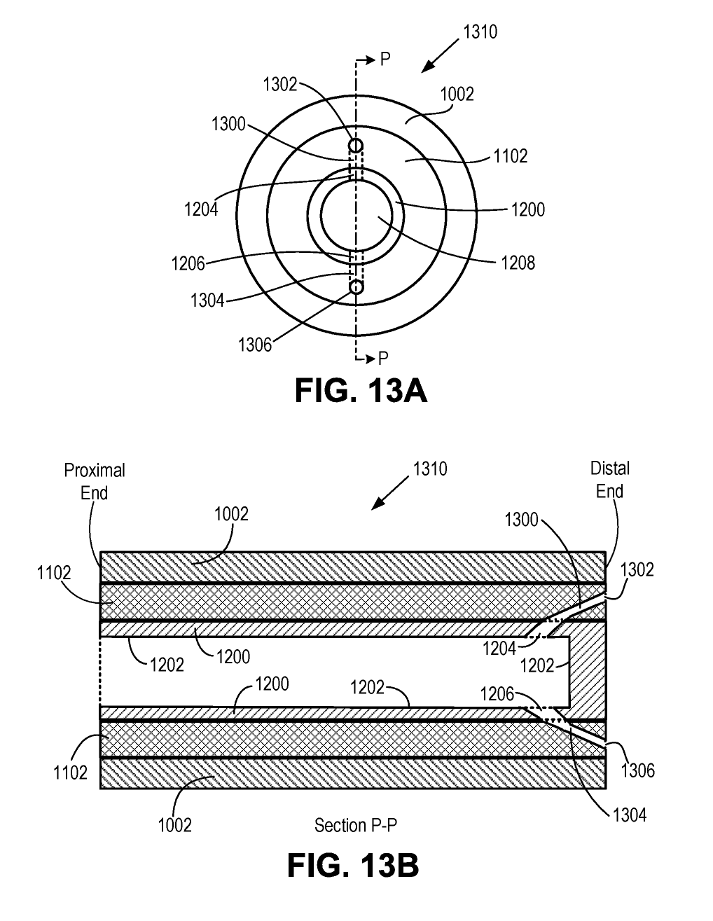

FIG. 13A illustrates an elevation view of a resonator 1310. The resonator 1310 is one of the many possible variations of a resonator (like the resonator 1100 shown in FIG. 11) including a dielectric and the conductor 1200 shown in FIG. 12A and FIG. 12B. This variation shows the conductor 1200 as an inner conductor disposed within the outer conductor 1002 and the dielectric 1102 disposed between the conductor 1200 and the outer conductor 1002. FIG. 13B is a cross-sectional view of the resonator 1310 shown in FIG. 13A, and includes labels “distal end” and “proximal end” to distinguish different ends of the resonator 1310. The distal end of the resonator 1310 is shown in FIG. 13A.

The fuel outlet 1204 is fluidly coupled to a fuel channel 1300 within the dielectric 1102. The fuel channel 1300 includes a fuel outlet 1302. Likewise, the fuel outlet 1206 is fluidly coupled to a fuel channel 1304 within the dielectric 1102, and the fuel channel 1304 includes a fuel outlet 1306. The fuel channels 1300, 1304 can transport fuel from the fuel outlets 1204, 1206 through the dielectric 1102 to the fuel outlets 1302, 1306, respectively. The fuel outlets 1302, 1306 can output the fuel into a combustion area, such as a combustion zone of a power-generation gas turbine, and/or in proximity to an ignition source, such as a plasma corona the resonator 1310 can generate when excited by a signal from a radio-frequency power source.

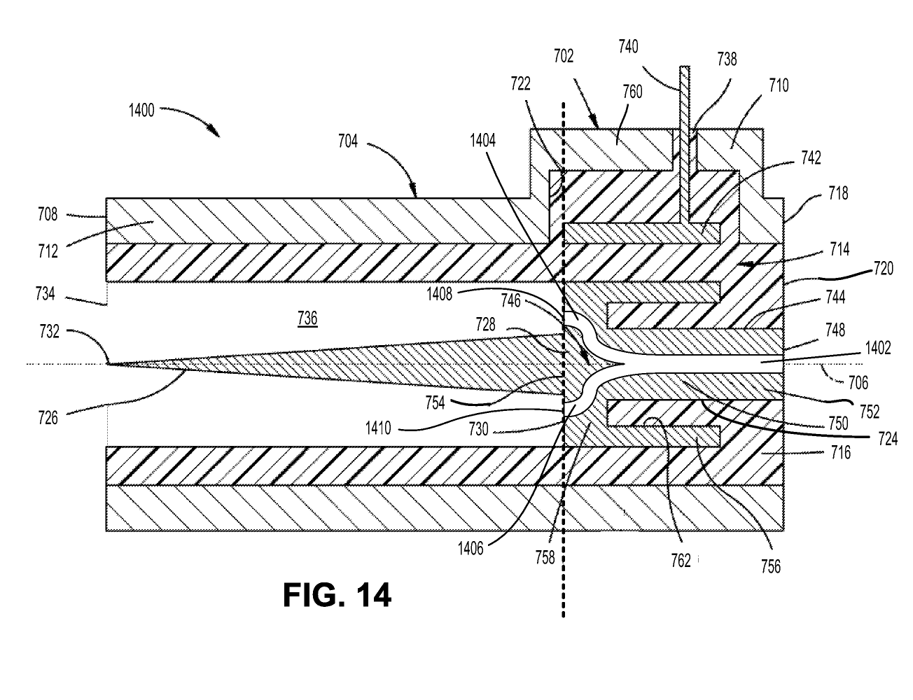

FIG. 14 illustrates a cross-sectional view of a resonator 1400. The resonator 1400 is one of the many possible variations of a resonator that include a fuel conduit and that can be used in the power-generation gas turbine 800. The resonator 1400 includes the components of the coaxial resonator 700 shown in FIG. 7 and a fuel conduit 1402 in the interior center conductor portion 750 and the transition zone 758. The description of the other components shown in FIG. 7 pertains to the components having the same reference number shown in FIG. 14.

The fuel conduit 1402 can extend from the proximal end 748 to the second cylindrical cavity 736. In an example implementation, the fuel conduit 2702 can include multiple branches, such as fuel conduit branches 1404, 1406. The fuel conduit 1402 can include a fuel outlet within the transition zone 758 for outputting fuel into the second cylindrical cavity 736. As illustrated in FIG. 14, the fuel conduit branch 1404 includes a fuel outlet 1408, and the fuel conduit branch 1406 includes a fuel outlet 1410.

The resonator 1400 can include a connector (not shown) to connect the fuel conduit 1402 to a fuel supply line. In an implementation, the connector of the resonator 1400 can be configured like the connector 1022 shown in FIG. 10 or the connector 1104 shown in FIG. 11.

Fuel received at fuel conduit 1402 at the proximal end of the 748 can flow towards the fuel conduit branches 1404, 1406. Some of the fuel within the fuel conduit 1402 can be provided to each of the fuel conduit branches 1404, 1406 for delivery through the fuel outlets 1408, 1410 respectively. The fuel output through the fuel outlets 1408, 1410 can be exposed to electromagnetic waves provided by the resonator 1400 in response to being excited by a signal from a radio-frequency power source.

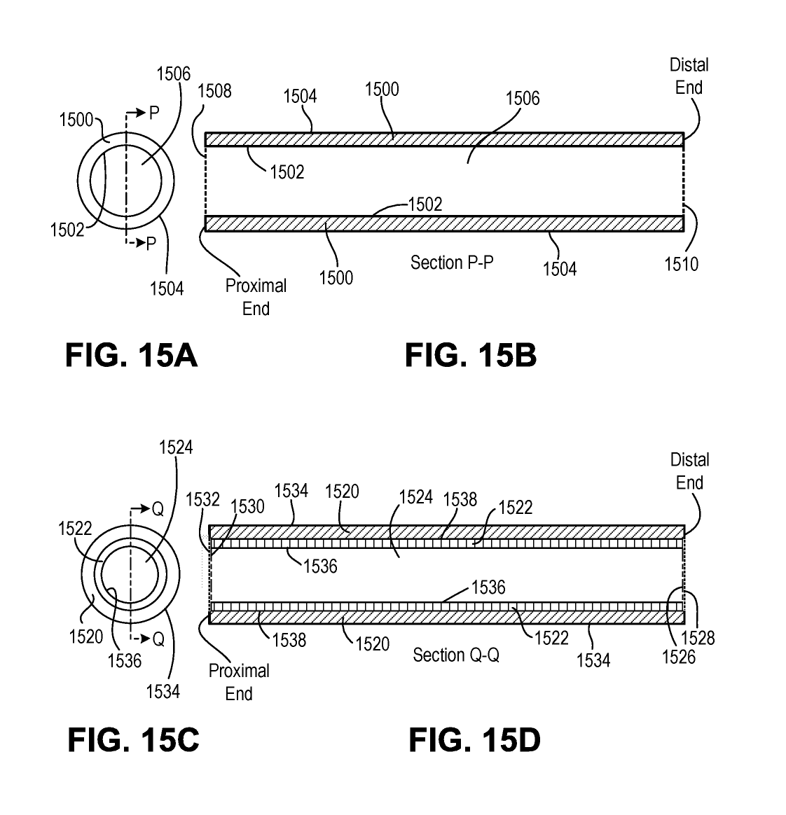

FIG. 15A is an elevation view of a conductor 1500 that can be used as an inner conductor of a resonator including a fuel conduit. The conductor 1500 is a variation of the inner conductor 1008 shown in FIG. 10 and FIG. 11. In this variation, a fuel outlet 1510 is at a distal end of the conductor 1500. FIG. 15B is a cross-sectional view of the conductor 1500 shown in FIG. 15A, and includes labels “distal end” and “proximal end” to distinguish different ends of the conductor 1500. The proximal end of the conductor 1500 is shown in FIG. 15A.

The conductor 1500 includes an interior surface 1502, an exterior surface 1504, and a fuel conduit 1506. The interior surface 1502 defines the fuel conduit 1506. The conductor 1500 also includes a proximal end opening 1508. A fuel supply line, such as the fuel supply line 1028 shown in FIG. 10, can fluidly couple to the conductor 1500 proximate the proximal end opening 1508.

The fuel pump 1026, shown in FIG. 10 and FIG. 11, can pump fuel into the fuel conduit 1506 at the proximal end of the conductor 1500. That fuel can flow through the fuel conduit 1506, and then out the fuel outlet 1510 into a combustion zone of a power-generation gas turbine.

FIG. 15C is an elevation view of a conductor 1520 that can be used as an inner conductor of a resonator including a fuel conduit. The conductor 1520 is another variation of the inner conductor 1008 shown in FIG. 10 and FIG. 11. This variation shows (i) a fuel conduit structure 1522 distinct from the conductor 1520, and (ii) a fuel conduit 1524 having a fuel outlet 1526 at a distal end of the fuel conduit structure 1522. The conductor 1520 includes a proximal end opening 1532 and a distal end opening 1528. The fuel conduit structure 1522 includes a proximal end opening 1530. FIG. 15D is a cross-sectional view of the conductor 1520 shown in FIG. 15C, and includes labels “distal end” and “proximal end” to distinguish different ends of the conductor 1520. The proximal end of the conductor 1520 is shown in FIG. 15C.

The conductor 1520 includes an exterior surface 1534, and the fuel conduit structure 1522 includes an interior surface 1536 that defines the fuel conduit 1524. At least a portion of the interior surface of the conductor 1520 and at least a portion of an exterior surface of the fuel conduit structure 1522 can form a joint 1538. In an implementation, the joint 1538 can include an adhesive material and/or a friction force. The friction force can result from pressing the fuel conduit structure 1522 into a cavity defined by the interior surface of the conductor 1520.

A fuel supply line, such as the fuel supply line 1028 shown in FIG. 10, can fluidly couple to the conductor 1520 and/or the fuel conduit structure 1522 proximate the proximal end opening 1532 and/or the proximal end opening 1530. The fuel pump 1026 shown in FIG. 10 and FIG. 11 can pump fuel into the fuel conduit 1524 at the proximal end of the conductor 1520. That fuel can flow through the fuel conduit 1524 and out the fuel outlet 1526. In an example implementation, the distal end of the conduit structure 1522 can be flush within a distal end opening 1528. In that implementation, the fuel outlet 1526 can output fuel into a combustion zone of a power-generation gas turbine. In another implementation, the distal end of the conduit structure 1522 can end prior to the distal end of the conductor 1520. In that implementation, the fuel outlet 1526 can output fuel into the conductor 1520 for delivery of the fuel through a portion of the conductor 1520, out the distal end opening 1528, and into a combustion zone of a power-generation gas turbine.

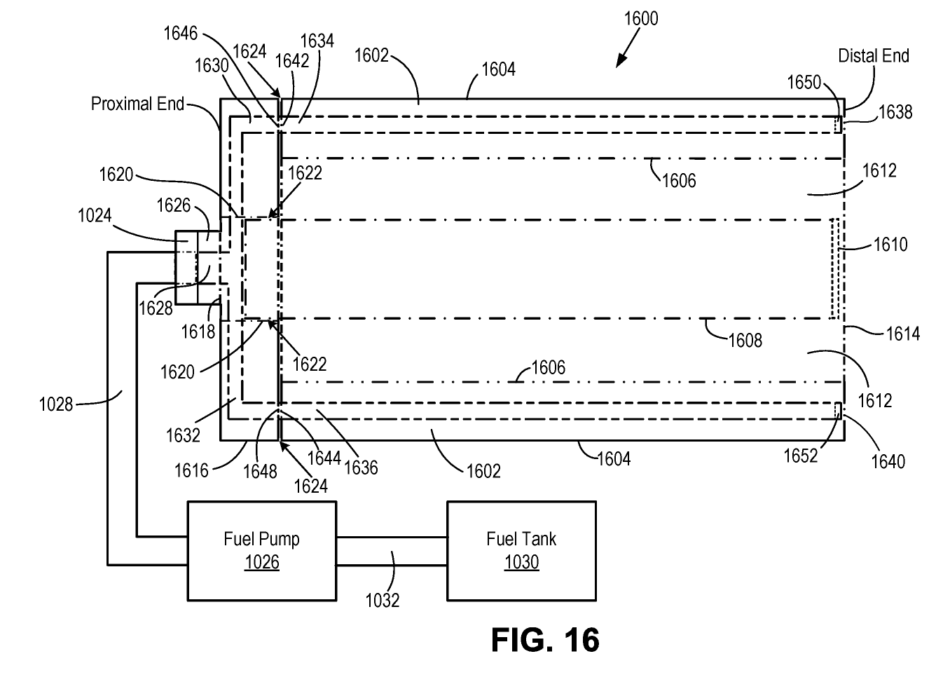

FIG. 16 illustrates a resonator 1600 and includes labels “distal end” and “proximal end” to distinguish different ends of the resonator 1600. The resonator 1600 is one of the many possible variations of a resonator that can be used a power-generation gas turbine. This variation shows a resonator with an outer conductor 1602, a base 1616 at the proximal end of the resonator 1600, and fuel conduits 1634, 1636 in the outer conductor 1602. FIG. 16 also shows the fuel tank 1030, the fuel pump 1026, and the fuel supply lines 1028, 1032, all of which are discussed above.

As shown in FIG. 16, the outer conductor 1602 has an exterior surface 1604, an interior surface 1606, distal end openings 1638, 1640, and proximal end openings 1642, 1644. The interior surface 1606 can define a cavity 1612 that extends from a proximal end of the outer conductor 1602 to a distal end of the outer conductor 1602. The resonator 1600 also includes an inner conductor 1608 having an electrode 1610 proximate to the distal end of the resonator 1600. The inner conductor 1608 can be disposed in the cavity 1612. The resonator 1600 can also include a dielectric within the cavity 2012 and between the outer conductor 2002 and the inner conductor 2008. Similar to the dielectric 108 shown in FIG. 1C, the dielectric can include air and/or one or more dielectric materials.

The base 1616 can include (i) a hole 1618 in which a portion of the inner conductor 1608 can be disposed, (ii) a fuel conduit 1628 that is fluidly connectable to the fuel supply line 1028, (iii) fuel conduit branches 1630, 1632, and (iv) holes 1646, 1648. A wall 1620 of the base 1616 and that portion of the inner conductor 1608 can form a joint 1622. In an implementation, the joint 1622 can include one or more fasteners, an adhesive material, and/or a friction force. The friction force can result from pressing the inner conductor 1608 into the hole 1618 or by turning a threaded portion of the inner conductor 1608 into a threaded portion of the wall 1620. In an implementation, at least a portion of the hole 1618 is a through-hole so that a portion of the fuel conduit 1628 and/or a portion of fuel supply line 1028 can pass through or be disposed within the base 1616.

The base 1616 and the outer conductor 1602 can form a joint 1624. In an implementation, the joint 1624 can include one or more fasteners, an adhesive material, and/or a friction force. The friction force can result from pressing one of the base 1616 and the outer conductor 1602 into the other. In yet another implementation, one of the base 1616 and the conductor 1602 can include an entry hole and a slot and the other can include a flange that can be disposed in the entry hole and slid within the slot to securely join the base 1616 and the conductor 1602. In an example implementation, the joint 1624 can extend from the exterior surface 1604 to the interior surface 1606.

The joint 1624 can include a seal, such as an o-ring, in one or both of the fuel conduit branch 1630 and the fuel conduit 1634. Likewise, the joint 1624 can include a seal in one or both of the fuel conduit branch 1632 and the fuel conduit 1636. Those seals can provide a leak-proof coupling between the fuel conduit branches 1630, 1632 and the fuel conduits 1634, 1636.

In an example implementation, the base 1616 can be made of an insulated material such that the base 1616 does not electrically short the outer conductor 1602 to the inner conductor 1608. In another example implementation, the base 1616 can be made of a conductive material that electrically shorts the outer conductor 1602 to the inner conductor 1608. In that implementation, the base 1616 can operate as a base conductor, similar to the implementations in which the base conductor 110 electrically shorts together the outer conductor 102 and the inner conductor 104 (all shown in FIG. 5).

In yet another example implementation, the base 1616 can be made of a conductive material and the joints 1622 and/or the joint 1624 can be insulated joints such that the base 1616 does not electrically short the outer conductor 1602 to the inner conductor 1608. In such implementation, the insulated joints can include one or more insulated fasteners, such as electrical standoff insulators, a dielectric material, or some other insulated material.

In some implementations, the fuel conduits 1634, 1636 can be cavities within the outer conductor 1602, between the exterior surface 1604 and the interior surface 1606, such that internal surfaces of the outer conductor 1602, between the exterior surface 1604 and the interior surface 1606, define the fuel conduits. In other implementations, the fuel conduits 1634, 1636 can further include a fuel conduit structure within the cavities within the outer conductor 1602 between the exterior surface 1604 and the interior surface 1606. That structure can be made of a material as described with respect to the fuel conduit 1018.

In some implementations, the fuel conduits 1634, 1636 can act, at least in part, as a Faraday cage (for example, by encapsulating the fuel within a conductor that makes up the fuel conduits 1634, 1636) to prevent electromagnetic radiation in the resonator 1600 from interacting with the fuel while the fuel is transiting the fuel conduits 1634, 1636. In other implementations, the fuel conduits 1634, 1636 can allow electromagnetic radiation to interact with (for example, reform) the fuel within the fuel conduits 1634, 1636.

The resonator 1600 can include a connector 1626 to connect the fuel conduit 1628 to the fuel supply line 1028. Likewise, the fuel supply line 1028 can include the connector 1024 discussed above. FIG. 16 shows the connector 1626 outside of the base 1616. In another implementation, at least a portion of the connector 1626 can be disposed within the base 1616.

In some implementations, the fuel conduit 1628 can include the connector 1626, and the fuel supply line 1028 can include the connector 1024. The connector 1626 can be similar to the connector 1022 shown in FIG. 10.

Similar to other resonators discussed above, the resonator 1600 can connect to a radio-frequency power source that is configured to provide a signal to excite the resonator 1600. The resonator 1600 can further connect to a direct-current power source that is configured to provide a bias signal between the outer conductor 1602 and the inner conductor 1608. The resonator 1600 can provide a plasma corona proximate to the concentrator of the electrode 1610 when the resonator 1600 is excited by a signal from the radio-frequency power source. The plasma corona can be provided within a combustion zone of a combustion chamber of a power-generation gas turbine.

The fuel conduits 1634, 1636 include fuel outlets 1650, 1652, respectively. In example implementations, the resonator 1600, or at least the distal end of the resonator 1600, can be disposed within the combustion zone of a combustion chamber of a power-generation gas turbine. In those implementations, the fuel output by the fuel outlets 1650, 1652 can mix with a gas within the combustion zone. Furthermore, a distal end of one or more of the fuel conduits 1634, 1636 and/or a distal end of one or more of the fuel outlets 1650, 1652 can be angled toward the electrode 1610.

### X. Example Plasma-assisted Combustion Using Multiple Resonators

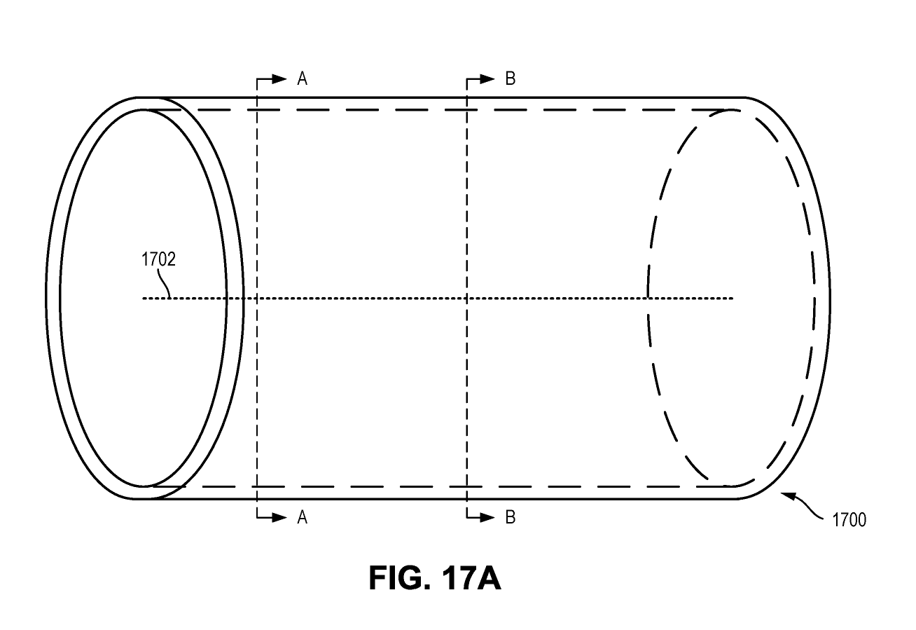

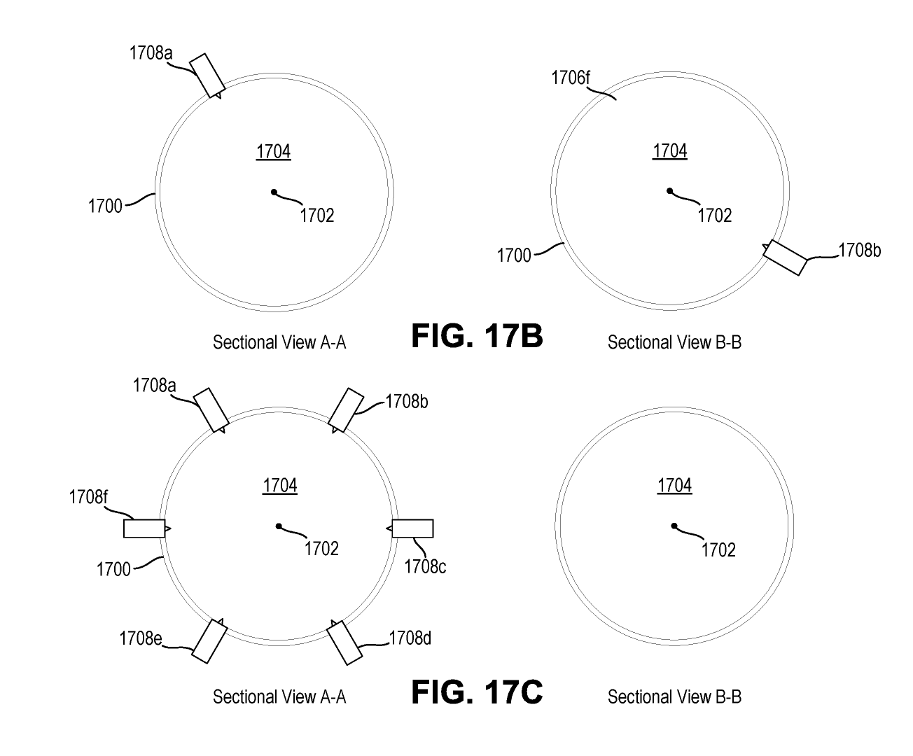

Example structures for plasma-assisted combustion using multiple resonators will now be described particularly (by way of example) in the context of a cylindrical combustor, by reference to FIGS. 17A-C and 18A-B. It should be noted, however, that other combustor configurations are possible as well, including combustors of different shapes, such as rectangular-shaped combustors, funnel-shaped combustors, or the like. For instance, the combustor can be generally tubular in shape while having a diameter that varies along its length, similar to the combustor 900 depicted in FIG. 9.

FIG. 17A illustrates an example combustor 1700. In some implementations, the combustor 1700 depicted in FIG. 17A can be a portion of a larger (for instance, longer) combustor 1700. FIGS. 17B and C illustrate multiple example cross-sectional views of the combustor 1700. Each cross-sectional view shows a cross-section of the combustor 1700 at a particular point along a length of the combustor 1700, the length running longitudinally and parallel to a longitudinal center axis 1702 of the combustor 1700. For instance, cross-section A-A is located near a proximal end of the combustor 1700, which can be near a fuel inlet that introduces fuel into the combustor. Cross-section B-B is located away from the proximal end of the combustor 1700 toward a distal end of the combustor 1700. In some examples, cross-section B-B can be located near a midpoint of the length of the combustor 1700. In other examples, cross-sections A-A and B-B can be located at various other points along the length of the combustor 1700.

Referring to FIG. 17B, example cross-sectional views of the combustor 1700 at cross-sections A-A and B-B are shown. In line with the discussion above, the combustor 1700 includes a combustion zone 1704 in which combustion of fuel occurs. As described above, in some implementations, a combustor can include a liner that surrounds and defines the combustion zone to act as a protective barrier that shields the interior walls of the combustor. Accordingly, in some implementations, the combustor 1700 can further include such a liner that surrounds and defines the combustion zone 1704.

In line with the discussion above, a resonator can generate a plasma corona for igniting fuel in a combustion zone of power-generation gas turbine. Sectional view A-A of FIG. 17B includes a representative resonator 1708a configured to excite a plasma corona in the combustion zone 1704. The representative resonator 1708a could be configured in accordance with any of the resonators discussed above.

In the illustrated examples, at least a portion of the representative resonator can be coupled to and/or located within and/or proximate to the combustion zone 1704 and used to trigger excitation of a plasma corona within the combustion zone 1704. For instance, as depicted in FIG. 17B, the electrode of resonator 1708a extends into the combustion zone 1704 so that a plasma corona provided at the electrode of resonator 1708a is provided in the combustion zone 1704.

In line with the discussion above, the resonator 1708a can include a fuel conduit configured to couple to a fuel source and having a fuel outlet for expelling fuel into the combustion zone 1704. A first portion of a fuel conduit can be disposed within a first conductor of the resonator 1708a. Further, the first conductor of the resonator 1708a could include an interior surface that defines the first portion of the fuel conduit. Alternatively, the first portion of the fuel conduit could be disposed within a cavity of the first conductor of the resonator 1708a. As also discussed above, in some implementations, a second portion of the fuel conduit could be disposed within a dielectric of the resonator 1708a.

Further in line with the discussion above, in some implementations, at least a portion of the first conductor of the resonator 1708a can be disposed within a cavity defined by a second conductor of the resonator 1708a. Alternatively, at least a portion of a second conductor of the resonator 1408a can be disposed within a cavity defined by the first conductor of the resonator 1708a.

Moreover, the orientation of a resonator with respect to a longitudinal axis of the combustor can vary, depending on the desired implementation. In an example, a longitudinal axis of the center conductor of resonator 1708a can be oriented at an oblique angle with respect to the longitudinal center axis 1702 of the combustor 1700, with a distal end of the center conductor being disposed toward a distal end of the combustor 1700. Orienting resonator 1708a in this manner can help to prevent fuel that is input into the combustor by a fuel inlet from blowing out the plasma corona. Alternatively, resonator 1708a can be oriented such that a longitudinal axis of the center conductor is perpendicular to the longitudinal center axis 1702 of the combustor 1700. Other examples are possible as well.

In any case, as described above, the resonator 1708a can provide a plasma corona in the combustion zone 1704 in order to ignite the fuel/air mixture and cause the fuel in the combustion zone to combust.

As further shown in sectional view B-B, one or more additional resonators similar to resonator 1708a can be included at various points along the length of the combustor 1700. For instance, sectional view B-B shows an additional resonator 1708b that is rotationally offset from resonator 1708a by approximately 180-degrees around the circumference of the combustor 1700. Resonator 1708b can supplement the combustion caused by resonator 1708a by providing an additional plasma corona to ignite any non-combusted fuel at or near resonator 1708b. Additionally or alternatively, resonator 1708b can supplement the combustion caused by resonator 1708a by providing electromagnetic waves that pre-treat fuel within a portion of a fuel conduit passing through a first conductor of the resonator 1708b. Similarly, resonator 1708b could be controlled so as to provide a plasma corona and resonator 1708a could be controlled so as to provide electromagnetic waves, thereby pre-treating fuel within a portion of a fuel conduit passing through a first conductor of resonator 1708a.

Further, in some implementations, an array of resonators can be arranged annularly around the longitudinal center axis 1702 of the combustor 1700. For instance, as depicted in FIG. 17C, sectional view A-A can include six resonators 1708a-f arranged annularly around the circumference of the combustor 1700, each resonator positioned at a respective angular position and configured to provide a respective plasma corona and/or electromagnetic waves. In other implementations, additional or fewer resonators could be included at cross-sections A-A and B-B. For instance, while sectional view B-B in FIG. 17C does not include any resonators, in other implementations, one or more resonators could be included at cross-section B-B. For instance, cross section A-A could include three resonators positioned to provide respective plasma coronas, and cross section B-B could similarly include three resonators positioned to provide respective plasma coronas. In another example, an array of resonators can be arranged along a curve that wraps helically around the longitudinal center axis 1702. Other examples are possible as well.

In these examples having multiple resonators, any of the resonators can be selectively excited according to a desired sequence so as to provide plasma coronas at the desired sequence. For instance, each resonator can be electromagnetically coupled to a corresponding radio-frequency power source, and a controller can cause the respective radio-frequency power sources to excite the resonators in the desired sequence. In other examples, multiple resonators can be electromagnetically coupled to a single radio-frequency power source, and the controller can cause the single radio-frequency power source to selectively excite the resonators at the desired point in the sequence.

The desired sequence can take various forms. For instance, referring to sectional view A-A in FIG. 17C, resonators 1708a-f can be excited sequentially in a clockwise or counter-clockwise sequence. As another example, some of the resonators, such as resonators 1708a, 1708c, and 1708e, can be excited at one time, and the remaining resonators 1708b, 1708d, and 1708f, can be excited at a subsequent time. Other examples are possible as well.

Further, in some implementations, resonators at different points along the length of the combustor 1700 can be excited at different times in accordance with the desired sequence. For instance, one or more resonators at cross section B-B can be excited after one or more resonators at cross section A-A. This can allow combustion to propagate from a resonator(s) at cross-section A-A along the length of the combustor 1700 toward cross-section B-B before exciting the resonator(s) at cross-section B-B.

By way of example, excitation of the resonator(s) at cross-section B-B can be delayed by a delay time with respect to excitation of the resonator(s) at cross-section A-A. For instance, the resonator(s) at cross-section A-A can be excited at a first time, and then after a delay time, the resonator(s) at cross-section B-B can be excited. Delaying the excitation of the resonator(s) at cross-section B-B can cause combustion propagating from the resonator(s) at cross section B-B to reach the distal end of the combustor at approximately the same time as combustion propagating from the resonator(s) at cross section A-A reaches the distal end of the combustor. The amount of delay time between exciting the resonators at cross section A-A and exciting the resonators at cross section B-B can depend on a velocity of the combustion propagation, which could depend on the type of fuel being combusted. For instance, for a given fuel, if it takes X milliseconds for combustion to propagate from cross section A-A to the distal end of the combustor and Y milliseconds for combustion to propagate from cross section B-B to the distal end of the combustor, then the resonator(s) at cross section B-B can be excited Z milliseconds after the resonator(s) at cross section A-A, where Z=X−Y.

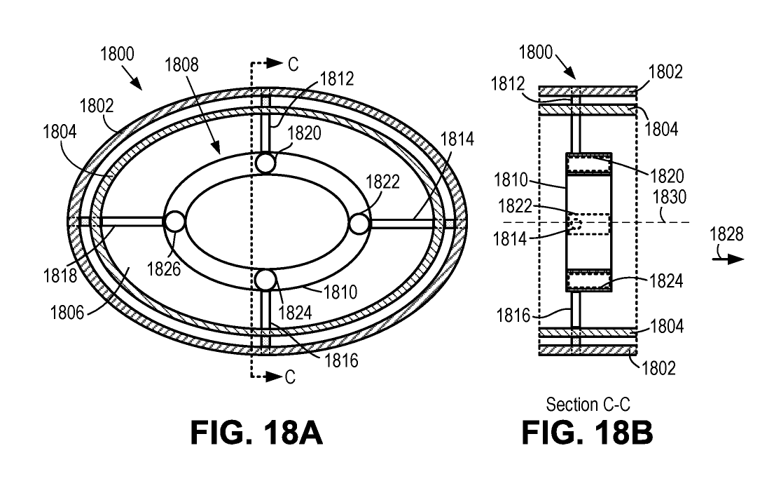

FIG. 18A illustrates an example combustor 1800. The combustor 1800 includes an outer casing 1802 and a liner 1804. The liner 1804 defines a combustion zone 1806. The combustor 1800 also includes a mounting bracket 1808 having a mounting ring 1810 and struts 1812, 1814, 1816, 1818. The struts 1812, 1814, 1816, 1818 can extend through respective ports in the outer casing 1802 and respective ports in the liner 1804. Further, a portion (not shown) of each of the struts 1812, 1814, 1816, 1818 can be disposed outside of the outer casing 1802 for attaching the struts 1812, 1814, 1816, 1818 to the outer casing 1802.

In an example implementation, a strut supported by and/or attached to the mounting bracket 1808 can be connected to a portion of a fuel supply line. In another example implementation, a strut supported by and/or attached to the mounting bracket 1808 can include a passage for electrical circuitry that is connected to a signal generator and/or direct-current power source. In yet another example implementation, a strut supported by and/or attached to the mounting bracket 1808 can include both a passage for the electrical circuitry and a portion of a fuel supply line.

As further shown in FIG. 18A, the combustor 1800 includes four resonators 1820, 1822, 1824, 1826 attached to the mounting bracket 1808. In other examples, the combustor 1800 could include more or less resonators. Further, the number of resonators could be different from the number of struts.

The resonators 1820, 1822, 1824, 1826 could be configured in accordance with any of the resonators discussed above. Electrical circuitry connected to a signal generator and/or a direct-current power source can connect to the resonators 1820, 1822, 1824, 1826. The resonators 1820, 1822, 1824, 1826 can be configured to provide electromagnetic waves and/or a plasma corona in response to being excited by a radio-frequency signal. As discussed above, in some implementations, one of the resonators 1820, 1822, 1824, 1826 can be configured to provide a plasma corona in response to being excited by a radio-frequency signal and having a direct-current power source provide a bias signal between a first conductor and a second conductor of the resonator.

FIG. 18B is a cross-sectional view of the combustor 1800. FIG. 18B includes an arrow 1828 to indicate a direction that a gas could flow through within the combustor 1800. With the arrangement shown in FIGS. 18A and B, the mounting ring 1810 can at least partially shield the resonators 1820, 1822, 1824, 1826 from air and/or fuel introduced into the combustion chamber upstream of the mounting ring. For instance, the mounting ring 1810 may have the shape of a hollow cylinder, with a proximal end of the hollow cylinder that faces the proximal end of the combustor 1800 being closed. Further, a distal end of the hollow cylinder may be open, and the distal ends of the resonators 1820, 1822, 1824, 1826 can extend through the distal end. Alternatively, the distal end of the hollow cylinder may be closed, and the distal ends of the resonators 1820, 1822, 1824, 1826 may extend through ports in the distal end of the hollow cylinder.

The arrangement shown in FIGS. 18A and B is not meant to be limiting. In other implementations, the resonators 1820, 1822, 1824, 1826 can be attached to the mounting ring in other manners.

FIG. 18B also depicts a longitudinal axis 1830 of the combustor. As shown in FIG. 18B, the resonators 1820, 1822, 1824, 1826 are oriented parallel to the longitudinal axis 1830. The orientation of the resonators 1820, 1822, 1824, 1826 with respect to the longitudinal axis 1830 can vary, depending on the desired implementation. In an example, longitudinal axes of the resonators 1820, 1822, 1824, 1826 can be oriented at angles oblique to the longitudinal axis 1830, with a distal end of the resonators 1820, 1822, 1824, 1826 being disposed toward a distal end of the combustor 1800. Orienting the resonators 1820, 1822, 1824, 1826 along axes that are parallel or oblique to the longitudinal axis 1830 can help to prevent fuel that is input into the combustor from blowing out plasma coronas generated by the resonators 1820, 1822, 1824, 1826. Alternatively, resonators 1820, 1822, 1824, 1826 can be oriented such that longitudinal axes of the resonators 1820, 1822, 1824, 1826 are perpendicular to the longitudinal axis 1830. Other examples are possible as well.

In another implementation, the mounting ring 1810 could be a helix that wraps helically around the longitudinal center axis 1420. With this approach, the struts 1812, 1814, 1816, 1818 could be located at different longitudinal positions along a length of the combustor 1800.

Like the resonators 1708a-f of FIG. 17, and other resonators discussed above, one or more of the resonators 1820, 1822, 1824, 1826 can include a fuel conduit configured to couple to a fuel source and having a fuel outlet for expelling fuel into the combustion zone 1806. A first portion of a fuel conduit of the resonator(s) can be disposed with a first conductor of the resonator.

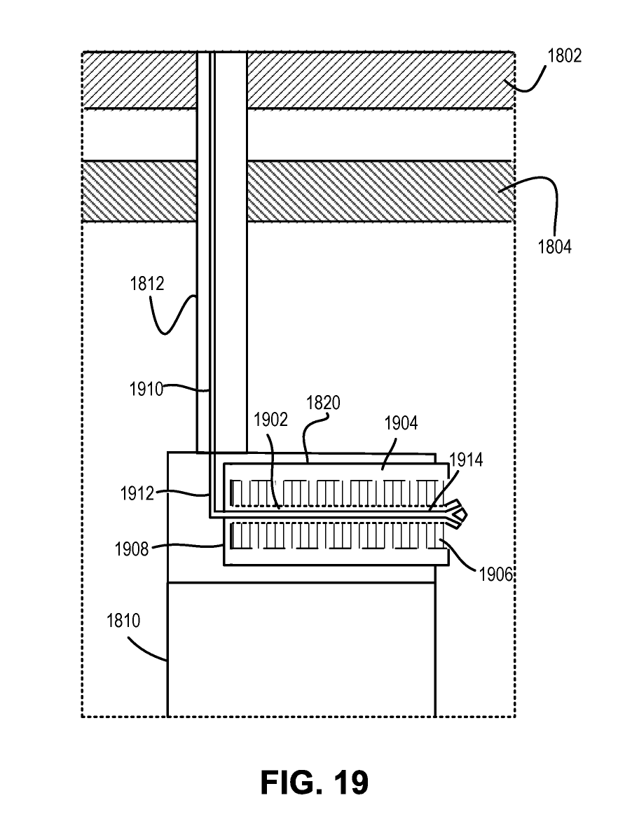

The fuel conduit(s) of the one or more of the resonators 1820, 1822, 1824, 1826 can be fluidly coupled to a fuel passage within one of the struts 1812, 1814, 1816, 1818. FIG. 19 is a cutaway side view of the strut 1812 and the resonator 1820. Portions of the outer casing 1802, liner 1804, and mounting ring 1810 are depicted in FIG. 19.

As shown in FIG. 19, the resonator 1820 includes a first conductor 1902, a second conductor 1904, and a dielectric 1906 disposed between the first conductor 1902 and the second conductor 1904. A base conductor 1908 is electrically coupled to the first conductor 1902 and the second conductor 1904. The configuration of the resonator 1820 shown in FIG. 19 is provided by way of example and is not meant to be limiting. The resonator 1820 may be configured in accordance with any of the resonators described above.

As further shown in FIG. 19, a fuel passage 1910 is located within the strut 1812. The fuel passage 1910 can be defined by a cavity within the strut. Or the fuel passage 1910 can be a separate structure, such as a tube, within the strut 1812 through which fuel can flow. The fuel passage 1910 is fluidly coupled to a fuel section 1912. The fuel section 1912 fluidly couples the fuel passage 1910 to a fuel conduit 1914 disposed within the first conductor 1902 of the resonator 1820. In line with the discussion above, in some implementations, the resonator 1820 can include a connector (not shown) to fluidly connect the fuel conduit 1914 to the fuel section 1912. Likewise, the fuel section 1912 can include a connector (also not shown) that is connectable to the connector of the resonator.

### XI. Example Methods

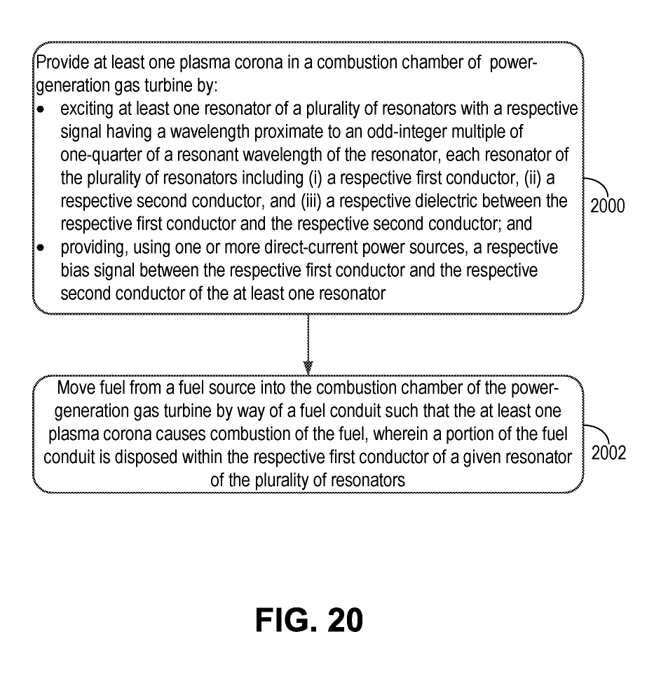

FIG. 20 is a flow chart depicting operations of a representative method for combusting fuel in a power-generation gas turbine.

At block 2000, the method includes providing at least one plasma corona in a combustion chamber of a power-generation gas turbine by: (a) exciting at least one resonator of a plurality of resonators with a respective signal having a wavelength proximate to an odd-integer multiple of one-quarter of a resonant wavelength of the resonator, each resonator of the plurality of resonators including (i) a respective first conductor, (ii) a respective second conductor, and (iii) a respective dielectric between the respective first conductor and the respective second conductor; and (b) providing, using one or more direct-current power sources, a respective bias signal between the respective first conductor and the respective second conductor of the at least one resonator. In line with the discussion above, each resonator of the plurality of resonators can include a coaxial cavity resonator, a dielectric resonator, a rectangular waveguide cavity resonator, or a gap-coupled microstrip resonator, or could take still other forms.

In some implementations, providing the at least one plasma corona can include exciting resonators of the plurality of resonators according to a desired sequence so as to provide respective plasma coronas in the desired sequence.

In some implementations, exciting at least one resonator of the plurality of resonators can include exciting all of the resonators of the plurality of resonators.

At block 2002, the method includes moving fuel from a fuel source into the combustion chamber of the power-generation gas turbine by way of a fuel conduit such that the at least one plasma corona causes combustion of the fuel. A portion of the fuel conduit is disposed within the respective first conductor of the given resonator. As discussed above, at least a portion of the first conductor can be disposed within a cavity defined by the second conductor of the given resonator. Alternatively, at least a portion of the second conductor of the given resonator can be disposed within a cavity defined by the first conductor of the given resonator.

In some implementations, the given resonator can be one of the at least one resonators that provides the at least one plasma corona. Accordingly, providing the at least one plasma corona can include exciting the given resonator with the respective signal having the wavelength proximate to an odd-integer multiple of one-quarter of a resonant wavelength of the given resonator and providing the respective bias signal between the first conductor and the second conductor of the given resonator.

In some implementations, one or more of the plurality of resonators can assume a dual role. For instance, providing the at least one plasma corona can include causing a given resonator of the plurality of resonators to provide a plasma corona. Further, in that example, the method can also include exciting the given resonator prior to formation of the plasma corona, such that the given resonator provides electromagnetic waves for pre-treating fuel that is input through the given resonator and/or fuel that is within the combustion zone.

Similarly, in some implementations, a first set of resonators of the plurality of resonators can provide plasma coronas and a second set of resonators of the plurality of resonators need not provide respective plasma coronas. The first set of resonators could include one or more resonators of the plurality of resonators, and the second set of resonators could include one or more other resonators of the plurality of resonators. With this arrangement, after combustion occurs, rather than providing plasma coronas, the second set of resonators could instead enhance an already present combustion process by providing electromagnetic waves that can reform fuel that is being input to the combustion zone and/or already in the combustion zone. In one example, the resonators of the second set of resonators could be controlled so as to initially provide plasma coronas and then, after combustion occurs, to no longer provide plasma coronas. Alternatively, resonators of the second set of resonators might never provide plasma coronas, but only provide electromagnetic waves for pre-treating or reforming fuel.

In some implementations, moving the fuel can include moving the fuel using a fuel pump of the power-generation gas turbine. In addition, moving the fuel can include expelling the fuel through a fuel outlet and toward a distal end of the first conductor of the given resonator where the resonator provides the plasma corona.

The order of the blocks shown in FIG. 20 is not meant to be limiting. In some implementations, the method can include moving fuel from the fuel source into the combustion chamber of the power-generation gas turbine by way of the fuel conduit, and then providing the at least one plasma corona such that the at least one plasma corona causes combustion of fuel that is in the combustion chamber of the power-generation gas turbine.

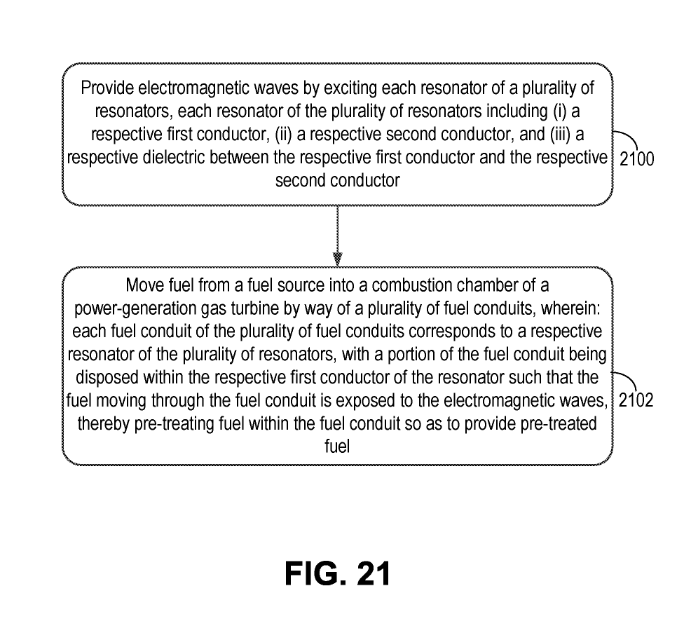

FIG. 21 is a flow chart depicting operations of a representative method for pre-treating fuel in a power-generation gas turbine.

At block 2100, the method includes providing electromagnetic waves by exciting each resonator of a plurality of resonators, with each resonator of the plurality of resonators including (i) a respective first conductor, (ii) a respective second conductor, and (iii) a respective dielectric between the respective first conductor and the respective second conductor. In line with the discussion above, each resonator of the plurality of resonators can include a coaxial cavity resonator, a dielectric resonator, a rectangular waveguide cavity resonator, or a gap-coupled microstrip resonator, or could take still other forms. In some implementations, providing electromagnetic waves by exciting each resonator can include providing electromagnetic waves by exciting each resonator of the plurality of resonators with a respective signal having a wavelength proximate to an odd-integer multiple of one-quarter of a resonant wavelength of the resonator.

At block 2102, the method includes moving fuel from a fuel source into a combustion chamber of a power-generation gas turbine by way of a plurality of fuel conduits. Each fuel conduit of the plurality of fuel conduits can correspond to a respective resonator of the plurality of resonators, with a portion of the fuel conduit being disposed within the respective first conductor of the resonator such that the fuel moving through the fuel conduit is exposed to the electromagnetic waves, thereby pre-treating fuel within the fuel conduit so as to provide pre-treated fuel. As discussed above, at least a portion of the first conductor can be disposed within a cavity defined by the second conductor. Alternatively, at least a portion of the second conductor can be disposed within a cavity defined by the first conductor.

In some implementations, pre-treating the fuel can include increasing an energy state of the fuel, thereby lowering an energy barrier to combustion of the fuel. In line with the discussion above, increasing the energy state of the fuel can include increasing a valence band occupancy rate.

In some implementations, pre-treating the fuel can include (i) liberating hydrogen atoms from the fuel, thereby making the pre-treated fuel more amenable to combustion and/or (ii) liberating hydrogen ions from the fuel, thereby making the pre-treated fuel more amenable to combustion.

In some implementations, the method can also include igniting the pre-treated fuel with the combustion chamber. In line with the discussion above, igniting the pre-treated fuel within the combustion chamber can include providing a plasma corona in the combustion chamber by: (i) causing a direct-current power source to provide a bias signal between the first conductor and the second conductor of a given resonator of the plurality of resonators, and (ii) causing a radio-frequency power source to excite the given resonator with the signal having the wavelength proximate to an odd-integer multiple of one-quarter of the resonant wavelength of the given resonator.

The particular arrangements shown in the Figures should not be viewed as limiting. It should be understood that other implementations can include more or less of each element shown in a given Figure. Further, some of the illustrated elements can be combined or omitted. Yet further, an illustrative implementation can include elements that are not illustrated in the Figures.

A step or block that represents a processing of information can correspond to circuitry that can be configured to perform the specific logical functions of a method or technique as presently disclosed. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer-readable medium such as a storage device including a disk, hard drive, or other storage medium.

The computer-readable medium can also include non-transitory computer-readable media such as computer-readable media that store data for short periods of time like register memory, processor cache, and random access memory (RAM). The computer-readable media can also include non-transitory computer-readable media that store program code and/or data for longer periods of time. Thus, the computer-readable media can include secondary or persistent long term storage, like read only memory (ROM), optical or magnetic disks, compact-disc read only memory (CD-ROM), for example. The computer-readable media can also be any other volatile or non-volatile storage systems. A computer-readable medium can be considered a computer-readable storage medium, for example, or a tangible storage device.

While various examples and implementations have been disclosed, other examples and implementations will be apparent to those skilled in the art. The various disclosed examples and implementations are for purposes of illustration and are not intended to be limiting, with the true scope being indicated by the following claims.

1. A system comprising:
a combustion chamber of a power-generation gas turbine;
one or more radio-frequency power sources;
a plurality of resonators electromagnetically coupled to the one or more radio-frequency power sources, each resonator of the plurality of resonators having a respective resonant wavelength and including (i) a respective first conductor, (ii) a respective second conductor, and (iii) a respective dielectric between the respective first conductor and the respective second conductor, wherein each resonator of the plurality of resonators is configured such that, when the resonator is excited by a corresponding radio-frequency power source of the one or more radio-frequency power sources with a respective signal having a wavelength proximate to an odd-integer multiple of one-quarter of the respective resonant wavelength, the resonator provides at least one of a plasma corona or electromagnetic waves; and
a fuel conduit configured to couple to a fuel source and having a fuel outlet for expelling fuel into a combustion zone of the combustion chamber, at least a first portion of the fuel conduit being disposed within the first conductor of a given resonator of the plurality of resonators.

2. The system of claim 1, wherein the plurality of resonators comprises an array of resonators arranged annularly around a center axis of the combustion chamber.

3. The system of claim 2, wherein the plurality of resonators are attached to a mounting bracket.

4. The system of claim 3, wherein the mounting bracket comprises a mounting ring.

5. The system of claim 1, wherein the combustion chamber comprises a proximal end and a distal end separated by a length of the combustion chamber, and wherein the plurality of resonators comprises a first resonator arranged at a first position along the length of the combustion chamber and a second resonator arranged at a second position along the length of the combustion chamber.

6. The system of claim 1, wherein the one or more radio-frequency power sources are configured to excite corresponding resonators of the plurality of resonators according to a desired sequence so as to provide respective plasma coronas in the desired sequence.

7. The system of claim 1, wherein the one or more radio-frequency power sources include a plurality of radio-frequency power sources, each radio-frequency power source of the plurality of radio-frequency power source being electromagnetically coupled to a corresponding resonator of the plurality of resonators.

8. The system of claim 1, further comprising a direct-current power source configured to provide a bias signal between the respective first conductor and the respective second conductor of the given resonator.

9. The system of claim 1, wherein another portion of the fuel conduit is disposed within the respective first conductor of another given resonator of the plurality of resonators.

10. The system of claim 1, further comprising a direct-current power source configured to provide a bias signal between the respective first conductor and the respective second conductor of the given resonator.

11. The system of claim 1, wherein the respective first conductor of the given resonator includes an interior surface that defines the first portion of the fuel conduit.

12. The system of claim 1, wherein the first portion of the fuel conduit is disposed within a cavity of the respective first conductor of the given resonator.

13. The system of claim 1, wherein the first portion of the fuel conduit includes a glass tube, a sapphire tube, a quartz tube, a rubber tube, an aliphatic polyamide tube, or a metallic tube.

14. The system of claim 1, wherein a second portion of the fuel conduit is disposed within the respective dielectric of the given resonator.

15. The system of claim 1, wherein at least a portion of the respective first conductor of the given resonator is disposed within a cavity defined by the respective second conductor of the given resonator.

16. The system of claim 15:
wherein the respective first conductor of the given resonator includes (i) a first center conductor portion having a proximal end of the respective first conductor, (ii) a second center conductor portion having a distal end of the respective first conductor, and (iii) a transition zone that (a) is between the distal end and the proximal end and (b) connects the first center conductor portion and the second center conductor portion,
wherein the first portion of the fuel conduit is disposed within the second center conductor portion and the transition zone, and
wherein the fuel outlet is disposed within the transition zone.

17. The system of claim 16, wherein the first portion of the fuel conduit includes (i) a first branch that leads to the fuel outlet and (ii) a second branch that leads to another fuel outlet disposed within the transition zone.

18. The system of claim 1, wherein at least a portion of the respective second conductor of the given resonator is disposed within a cavity defined by the respective first conductor of the given resonator.

19. The system of claim 1, wherein the fuel outlet is located at a distal end of the respective first conductor of the given resonator.

20. The system of claim 1, further comprising:
a fuel pump configured to move the fuel through the fuel conduit; and
a controller configured to carry out operations, the operations including:
causing a given radio-frequency power source of the one or more radio-frequency power sources to excite the given resonator with the respective signal so as to provide the electromagnetic waves, and
causing the fuel pump to move the fuel from the fuel source through the fuel conduit such that the fuel moves through the respective first conductor of the given resonator and is exposed to the electromagnetic waves while moving through the respective first conductor of the given resonator.

21. The system of claim 1, wherein each resonator of the plurality of resonators is selected from the group consisting of: a coaxial cavity resonator, a dielectric resonator, a rectangular waveguide cavity resonator, and a gap-coupled microstrip resonator.

22. The system of claim 1, further comprising the power-generation gas turbine.

23. The system of claim 1, further comprising:
a fuel supply line fluidly coupled to the fuel conduit;
a fuel tank fluidly coupled to the fuel supply line; and
a fuel pump configured to provide fuel through the fuel supply line from the fuel tank to the fuel conduit and out the fuel outlet.

24. A method comprising:
providing at least one plasma corona in a combustion chamber of a power-generation gas turbine by:
exciting at least one resonator of a plurality of resonators with a respective signal having a wavelength proximate to an odd-integer multiple of one-quarter of a resonant wavelength of the resonator, each resonator of the plurality of resonators including (i) a respective first conductor, (ii) a respective second conductor, and (iii) a respective dielectric between the respective first conductor and the respective second conductor, and
providing, using one or more direct-current power sources, a respective bias signal between the respective first conductor and the respective second conductor of the at least one resonator; and
moving fuel from a fuel source into the combustion chamber of the power-generation gas turbine by way of a fuel conduit such that the at least one plasma corona causes combustion of the fuel, wherein a portion of the fuel conduit is disposed within the respective first conductor of a given resonator of the plurality of resonators.

25. The method of claim 24, wherein providing the at least one plasma corona comprises:
exciting the given resonator with the respective signal having the wavelength proximate to an odd-integer multiple of one-quarter of the resonant wavelength of the resonator, and
providing the respective bias signal between the respective first conductor and the respective second conductor of the given resonator.

26. The method of claim 25, wherein moving the fuel includes expelling the fuel through a fuel outlet and toward a distal end of the first conductor of the given resonator where the given resonator provides a plasma corona.

27. The method of claim 24, wherein providing the at least one plasma corona comprises exciting resonators of the plurality of resonators according to a desired sequence so as to provide respective plasma coronas in the desired sequence.

28. The method of claim 24, wherein moving the fuel comprises moving the fuel using a fuel pump of the power-generation gas turbine.

29. A method comprising:
providing electromagnetic waves by exciting each resonator of a plurality of resonators with a respective signal having a wavelength proximate to an odd-integer multiple of one-quarter of a resonant wavelength of the resonator, each resonator of the plurality of resonators including (i) a respective first conductor, (ii) a respective second conductor, and (iii) a respective dielectric between the first conductor and the second conductor; and
moving fuel from a fuel source into a combustion chamber of a power-generation gas turbine by way of a plurality of fuel conduits, wherein:
each fuel conduit of the plurality of fuel conduits corresponds to a respective resonator of the plurality of resonators, with a portion of the fuel conduit being disposed within the respective first conductor of the resonator such that the fuel moving through the fuel conduit is exposed to the electromagnetic waves, thereby pre-treating fuel within the fuel conduit so as to provide pre-treated fuel.

30. The method of claim 29, wherein pre-treating the fuel includes increasing an energy state of the fuel, thereby lowering an energy barrier to combustion of the fuel.

31. The method of claim 30, wherein increasing the energy state of the fuel includes increasing a valence band occupancy rate.

32. The method of claim 29, wherein pre-treating the fuel comprises at least one of:
liberating hydrogen atoms from the fuel, thereby making the pre-treated fuel more amenable to combustion; or
liberating hydrogen ions from the fuel, thereby making the pre-treated fuel more amenable to combustion.

33. The method of claim 29, further comprising igniting the pre-treated fuel within the combustion chamber.

34. The method of claim 33, wherein igniting the pre-treated fuel with the combustion chamber includes providing a plasma corona in the combustion chamber by:
causing a direct-current power source to provide a bias signal between the first conductor and the second conductor of a given resonator of the plurality of resonators; and
causing a radio-frequency power source to excite the given resonator with the respective signal having the wavelength proximate to an odd-integer multiple of one-quarter of the resonant wavelength of the given resonator.

35. The method of claim 29, wherein providing electromagnetic waves by exciting each resonator of the plurality of resonators includes exciting each resonator of the plurality of resonators with a respective signal having a wavelength proximate to an odd-integer multiple of one-quarter of a resonator wavelength of the resonator.
